(19) United States
(12) Patent Application Publication
(10) Pub. No.: US 2002/0076990 A1
(43) Pub. Date: Jun. 20, 2002

(54) Apparatus for processing a stacked-type connector of a wire harness, a housing holder, apparatus and method and for stacking housings of a stacked-type connectors, and apparatus for pressing a joint portion of stacked-type connector

(75) Inventor: Koji Fujita, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS Ltd., Yokkaichi-city (JP)

(21) Appl. No.: 10/023,994

(22) Filed: Dec. 21, 2001

(30) Foreign Application Priority Data
Dec. 25, 2000 (JP) 2000-393566
Dec. 25, 2000 (JP) 2000-393564
Dec. 15, 2000 (JP) 2000-393565

(51) Int. Cl. H01R 13/502

(52) U.S. Cl. 439/701

(57) ABSTRACT

A pressing unit is provided for pressing a joint portion of a housing of a stacked-type connector to have a generally U-shaped configuration. In a predetermined housing-stacking order, a stacking unit stacks the housings whose joint portions have been pressed by the pressing unit. Also provided is an apparatus for pressing a joint portion of a stacked-type connector whose housings are stacked one upon another to bend the joint portion into a generally U-shape. A frame member (housing holder) of the apparatus holds the housings, with the joint portion placed in a predetermined pressing position. A first pressing portion sandwiches the linear joint portion placed in the pressing position under pressure and bends a front side of the joint portion. After the first pressing portion bends the joint portion, a second pressing portion bends a portion of the joint portion rearwardly from the bent portion such that the joint portion has a generally U-shaped configuration. An apparatus and a method for stacking connector housings is also provided. The apparatus includes a housing-holding portion that holds housings of a stacked-type connector having a U-shaped joint portion of a terminal in a stacking order. A correction mechanism corrects the configuration of the joint portion projecting from the housing held by the housing-holding portion. In this condition, a fit-in mechanism fits a subsequent-stack housing in the housing held by the housing-holding portion. After the correction mechanism retracts, both housings are fitted to each other normally. By repeating this operation, the housings are stacked one upon another to complete formation of the stacked-type connector.

### BACKGROUND OF THE INVENTION

1. Field of the Invention

The present invention relates to an apparatus for processing a stacked-type connector of a wire harness, a housing holder, and a method of supplying the wire harness to the apparatus, to an apparatus for pressing joint portions of stacked-type connectors, to an apparatus for pressing joint portions of stacked-type connectors, and to an apparatus and method for stacking housings of stacked-type connectors.

2. Description of the Related Art

The wire harness is an electric wiring system forming circuits of an apparatus. The wire harness for a vehicle has 250-300 circuits. As a method of manufacturing the wire harness and sub-assemblies manufactured by an automatic manufacturing apparatus are gross-assembled on a wiring board of a main line.

In the above-described method, it is preferable that each assembly is constructed as a complete circuit having no terminal inserted into a connector and designed in a manner suitable for automatic production to prevent the terminal from being manually erroneously inserted into the connector and to facilitate automation of the gross assembly process. Thus, as a connection technique for connecting circuits constituting the wire harness to each other, the joint connector and the electrical connection box have been adopted.

The joint connector is used to short-circuit a plurality of electric wires with pressure welding terminals accommodated in a housing to thereby construct branch circuits of electric wiring. The pressure welding terminals are conductive parts each having a slit and connected to each other to connect the pressure welding terminals to coated electric wires under pressure. In connecting the pressure welding terminals and the coated electric wires to each other, the coated electric wires are inserted into a plurality of the slits by press fitting to cut out the coated portion of the coated electric wires and connect the pressure welding terminals and core wires to each other.

The junction box accommodates wiring materials such as stacked bus bars in a case to allow the stacked bus bars to form branch circuits of electric wires. Bus bar materials for the bus bars composing circuits corresponding to the kind of a vehicle are punched from a hoop material. The bus bar materials are stacked one upon another with insulation plates therebetween and accommodated in the case, with tab terminals bent vertically from the bus bar materials.

However, the joint connector and the junction box are incapable of satisfying demands for the development of a compact and inexpensive wire harness and an art of manufacturing the compact and inexpensive wire harness.

That is, it is easy to design and manufacture the joint connector. But the joint connector has slits merely arranged to connect the terminals to electric wires through the slits. Thus, it is difficult to construct a branch structure having a complicated large-scale circuit.

The construction of a bus bar which is adopted in the junction box is required to be changed for each kind of a vehicle. Therefore for each kind of a vehicle, it is necessary to design and manufacture a press die for punching the bus bar material from the hoop material, which causes the manufacturing cost to be high. Another problem is that as the bus bar-adopted construction becomes more complicated, the number of parts for the bus bar increases. Consequently the junction box becomes large.

To manufacture the wire harness having a complete circuit by the connection technique, it is indispensable to develop an art for bending the joint portion of the terminal easily and accurately, accurately stacking the housings one upon another, and securely connecting the joint portion projecting from the lower housing and the connection portion accommodated in the upper housing stacked on the lower housing to each other. It is also indispensable to develop an art for accurately stacking the housings one upon another and securely connecting the joint portion projecting from the lower housing and the connection portion accommodated in the upper housing stacked on the lower housing to each other.

### SUMMARY OF THE INVENTION

Thus to solve the above problem, the present applicant has developed a novel connection technique. The connector developed by the connection technique has a plurality of multi-stacked housings and a plurality of terminals accommodated in the housings with the terminals arranged parallel with one another. One of the terminals has the electric wire connection portion formed at one side thereof in a longitudinal direction thereof and connected to the end of a coated electric wire, the female connection portion formed at the other side thereof in the longitudinal direction thereof and accommodated in the housing, and the joint portion which extends from the female connection portion which can be joined to the female connection portion of another of the terminals adjacent to the one of the terminals in a direction in which the housings are stacked one upon another by folding back the free end of the one of the terminals toward the one side thereof in the outside of the housing in its longitudinal direction thereof in the shape of U.

The present invention has been made in view of the above-described situation. Accordingly, it is an object of the present invention to provide an apparatus for processing a stacked-type connector of a wire harness which allows use of an automatic electrical connection art contributing to formation of a complete circuit, a housing holder, and a method of supplying the wire harness to the apparatus.

To achieve the object, according to the present invention, there is provided an apparatus for a processing stacked-type connector having terminals connected to electric wire and arranged parallel with one another in a predetermined direction, and housings each accommodating the arranged terminals and stacked one upon another in a direction perpendicular to the direction in which the terminals are arranged and connected to each other.

Each of the terminals has an electric wire connection portion formed at one end thereof in a longitudinal direction thereof and connected to an end of a coated electric wire. A female connection portion is formed at the other end thereof in the longitudinal direction thereof and accommodated in the housing, and a joint portion extends from the female connection portion, with a front end of the joint portion formed to have a generally U-shaped configuration and connected to the female connection portion of another terminal adjacent to the one terminal in a direction in which the housings are stacked one upon another.

The apparatus for processing the stacked-type connector includes a pressing unit configured to pressing the joint portion of the housing into the generally U-shaped configuration, and a stacking unit configured to sequentially stack the joint portion-pressed housings one upon another in a predetermined order.

In another aspect of the present invention, in constructing a part of the wire harness of the stacked-type connector proposed by the present applicant, the joint portion projecting from the housing is pressed to have a generally U-shaped configuration, and the pressed housing can be successively stacked one upon another. Thus it is possible to automatically produce a large-scale circuit very close to a complete circuit.

In a preferred aspect of the present invention, the apparatus includes a correction unit disposed between the pressing unit and the stacking unit. The correction unit is configured to a configuration of the joint portion shaped by the pressing unit. In this case, the joint portion shaped by the pressing unit is shaped again into a predetermined configuration. That is, it is possible to accurately shape the joint portion into the predetermined configuration and prevent disadvantages (for example, defective connection between terminal and female connection portion when housings are stacked one upon another) which may occur in subsequent stages.

In still another preferred aspect of the present invention, the apparatus further includes an electric wire guide unit provided on the stacking unit. The electric wire guide unit is configured to guide electric wires of the housings supplied to the stacking unit. In this case, it is possible to prevent the electric wires extending from the housing from interfering a housing-stacking operation when the stacking unit stacks the housings one upon another.

In still another preferred aspect of the present invention, the apparatus includes a housing supply unit configured to stock the housings in such a way that the housings can be supplied to the pressing unit in a housing-stacking order. In this case, in sequentially processing a plurality of housings, the protection and supply of the housing can be easily accomplished.

In still another preferred aspect of the present invention, the housing supply unit is configured to stock the housings in such a way that the housings can be supplied to the pressing unit by removably holding the housing holder unit accommodating the housings of the wire harness in a housing-stacking order.

In this case, because the wire harness and the housing holder unit can be treated as one unit, it is possible to perform the preceding processes, with the housing holder maintaining the housing-stacking order, and then supply the housings to the pressing unit in the housing-stacking order. Accordingly it is possible to smoothly accomplish automatic processing and improve workability.

In still another aspect of the present invention, there is provided a housing holder unit which is used for an apparatus for processing a stacked-type connector having the housing supply unit. The housing holder includes a holder body suppliably stocking housings of the stacked-type connectors in a housing-stacking order, and a protection cap provided for each of the housings held by the holder body and covering a joint portion of each of the housings. The protection cap is connected to the holder body in such a way that the protection cap is removed from the housing by a removal operation of the housings from the holder body.

In this case, in the process of manufacturing the wire harness, the protection cap can protect the joint portion of the each of the stacked-type connectors, and the housing can be supplied smoothly in the housing-stacking process which is performed by the processing apparatus.

In still another preferred aspect of the present invention, there is provided a wire harness supply method for supplying a stacked-type connector and a wire harness to the apparatus for processing the stacked-type connector described above. The method includes mounting a protection cap configured to cover an unprocessed joint portion on each of the housings at a time of manufacturing the wire harness, stocking the protection cap-mounted housings in a holder body forming a housing holder unit together with the protection cap in such a way that the housings can be supplied in a housing-stacking order, mounting the housing holder unit and the stacked-type connector on the wire harness, and supplying the wire harness and the housing holder unit mounted on the wire harness to the processing apparatus.

In a further aspect of the present invention, in the process of manufacturing the wire harness, the housing is covered with a protection cap which protects the joint portion of the terminal accommodated in the housing. Thus, in the entire process of manufacturing the wire harness, it is possible to protect the joint portion and prevent failures from occurring in the stages of the processing which is performed by the processing apparatus.

According to another aspect of the present invention, an apparatus is provided for processing a stacked-type connector having terminals connectable to electric wires and arranged parallel with one another in a predetermined direction, and housings each accommodating the arranged terminals and stackable one upon another and connected to each other, each of the terminals having a female connection portion formed at one end thereof in the longitudinal direction thereof and accommodated in the housing, and a joint portion extending from the female connection portion. The apparatus for processing the stacked-type connector includes a pressing unit configured to press the joint portion of the housing into a generally U-shaped configuration and a stacking unit configured to sequentially stack the joint portion-pressed housings one upon another in a predetermined order.

In another aspect of the present invention, the apparatus for processing a stacked-type connector may further include a correction unit disposed between the pressing unit and the stacking unit, with the correction unit being configured to correct a configuration of the joint portion shaped by the pressing unit. The apparatus for processing a stacked-type connector may also include a housing supply unit configured to stock the housings in such a way that the housings are suppliable to the pressing unit in a housing-stacking order, and the housing supply unit may be configured to stock the housings in such a way that the housings are suppliable to the pressing unit by removably holding a housing holder unit accommodating the housings of the wire harness in a housing-stacking order.

In a further aspect of the present invention, a housing holder unit usable in the apparatus for processing a stacked-type connector described above is provided. The housing holder unit includes a holder body configured to stock the housings of the stacked-type connectors in a housing-stacking order, and a protection cap is provided for each of the housings held by the holder body to cover joint portions of each of the housings. Additionally, the protection cap may be connected to the holder body in such a way that the protection cap is removed from the housing by a removal operation of the housings from the holder body.

It is another object of the present invention to provide an apparatus, for pressing joint portions of stacked-type connectors, which embodies the electrical connection art contributing to the formation of a complete circuit.

To achieve the object, according to another aspect of the present invention, there is provided an apparatus for pressing joint portions of stacked-type connectors each having terminals arranged parallel with one another in a predetermined direction in housings, with each housing accommodating the arranged terminals and stacked one upon another in a direction perpendicular to the direction in which the terminals are arranged.

The pressing apparatus is configured to press the joint portion of each terminal to having a generally U-shaped configuration such that the joint portion of one terminal can be joined to a female connection portion of another of the terminals adjacent to the one terminal in a direction in which the housings are stacked one upon another.

In this construction, each of the terminals has an electric wire connection portion formed at one end thereof in a longitudinal direction thereof and connected to an end of a coated electric wire. The female connection portion formed at the other end thereof in the longitudinal direction thereof is accommodated in the housing, and the joint portion extends from the female connection portion with a front end of the joint portion projecting from the housing.

The pressing apparatus includes a frame member configured to hold the housing, with the joint portion placed in a predetermined pressing position, a first pressing portion configured to sandwich a linear joint portion placed in the predetermined pressing position under pressure and to bend a front end of the joint portion. The pressing apparatus further includes a second pressing portion configured to bend the joint portion to have a generally U-shaped configuration by folding back a base end of the terminal with respect to the bent joint portion after the first pressing portion bends the joint portion, and a driving mechanism configured to sequentially drive the first pressing portion and then the second pressing portion.

According to a further aspect of the present invention, the housing is mounted on the frame member, and the joint portion projecting from the housing is set at the pressing position. Thereafter, the driving mechanism initially drives the first pressing portion, and then drives the second pressing portion to bend an intermediate portion of the joint portion and then the base end thereof. Thus, the entire joint portion is formed to have a generally U-shaped configuration.

It is preferable that both pressing portions of the pressing apparatus have a housing holder for placing the housing in position. In this case, it is possible to increase the positioning accuracy by placing the housing in position in the single frame member.

In another aspect of the present invention, the first pressing portion includes a pair of dies configured to sandwich therebetween all of the joint portions projecting from the connectors placed at the predetermined pressing position of the frame member. In this case, all the joint portions are processed by a single sandwiching operation. Therefore, it is possible to improve the processing efficiency.

In a further aspect of the present invention, the frame member includes a guide member configured to guide the pair of the dies along the same line.

According to another aspect of the present invention, the second pressing portion includes a die configured to bend all of the joint portions of the terminals in a space between the die and the housings of the connectors placed at the predetermined pressing position of the frame member. In this case, a single cantilevered die performs the second forming process of the joint portion.

In another aspect of the present invention, the die of the second pressing portion has a punching portion configured to press all of the joint portions projecting from the connectors. In this case, too, all the joint portions are processed by a single sandwiching operation. Therefore, it is possible to improve the processing efficiency.

It is a further object of the present invention to provide an apparatus and a method, for stacking housings of stacked-type connectors, which embody an electrical connection art contributing to formation of a complete circuit.

To achieve this object, according to the present invention, there is provided an apparatus for stacking housings of stacked-type connectors each having terminals arranged parallel with one another in a predetermined direction, and housings accommodating the arranged terminals and stacked one upon another in a direction perpendicular to the direction in which the terminals are arranged and connected to each other.

Each of the terminals has an electric wire connection portion formed at one end thereof in a longitudinal direction thereof and connected to an end of a coated electric wire, a female connection portion formed at the other end thereof in the longitudinal direction thereof and accommodated in the housing, and a joint portion extending from the female connection portion, with a front end of the joint portion formed to have a generally U-shaped configuration and connectable to a female connection portion of another terminal adjacent to the one of the terminals in a direction in which the housings are stacked one upon another.

The apparatus also includes a housing-holding portion configured to hold the housings of stacked-type connectors in a stacking order, a correction mechanism that corrects a configuration of the joint portion projecting from one of the housings held by the housing-holding portion and connectable to the female connection portion of another of the housings to be stacked on the one housing held by the housing-holding portion, and the correction mechanism being movable between a correction position where the joint portion is corrected and a position away from the joint portion that allows the joint portion to be connected to the female connection corresponding thereto. The apparatus further includes a fit-in mechanism that temporarily fits the another of the housings to the one housing after the configuration of the joint portion of the one housing is corrected by the joint portion correction mechanism and normally fitting both housings to each other after the correction mechanism moves away from the joint portion correction position.

In the present invention, the lowermost (or uppermost) housing is supplied to the housing-holding portion and held thereby. Thereafter the joint portion correction mechanism is displaced to the correction position. Thereby, the configuration of the joint portion projecting from the housing held by the housing-holding portion is corrected. Then, the next housing to be stacked on the housing held by the housing-holding portion is supplied thereto to temporarily fit both housings in each other. Thus the configuration-corrected joint portion can be smoothly connected to a terminal to be connected to the joint portion. Thereafter, both housings are fitted to each other normally. Thus, a smooth connection operation can be accomplished without error in the fit-in operation.

In another aspect of the present invention, the correction mechanism includes a position regulation member configured to receive a lower surface of a free end of the joint portion of the one housing positioned in the housing-holding portion, and a correction member configured to press an upper surface of the free end of the joint portion downward, with the joint portion sandwiched between the correction member and the position regulation member. In this aspect, the correction member is capable of correcting the configuration of the free end of the joint portion precisely, with the position regulation member preventing an excessive deformation of the free end of the joint portion. Thus, it is possible to correct the configuration of the joint portion very precisely and accurately.

In still another aspect of the present invention, the apparatus further includes a locking mechanism configured to move between a locking condition in which one of the housings initially placed in the housing-holding portion is locked to the housing-holding portion and an unlocking condition. In this aspect, subsequent housings placed in the housing-holding portion can be locked temporarily. Thus, the position of each housing is stable, which allows a temporary fit-in operation to be accomplished easily.

In still another aspect of the present invention, the locking mechanism includes a sliding member configured to move between a housing-locking position and a housing-unlocking position. The locking mechanism also includes a connection member connected to the sliding member so that the sliding member is movable from the housing-unlocking position to the housing-locking position in unison with a fit-in operation of the fit-in mechanism. In this aspect, it is possible to interlock the housing-locking operation of the locking mechanism to the operation of the fit-in mechanism. Therefore it is possible to lock the housing automatically by merely operating the fit-in mechanism.

It is preferable that the apparatus further includes a holding mechanism configured to hold the sliding member at the locking position. The connection member connects the sliding member and the fit-in mechanism to each other so that the fit-in mechanism moves relative to the sliding member located at the locking position to perform an operation of fitting the housings together. In this aspect, with the lowermost housing locked by the locking mechanism, the remaining housings can be stacked one upon another by repeating the fit-in operation. Thus the housing fit-in operation can be accomplished easily.

In still another aspect of the present invention, there is provided a method for stacking housings of stacked-type connectors each having terminals arranged parallel with one another in a predetermined direction, and housings accommodating the arranged terminals and stacked one upon another in a direction perpendicular to the direction in which the terminals are arranged and connected to each other. Each of the terminals has an electric wire connection portion formed at one end thereof in a longitudinal direction thereof and connected to an end of a coated electric wire, a female connection portion formed at the other end thereof in the longitudinal direction thereof and accommodated in the housing, and a joint portion extending from the female connection portion, with a front end of the joint portion formed to have a generally U-shaped configuration and connectable to the female connection portion of another of the terminals adjacent to the one of the terminals in a direction in which the housings are stacked one upon another.

The method includes holding the housings of stacked-type connectors in a stacking order by a housing-holding portion, correcting with a correction mechanism a configuration of the joint portion projecting from one of the housings held by the housing-holding portion and joined to the female connection portion of another of the housings to be stacked on the one housing held by the housing-holding portion, and fitting the another housing in the one housing after the configuration of the joint portion of the one housing is corrected by the joint portion correction mechanism, with the another housing pressing the plate-shaped correction member rearward. The correction mechanism may include a plate-shaped correction member.

In the present invention, the lowermost (or uppermost) housing is held. Then the configuration of the joint portion is corrected by the correction member. Thus, the configuration of the joint portion projecting from the housing can be corrected in such a way that the joint portion can be connected to the female connection portion of the next-layer housing. The housing having the joint portion corrected and the next-layer housing are fitted to each other, with the next-layer housing pressing the correction member. Therefore, in the entire process of fitting both housings to each other, it is possible to keep the condition in which the joint portion of the lower housing can be securely connected to the female connection portion of the upper housing. Accordingly, even though the fit-in operation is performed automatically, it is possible to smoothly fit both housings to each other.

### BRIEF DESCRIPTION OF THE DRAWINGS

The above and other objects, features and advantages of the present invention will be made apparent from the following description of the preferred embodiments, given as non-limiting examples, with reference to the accompanying drawings in which:

FIG. 1 is a perspective view showing main portions of a connector according to an embodiment of the present invention;

FIG. 2 is a side view showing a housing of the connector shown in FIG. 1;

FIG. 3 is a rear view showing the housing of the connector shown in FIG. 1;

FIG. 4 is a perspective view showing one step of the process of manufacturing a pressing plate (terminal) of the connector shown in FIG. 1;

FIG. 5 is a perspective view showing another step of the process of manufacturing the connector shown in FIG. 1;

FIG. 6 is a perspective view showing a further step of the process of manufacturing the connector shown in FIG. 1;

FIG. 7 is a perspective view showing another step of the process of manufacturing the connector shown in FIG. 1;

FIG. 8 is a perspective view showing a further step of the process of manufacturing the connector shown in FIG. 1;

FIG. 9 is a sectional view showing an additional step of the process of manufacturing the connector shown in FIG. 1;

FIG. 10 is a schematic plan view showing a processing apparatus for processing a stacked-type connector according to an embodiment of the present invention;

FIG. 11 is a schematic side view showing the processing apparatus according to the embodiment shown in FIG. 10;

FIG. 12 is a perspective view showing a schematic construction of a feeding unit according to the embodiment shown in FIG. 10;

FIG. 13 is a schematic rear view showing a schematic construction of the feeding unit according to the embodiment shown in FIG. 10;

FIG. 14 is a perspective view at a front side showing a schematic construction of a housing supply unit of the processing apparatus shown in FIG. 10;

FIG. 15 is a perspective view at a rear side showing a schematic construction of the housing supply unit of the processing apparatus shown in FIG. 10;

FIG. 16 is a schematic plan view showing the housing supply unit of the processing apparatus shown in FIG. 10;

FIG. 17 is a schematic side view showing the housing supply unit of the processing apparatus shown in FIG. 10;

FIG. 18 is a schematic front view showing a housing take-out stage in the housing supply unit of the processing apparatus shown in FIG. 10;

FIG. 19 is a schematic plan view showing a pressing unit according to the embodiment shown in FIG. 10;

FIG. 20 is a front view showing the pressing unit according to the embodiment shown in FIG. 19;

FIG. 21 is a perspective view showing the construction of a housing guide of the pressing unit according to the embodiment shown in FIG. 19;

FIG. 22 is a perspective view showing a first forming portion according to the embodiment shown in FIG. 10;

FIG. 23 is an enlarged schematic view showing a forming stage of the first forming portion according to the embodiment shown in FIG. 10;

FIG. 24 is a perspective view showing a schematic construction of a first forming operation portion according to the embodiment shown in FIG. 10;

FIG. 25 is an enlarged schematic view showing a forming stage of the first forming portion and a second forming portion according to the embodiment shown in FIG. 10;

FIG. 26 is an enlarged schematic view showing a forming stage of the first forming portion and the second forming portion according to the embodiment shown in FIG. 10;

FIG. 27 is an enlarged schematic view showing a forming stage of the first forming portion and the second forming portion according to the embodiment shown in FIG. 10;

FIG. 28 is a perspective view showing a schematic construction of a correction unit installed on a correction/inspection station according to the embodiment shown in FIG. 10;

FIGS. 29(A)-(C) are partly enlarged schematic plan view showing the operation of the correction unit shown in FIG. 28;

FIG. 30 is a perspective view showing a schematic construction of a stacking unit according to the embodiment shown in FIG. 10;

FIG. 31 is a side view showing the stacking unit of FIG. 30;

FIG. 32 is a schematic perspective view showing a schematic construction of component parts disposed in the periphery of a transfer guide shown in FIG. 30;

FIG. 33 is a schematic front view showing the stacking unit shown in FIG. 30;

FIG. 34 is a partly enlarged schematic plan view showing an operation procedure of the stacking unit shown in FIG. 30;

FIG. 35 is a partly enlarged schematic plan view showing the operation procedure of the stacking unit shown in FIG. 30;

FIG. 36 is a partly enlarged schematic plan view showing the operation procedure of the stacking unit shown in FIG. 30;

FIG. 37 is a perspective view showing a schematic construction of a joint portion pressing apparatus according to an embodiment of the present invention;

FIG. 38 is an exploded perspective view showing a schematic construction of the joint portion pressing apparatus shown in FIG. 37;

FIG. 39 is a perspective view showing a schematic construction of a housing holder of the embodiment shown in FIG. 37;

FIG. 40 is a perspective view showing a housing held by the housing holder of the embodiment shown in FIG. 37;

FIG. 41 is a side view showing a schematic construction of the joint portion pressing apparatus according to the embodiment shown in FIG. 37;

FIG. 42 is a perspective view showing a first forming unit according to the embodiment shown in FIG. 37;

FIG. 43 is a main portion-enlarged schematic view showing a forming process which is performed by the first forming unit according to the embodiment shown in FIG. 37;

FIG. 44 is a side schematic view showing the forming process which is performed by the first forming unit according to the embodiment shown in FIG. 37;

FIG. 45 is an enlarged perspective view showing a schematic construction of a second forming unit and a second forming operation portion according to the embodiment shown in FIG. 37;

FIG. 46 is a side schematic view showing a forming process which is performed by a second forming unit according to the embodiment shown in FIG. 37;

FIG. 47 is a main portion-enlarged schematic view of FIG. 46;

FIG. 48 is a schematic front view showing another embodiment of the present invention;

FIG. 49 is a perspective view showing a schematic construction of a housing-stacking apparatus according to an embodiment of the present invention;

FIG. 50 is an exploded perspective view showing a schematic construction of the housing-stacking apparatus shown in FIG. 49;

FIG. 51 is a perspective view showing a positioning unit of the embodiment shown in FIG. 49;

FIG. 52 is a partly broken-away schematic side view showing the housing-stacking apparatus of the embodiment shown in FIG. 49;

FIG. 53 is a partly broken-away schematic side view showing the housing-stacking apparatus of the embodiment shown in FIG. 49;

FIG. 54 is a partly broken-away schematic side view showing the housing-stacking apparatus of the embodiment shown in FIG. 49;

FIG. 55 is a partly broken-away schematic side view showing the housing-stacking apparatus of the embodiment shown in FIG. 49;

FIG. 56 is a partly enlarged schematic sectional view showing the process of stacking housings one upon another in the embodiment shown in FIG. 49; and

FIG. 57 is a partly enlarged schematic front view showing the process of stacking housings one upon another in the embodiment shown in FIG. 49.

### DETAILED DESCRIPTION OF THE PREFERRED EMBODIMENTS

A preferred embodiment of the present invention will be described below with reference to accompanied drawings.

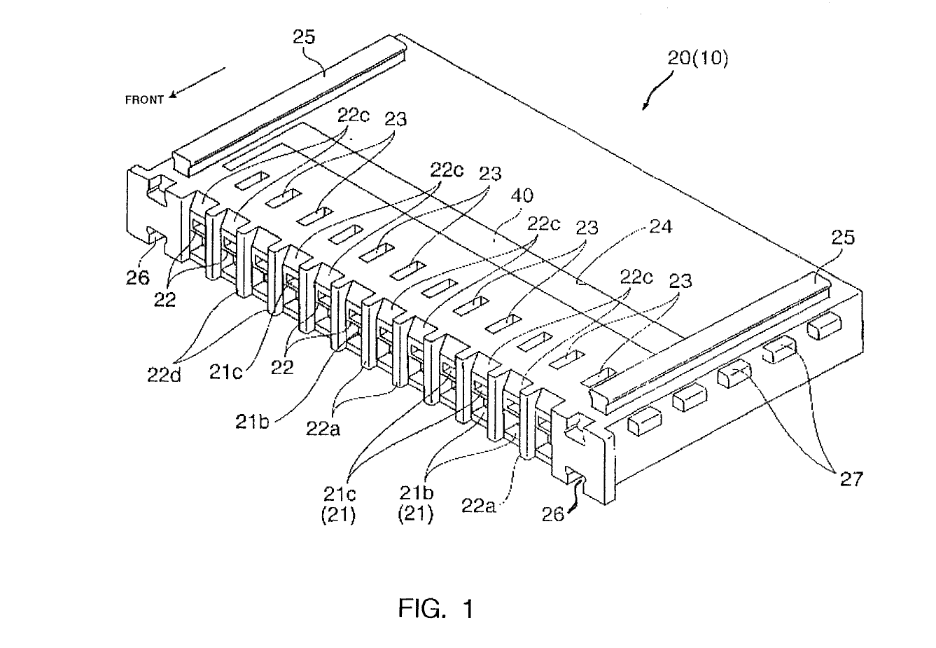

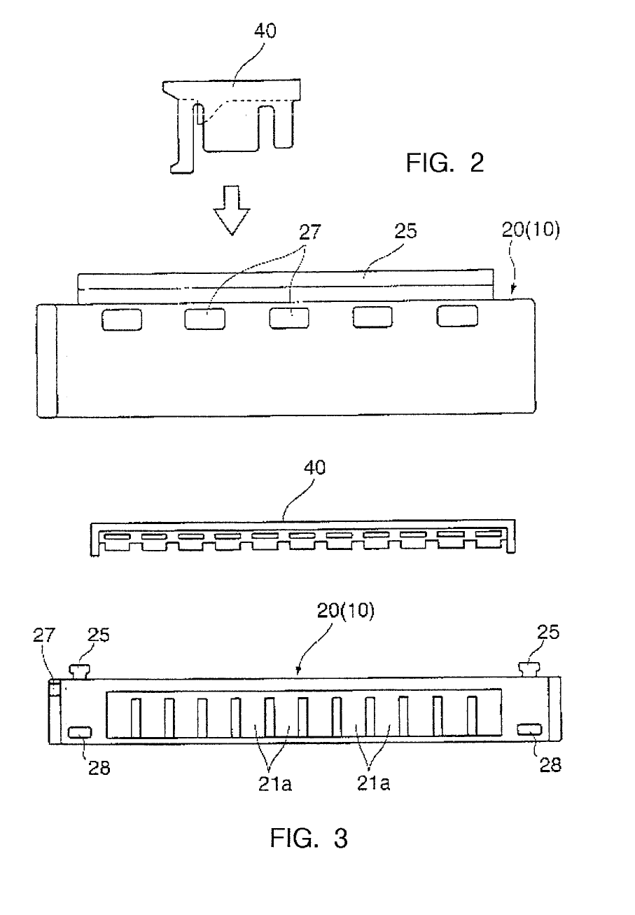

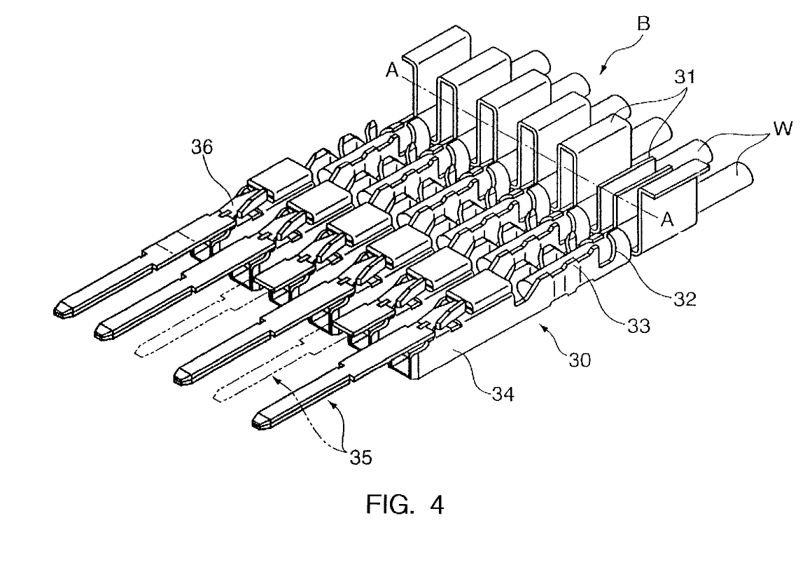

FIG. 1 is a perspective view showing main portions of a connector according to an embodiment of the present invention. FIG. 2 is a side view showing a housing of the connector shown in FIG. 1. FIG. 3 is a rear view showing the housing of the connector shown in FIG. 1. FIG. 4 is a perspective view showing a pressing plate (terminal) of the connector shown in FIG. 1.

The connector 10 shown in these figures has a housing 20 and terminals 30 to be accommodated in the housing 20. Each terminal 30 is connected to an electric wire W. In the description which will follow, the direction in which the terminal 30 is inserted into the housing 20 is set as the forward direction.

As will be described later, the housings 20 are vertically stacked one upon another to form the contour of the stacked-type connectors 10. The housing 20 is monolithically made of synthetic resin and has a shape of an approximately rectangular solid. The housing 20 has a plurality of cavities 21 which can accommodate the terminals 30 (see FIG. 4), with the terminals 30 arranged widthwise parallel with one another. Each cavity 21 is open at its front and rear ends. A terminal-mounting opening 21a (see FIG. 3) in which the terminal 30 is mounted is formed at the rear end of the cavity 21. In FIG. 3, reference numeral 28 denotes a positioning hole.

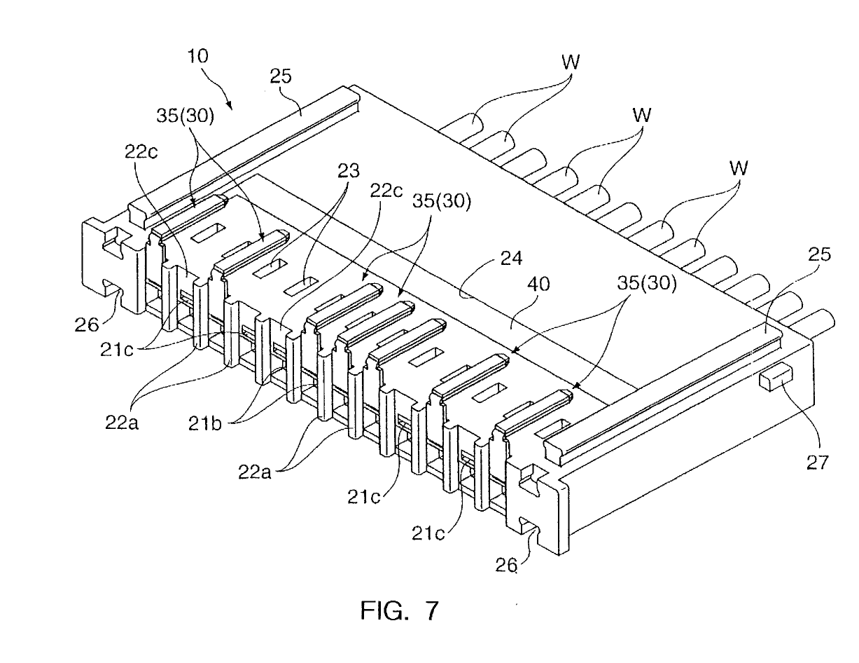

A partitioning portion 22 is formed on the front-end wall of the housing 20. The partitioning portion 22 partitions the cavity 21 into a terminal connection opening 21b at its lower side and a tab-projecting opening 21c at its upper side. Ribs 22a partitioning the cavities 21 vertically are formed on the front-end wall of the housing 20. In the embodiment shown in the drawings, a chamfered portion 22c is formed on the front end of the cavity 21 in consideration of spring back which occurs when a joint portion 35 of the terminal 30 is bent (see FIG. 7).

A plurality of lance-engaging holes 23 corresponding to the respective cavities 21 are formed on the upper wall of the housing 20 in such a way that the lance-engaging holes 23 are spaced at regular intervals equal to the interval between the adjacent cavities 21. For each cavity 21, a retainer-mounting hole 24 in which a retainer 40 for double locking the terminal 30 accommodated in the cavity 21 is formed at the rear side of each lance-engaging hole 23.

A guide rib 25 is formed at left and right sides of the upper wall of the housing 20. Each guide rib 25 slides longitudinally in a slide groove 26 recessed in the lower wall of the upper housing 20 when stacked on the lower housing 20 when the housings 20 are stacked one upon another, thus fitting into the slide groove 26.

The rear end of the slide groove 26 is closed, whereas its front side is open at the front of the housing 20. Thus in the embodiment, when a plurality of the housings 20 are mounted vertically one upon the other, the upper housing 20 slides forward on the lower housing 20.

With reference to FIG. 2, a plurality of projections 27 are formed on both side walls of the housing 20 to specify the stacking position of the housing 20 when the housings 20 are stacked one upon another. The projections 27 are cut selectively before the housings 20 are stacked one upon another.

The terminal 30 will be described below with reference to FIG. 4.

The terminals 30 are manufactured by using a press which bends conductive metal materials spaced at predetermined intervals in correspondence to long, narrow carriers 31 arranged at the interval at which the conductive metal materials are spaced. All of the terminals 30 constitute a group of terminals B. The rear end of each terminal 30 is connected to the carrier 31. The front end of each terminal 30 is approximately perpendicular to the longitudinal direction of the carrier 31. A barrel portion 32 to be crimped to a coating portion of an electric wire W is formed at the rear portion of the terminal 30. A pair of front and rear pressure-welding portions 33 (example of electric wire connection portion), which bite into the coating portion of the electric wire W and are connected to an inner core wire, are provided forwardly of the barrel portion 32. A rectangular solid-shaped connection portion 34 is formed at the front portion of the terminal 30. A joint portion 35 extends from the upper front end of the connection portion 34. The terminal 30 has the construction of a male terminal fitting and that of a female terminal fitting. As will be described later, when a plurality of housings 20 are stacked vertically one upon another, the joint portion 35 of the terminal 30 disposed immediately under the upper housing 20 can be connected to the connection portion 34 of the upper housing 20. Reference numeral 36 denotes a lance.

Each terminal 30 is bent, with the terminal 30 connected to the carrier 31. The terminals are spaced at intervals in correspondence to the intervals at which the cavities 21 are spaced. The group of terminals B consisting of the terminals 30 is split into an appropriate number of terminals 30 in correspondence to the number of poles of the housing 20.

Except the joint portion 35 required to be connected to the terminal 30 disposed immediately on the lower housing, other joint portions 35 are cut from the base portions thereof. The portion of the carrier 31 disposed above the imaginary line A shown in FIG. 4 is selectively cut off with a cutting device.

With reference to FIGS. 1 through 3, after the terminal 30 (or the pressing plate B) is mounted on the housing 20, the retainer 40 is fitted in the retainer-mounting hole 24 of the housing 20 to lock each terminal 30 to the housing 20.

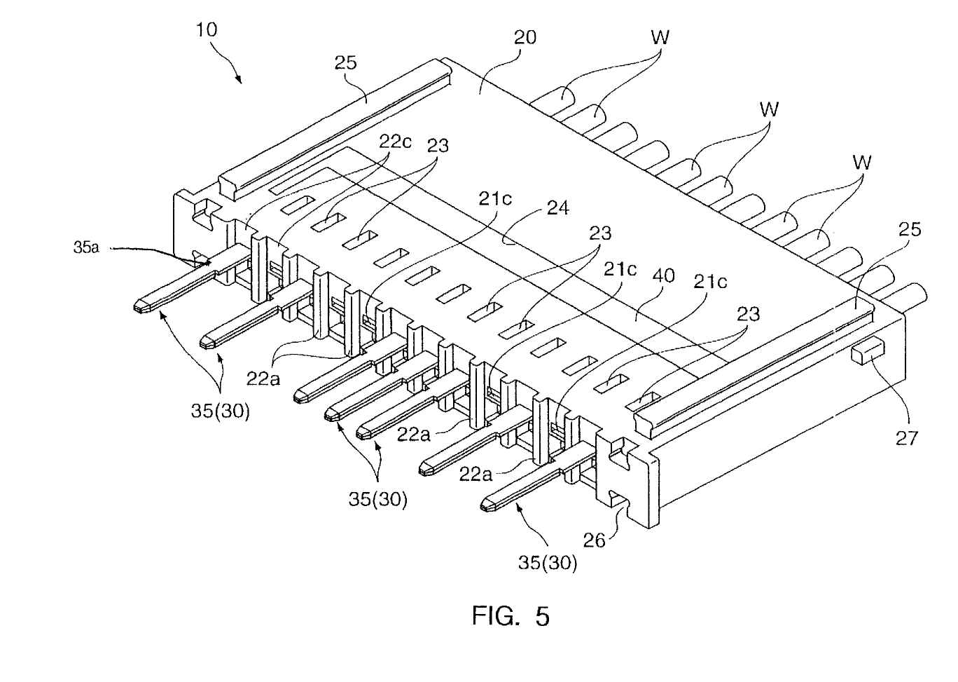

The outline of the stages of manufacturing the connector 10 will be described below with reference to FIGS. 5 through 9. Referring to FIG. 5, the terminal 30 is inserted into the cavity 21 formed in each housing 20. FIG. 5 shows the housing 20 located at the lowermost position when the terminal 30 is mounted in each cavity 21. Referring to FIG. 5, the terminal 30 having the joint portion 35 not cut off projects from the tab-projecting opening 21c of the cavity 21.

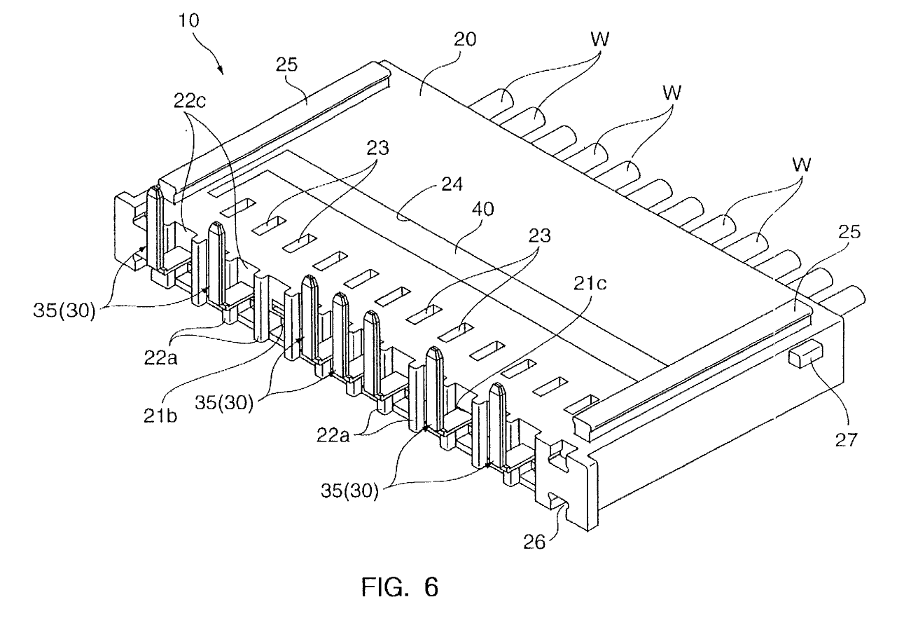

As shown in FIG. 6, the front side of the joint portion 35 is bent upwardly approximately perpendicularly by a processing apparatus AS which will be described later. Thereafter as shown in FIG. 7, the rear side of the joint portion 35 with respect to the bent portion is bent rearwardly perpendicularly. In this manner, the entire joint portion 35 is formed to have a generally U-shaped configuration. The front end of the joint portion 35 of the terminal 30 of the lower housing 20 is at a position where the front end thereof can be inserted into the terminal connection opening 21b of an upper housing 20.

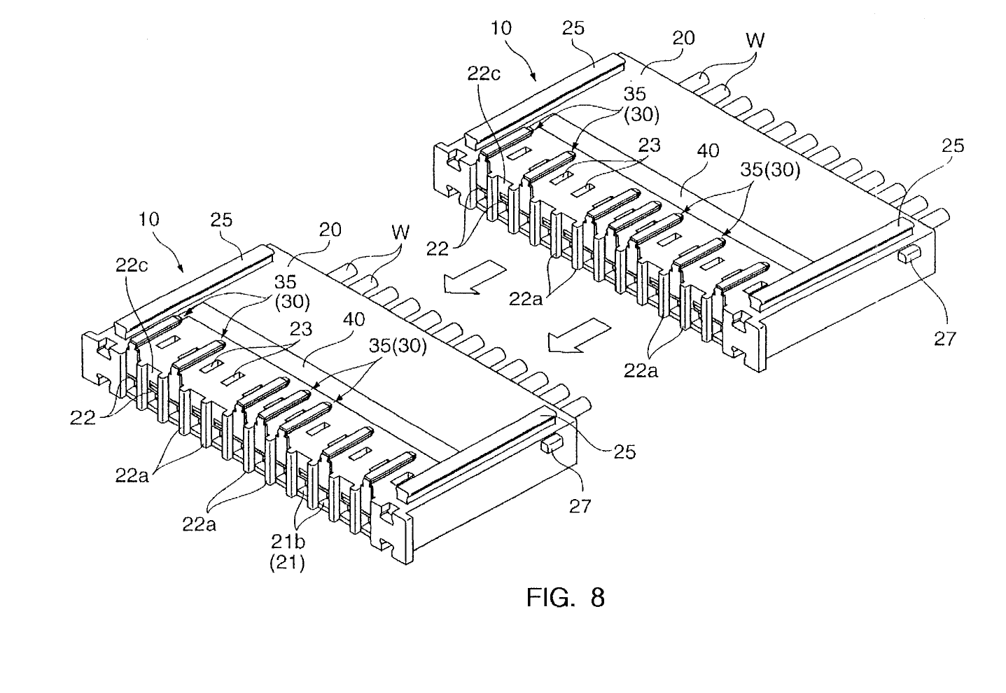

Thereafter, as shown in FIG. 8, the second-stage housing 20 is mounted on the upper portion of the lowermost housing 20 from the rear end of the lowermost housing 20 in such a way that the second-stage housing 20 slides horizontally on the upper portion of the lowermost housing 20. The guide ribs 25 of the lowermost housing 20 are positioned in the slide grooves 26 open at the front end of the lower surface of the second-stage housing 20. Thereafter, the second-stage housing 20 is slid forward. As a result of the connection between the lowermost housing 20 and the second-stage housing 20, the joint portion 35 projecting from the lowermost housing 20 penetrates into the cavity 21 from the terminal connection opening 21b of the second-stage housing 20. Consequently, the terminal 30 of the lowermost housing 20 and that of the second-stage housing 20 are electrically connected to each other.

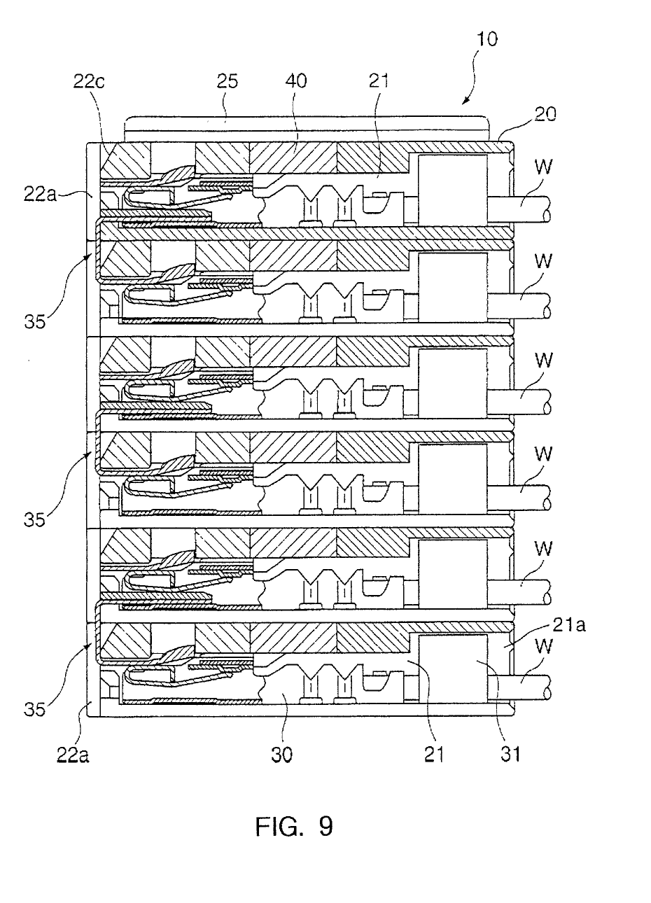

When the housing 20 is pressed into a predetermined position, the upper and lower housings are connected to each other at a predetermined mounting position where the positions of the front and rear ends of both housings 20 are coincident with each other. The connection work is performed sequentially from the lower housing 20 to the upper housing 20. When the housings 20 at a plurality of stages are normally mounted one upon another, the mounting of the stacked-type connector 10 is completed, as shown in FIG. 9.

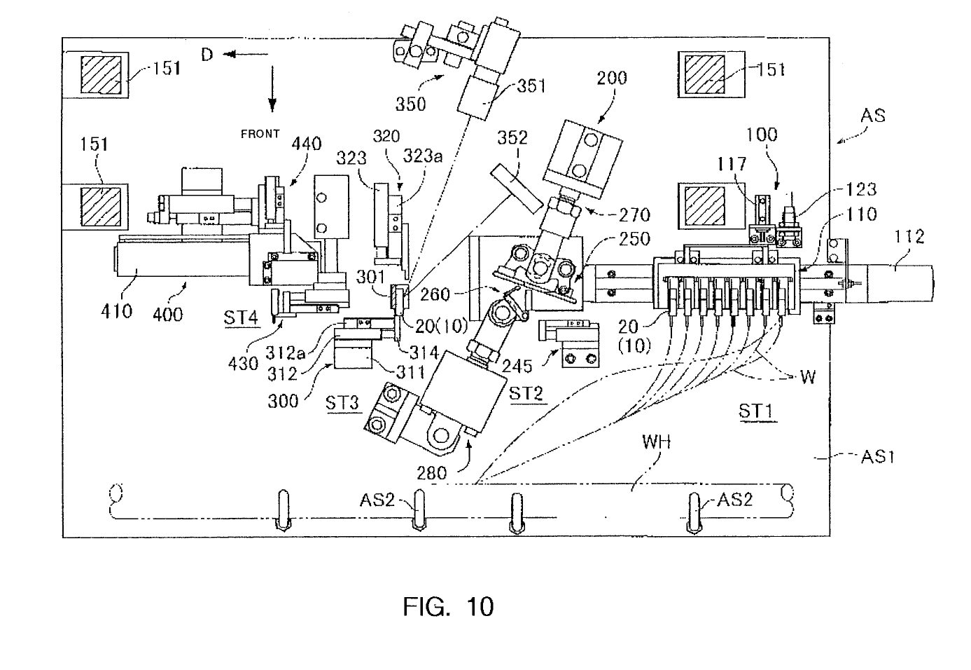

The stacked-type connector 10 can be automatically processed by the processing apparatus AS shown in FIG. 10 and subsequent drawings.

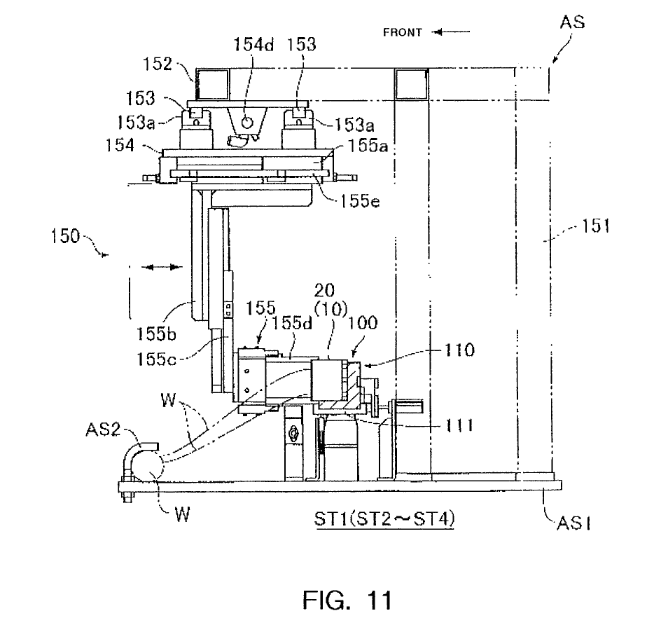

FIG. 10 is a schematic plan view showing a processing apparatus AS according to an embodiment of the present invention. FIG. 11 is a schematic side view showing the processing apparatus AS according to the embodiment shown in FIG. 10.

With reference to FIGS. 10 and 11, the stacked-type connector 10 is connected to an electric wire W constituting a branch wire of a wire harness WH. The processing apparatus AS is supplied with housings 20 and terminals 30 in the condition as shown in FIG. 5. At this time, each housing 20 is accommodated in a housing holder 110 (example of body of holder), with the unprocessed joint portion 35 protected with a protection cap 101 which will be described in detail with reference to FIG. 14 and subsequent drawings.

As will be described later in detail, the housing holder 110 is constructed to hold each housing 20 in such a way that it stocks the housings 20 of the stacked-type connector 10 in a stacking order. The housing holder 110 and the protection cap 101 protecting the joint portion 35 of the housing 20 constitute a housing holder unit.

The processing apparatus AS has a base AS1 capable of holding the wire harness WH. On the base AS1, there are provided a housing supply station ST1 on which a housing supply unit 100 is installed, a press station ST2 on which a pressing unit 200 is installed, a correction/inspection station ST3 on which a correction unit 300 and an image pick-up/inspection unit 350 are installed, and a stacking station ST4 on which a stacking unit 400 is installed. A feeding unit 150 mounted on the base AS1 feeds the housings 20 stocked in the housing supply station ST1 to the stations ST2-ST4 in the above-described order so that each state ST performs a predetermined processing.

In the description which will follow, a feeding direction means the direction from the upstream side to the downstream side in the direction in which the stations ST1 through ST4 are arranged.

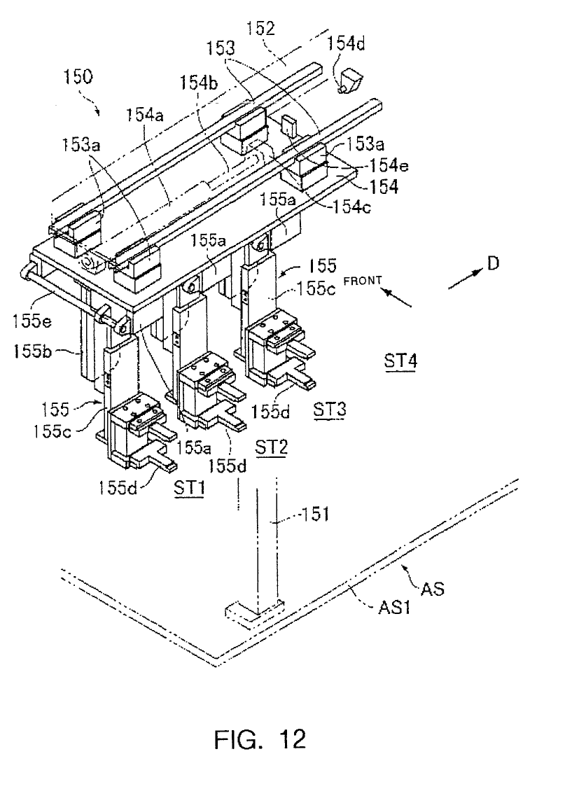

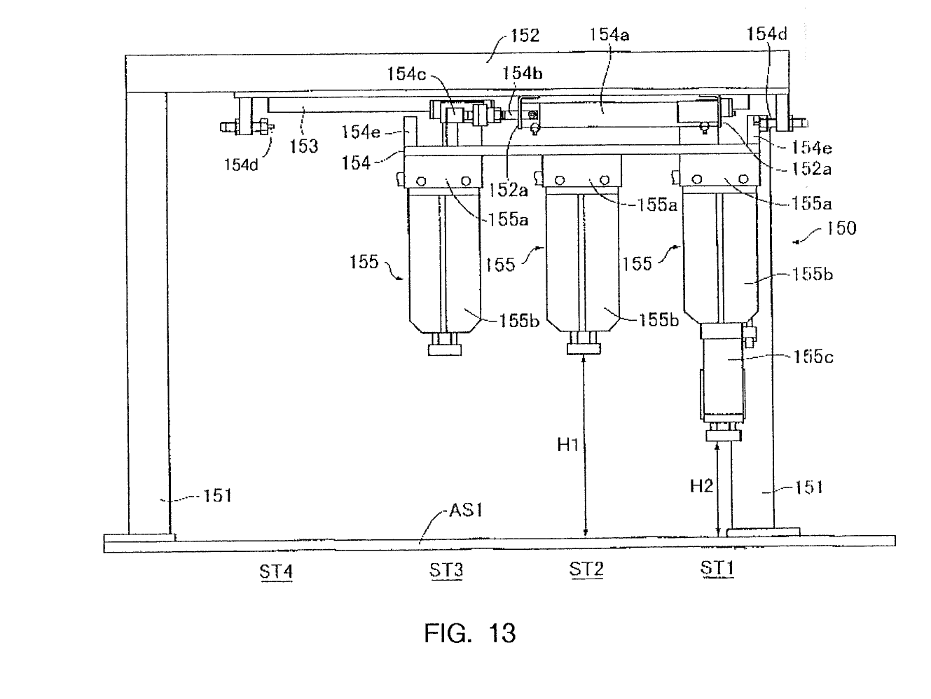

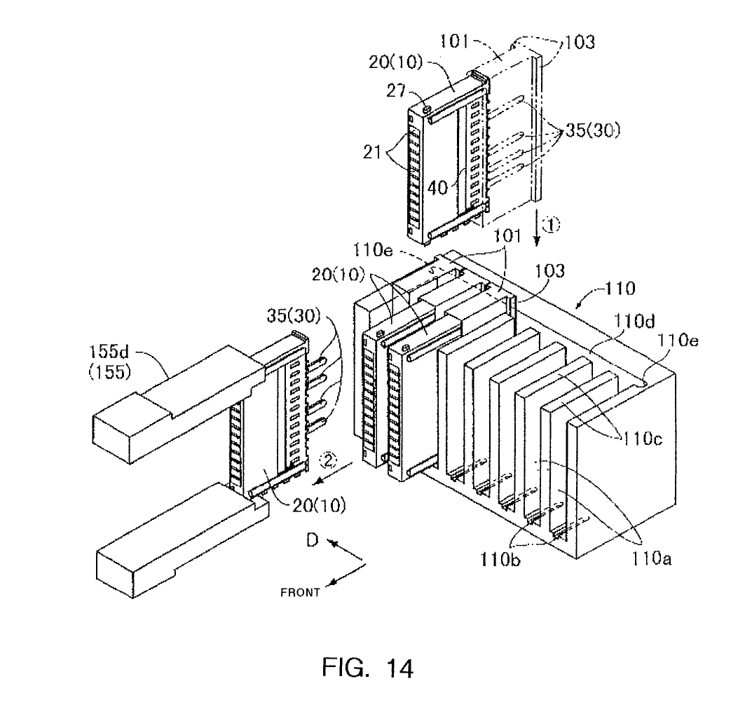

FIG. 12 is a perspective view showing a schematic construction of the feeding unit 150 according to the embodiment shown in FIG. 10. FIG. 13 is a schematic rear view showing a schematic construction of the feeding unit 150 according to the embodiment shown in FIG. 10.

With reference to FIGS. 10 through 13, the feeding unit 150 has a plurality of pillars 151 extending upwardly on the processing apparatus AS, a beam 152 supported by the pillars 151, a pair of rails 153 formed on the bottom surface of the beam 152, a slider 154 mounted on the rails 153 through two pairs of linear ways 153a, and three hand units 155 installed on the lower surface of the slider 154.

A pair of the rails 153 extends along the feeding direction D and allows the hand unit 155 to reciprocate along the feeding direction D through the slider 154.

With reference to FIG. 13, to reciprocate the slider 154 along the feeding direction D, an air cylinder 154a is fixed to the lower surface of the beam 152 through a pair of stays 152a, and a rod 154b of the air cylinder 154a is fixed to an upper portion of the slider 154 through a mounting member 154c. A pair of shock absorbers 154d is disposed on the lower surface of the beam 152. A projection 154e is formed at opposite ends of the slider 154 in such a way that the projection 154e can contact each shock absorber 154d. The pair of the shock absorbers 154d and the projections 154e regulate the movable range of the slider 154 and absorb an impact generated by the slider 154 when it stops. In the embodiment, the slider 154 reciprocates by one span of each of the stations ST1 through ST4. The hand units 155 are spaced at regular intervals at which the stations ST1 through ST4 are spaced. Each hand unit 155 reciprocates between two predetermined stations. As will be described later, each hand unit 155 feeds a housing 20 to the stations ST1 through ST4 in the order of the stations ST1 to ST4.

Each hand unit 155 is mounted on the bottom surface of the slider 154 and has a rod-less cylinder 155a extending horizontally (the slider side of the processing apparatus AS is set as “forward” in this direction) perpendicular to the feeding direction D, a vertical member 155b reciprocated forwardly and rearwardly by the rod-less cylinder 155a, an air cylinder 155c mounted on the vertical member 155b, and an air chuck 155d which is vertically moved by the air cylinder 155c.

The rod-less cylinder 155a serves as a means for inserting and removing the housing 20 by moving each air chuck 155d forwardly and rearwardly. In the embodiment, a guide bar 155e is disposed alongside the rod-less cylinder 155a (see FIGS. 11, 12).

As shown in FIG. 13, the air cylinder 155c moves the air chuck 155d in the gap between a predetermined transfer height H1 and a housing removal height H2 set lower than the transfer height H1. By selectively driving the air cylinder 154a, the rod-less cylinder 155a, the air cylinder 155c, and the air chuck 155d, each hand unit 155 grips a housing 20 and transfers the housing 20 from the upstream-side station ST1 (-ST3) to the downstream-side station ST2 (-ST4) and removes the housing 20 supplied to the housing supply station STI in a predetermined order. It is possible to stack the housings one upon another through predetermined stages.

The housing supply unit 100 installed on the housing supply station ST1 will be described below in detail with reference to FIGS. 14 through 17.

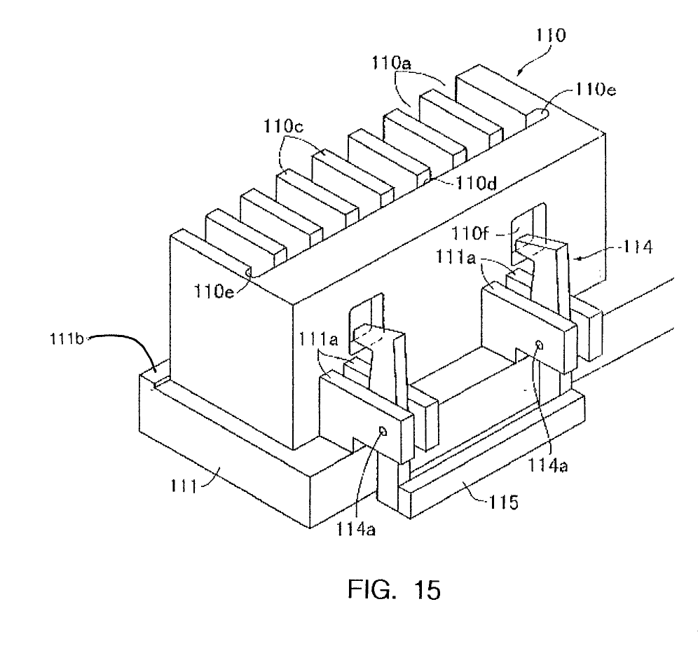

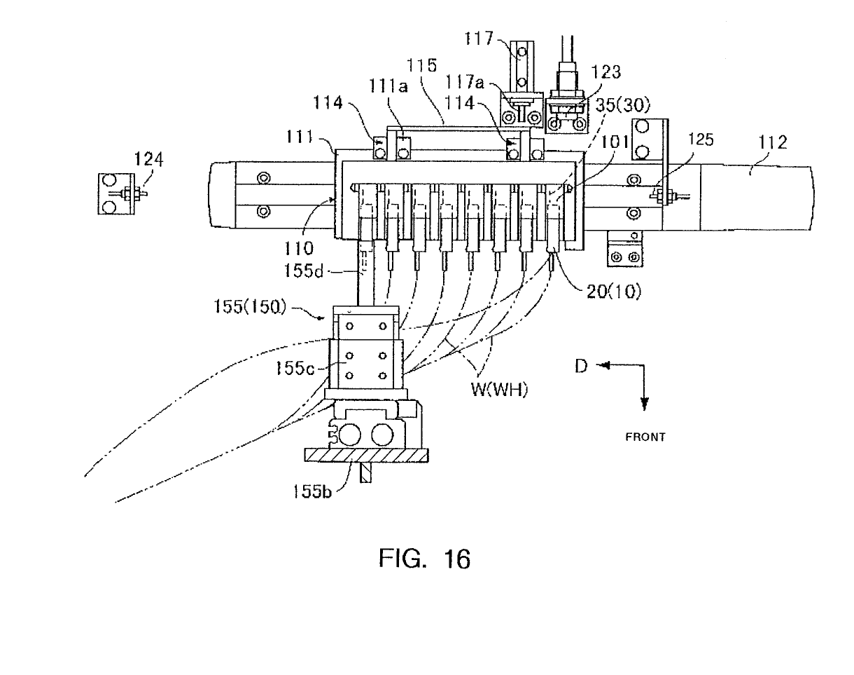

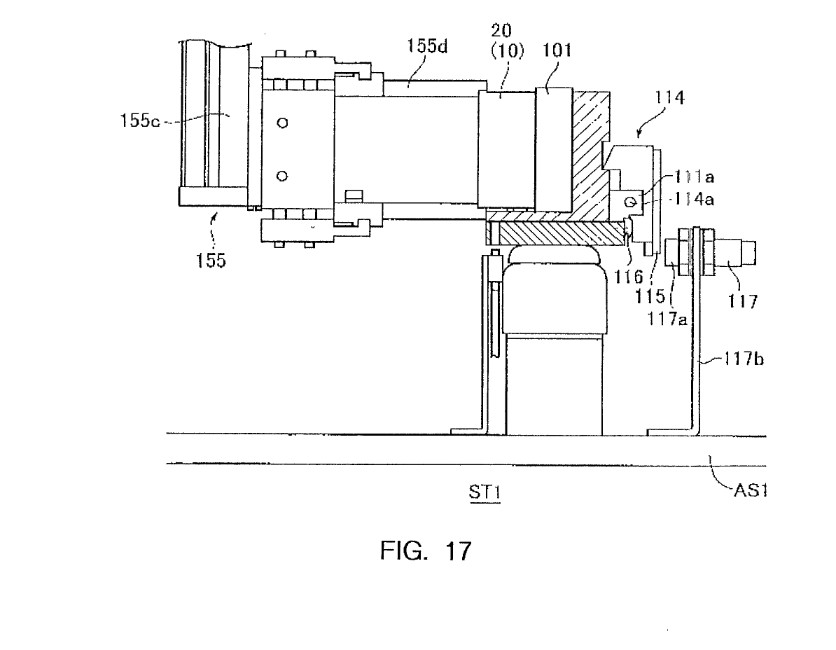

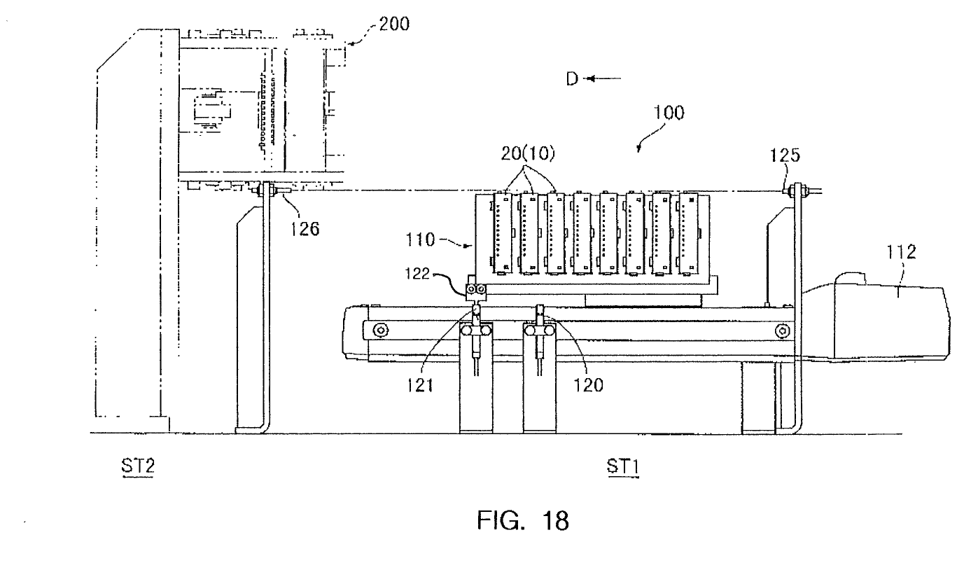

FIG. 14 is a perspective view at a front side showing a schematic construction of the housing supply unit 100 of the processing apparatus AS shown in FIG. 10. FIG. 15 is a perspective view at a rear side showing a schematic construction of the housing supply unit 100 of the processing apparatus AS shown in FIG. 10. FIG. 16 is a schematic plan view showing the housing supply unit 100 of the processing apparatus AS shown in FIG. 10. FIG. 17 is a schematic side view showing the housing supply unit 100 of the processing apparatus AS shown in FIG. 10. FIG. 18 is a schematic front view showing a housing removal stage in the housing supply unit 100 of the processing apparatus AS shown in FIG. 10.

With reference to FIGS. 14 through 17, the housing supply unit 100 has the housing holder 110, a slide table 111 removably carrying the housing holder 110, and one-axis robot 112 which reciprocates the slide table 111 along the feeding direction.

In the housing holder 110, a recess 110a is formed to arrange all the housings 20 to be stacked one upon another by the processing apparatus AS in a stacking order. The housings 20 are accommodated in the recesses 110a respectively in the same position (in the example shown in FIG. 14, one side of the housing 20 faces the bottom of the concavity 110a). A groove 110b receiving a projection 27 formed on the side of each housing 20 is formed on the bottom of each recess 110a.

The housing 20 is covered with a protection cap 101 which protects the joint portion 35 of the housing 20.

The protection cap 101 is made of, for example, resin and has a generally rectangular configuration that corresponds to the configuration of the housing 20. The protection cap 101 is hollow and has an opening into which the rear portion of the housing 20 can be elastically inserted by press fitting. The protection cap 101 is frictionally locked to the housing 20, thus surrounding the entire joint portion 35. A pair of locking ribs 103 projects from the rear end of the protection cap 101. The locking ribs serve to hold the protection cap 101 in the housing holder 110 when the housing 20 is pulled out from the housing holder 110, with the air chuck 155d of the processing apparatus AS gripping the housing 20.

To perform the above-described operation, the recesses 110a are formed by providing a plurality of spaced locking plates 110c. An introduction groove 110d continuous with the concavity 110a is formed at the rear end of each locking plate 110c to lock the protection cap 101 to the rear end surface of the locking plate 110c. At opposite ends of the housing holder 110, a termination 110e of the introduction groove 110d is bored longitudinally to form a recess to thereby lock the locking rib 103 introduced to the recess.

In introducing a housing 20 mounted on the protection cap 101 into a corresponding recess 110a, as shown with the arrow \mathring{1} of FIG. 14, the housing 20 is located in confrontation with the corresponding concavity 110a and moved downwardly, with each locking rib 103 of the protection cap 101 facing the introduction groove 110d. Therefore, it is possible to accommodate the housing 20 and the protection cap 101. The housing 20 moves forwardly by pulling out the housing 20 from the recess 110a as shown with the arrow \mathring{2} of FIG. 14, with the air chuck 155d gripping the front portion of the housing 20. However, the protection cap 101 is locked to the housing holder 110. Thus, the protection cap 101 remains in the housing holder 110 and the housing 20 can be automatically removed from the protection cap 101.

With reference to FIG. 15, the slide table 111 serves to carrying the housing holder 110, with a rib 111b formed on the upper surface of the slide table 111 accurately placing the housing holder 110 in position. To removably lock the housing holder 110 to the slide table 111, a pair of locking recesses 110f is formed on the rear surface of the housing holder 110. Further on the rear surface of the housing holder 110, there is formed a pair of locking hooks 114 corresponding to each locking recess 110f. The locking hook 114 rotates between a locking position locked to the locking recess 110f to lock the housing holder 110 and an unlocking position retracted from the locking recess 110f to unlock the housing holder 110. Each of the locking hooks 114 is rotatably mounted on a stay 111a fixed to the slide table 111 by a shaft 114a. The locking hooks 114 are connected to a connection member 115. A spring 116 (shown in only FIG. 17) urges the locking hook 114 into a locking position. Normally, the locking hook 114 locks the housing holder 110 by the urging force of the spring 116.

With reference to FIG. 16, an unlocking cylinder 117 is disposed at the rear of one of the locking hooks 114. A rod 117a of the unlocking cylinder 117 is extended to rotate the locking hook 114 on shaft 114a to unlock the housing holder 110. The unlocking cylinder 117 is supported by a stay 117b.

The one-axis robot 112 reciprocates the housing holder 110 in the feeding direction D through the slide table 111 to feed the housings 20 to a housing removal position set on the air chuck 155d of the feeding unit 150 in the order of the housings 20 at the downstream side to the housing 20 at the upstream side.

With reference to FIGS. 17 and 18, to supply the housing 20 securely to the feeding unit 150, a pair of switches 120 and 121 proximate to each other is disposed immediately below the front side of the slide table 111 of the housing supply unit 100 in such a way that the switches 120 and 121 are arranged along the feeding direction D. The switches 120 and 121 detect the position of the housing holder 110 by detecting a dog switch 122 mounted on the slide table 111.

The switch 120 at the upstream side of the feeding direction D is disposed at a housing removal position set on the air chuck 155d of the feeding unit 150 to detect presence or non-presence of the housing holder 110 by detecting the dog switch 122 mounted on the slide table 111.

The switch 121 at the downstream side of the feeding direction D detects the original position of the slide table 111, based on the same principle.

In addition, a switch 123 making the connection member 115 of the locking hook 114 a dog is provided on the rear surface of the housing supply unit 100. The switch 123 detects whether or not the slide table 111 has moved to the most upstream position.

With reference to FIGS. 16 and 18, to detect whether the housing 20 is located upwardly from the housing holder 110, a light emitting element 125 is disposed at the upstream side in the feeding direction D of the housing supply unit 100, and a light receiving element 126 is disposed at the downstream side in the feeding direction D. If the housing 20 is located in an unallowable amount upward from the housing holder 110, a photoelectric switch composed of the light emitting element 125 and the light receiving element 126 detects that the housing 20 extends upwardly from the housing holder 110. Thereby processing for an error can be executed.

In the embodiment, the light receiving element 126 is disposed immediately below the pressing unit 200 which will be described below.

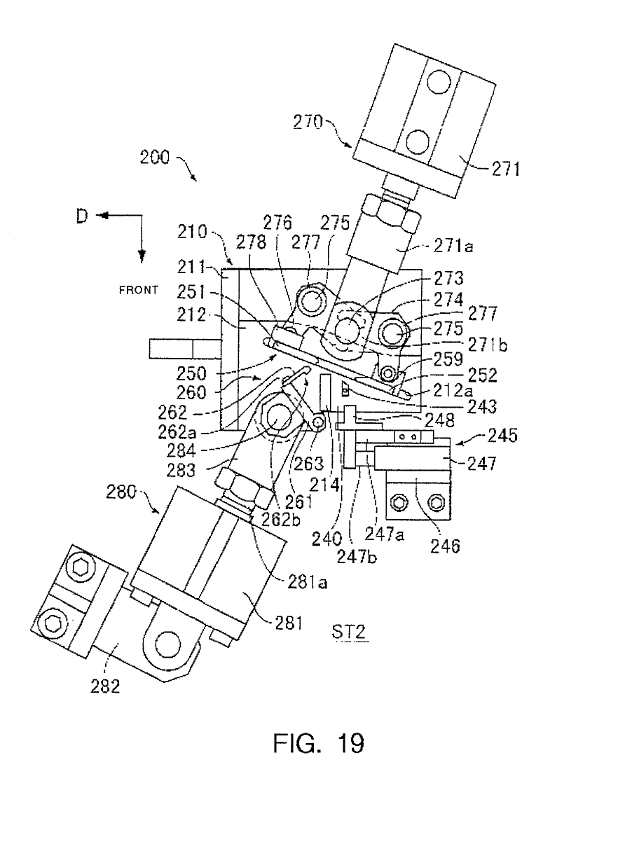

The pressing unit 200 will be described in detail below with reference to FIG. 19 and subsequent drawings.

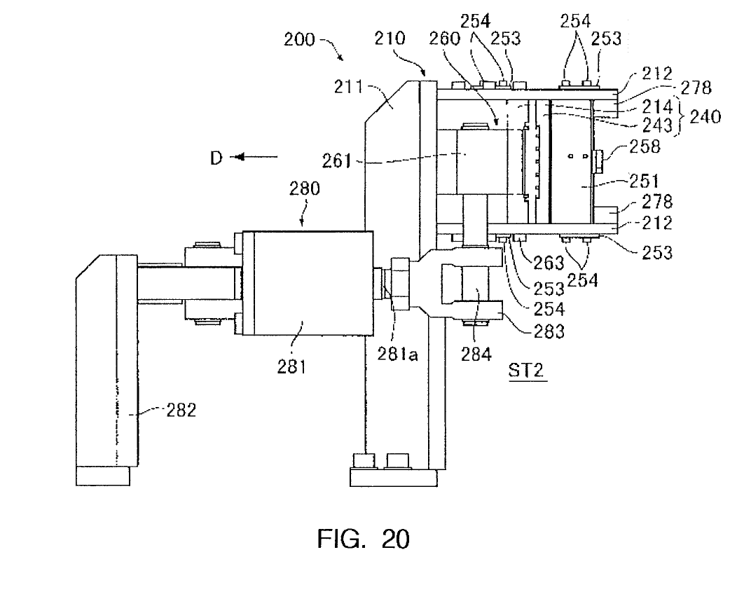

FIG. 19 is a schematic plan view showing the pressing unit 200 according to the embodiment shown in FIG. 10. FIG. 20 is a front view showing the pressing unit 200 according to the embodiment shown in FIG. 19.

The pressing unit 200 includes a structure 210, a housing holder 240 mounted on the structure 210, a first forming portion 250 held by the housing holder 240, a second forming portion 260 held thereby, a first forming operation portion 270 for driving the first forming portion 250, and a second forming operation portion 280 for driving the second forming portion 260.

The structure 210 has a stay 211 mounted erect at a fixed position of the press station ST2, a pair of forming guides 212 held by the stay 211 and confronting each other vertically, and a front plate 214 disposed between the forming guides 212 and forming the housing holder 240. The forming guides 212 are erect and fixed at predetermined positions of the stay 211 with suitable fasteners, such as bolts (not shown) and spaced at a predetermined interval. The first forming portion 250 which will be described later is disposed between both forming guides 212. A guide groove 212a for guiding the first forming portion 250 is also disposed between both forming guides 212. In the present embodiment, the pressing unit 200 is constructed such that the guide groove 212a is oblique to the feeding direction D and such that the approximate center of the guide groove 212a corresponds to a position (the pressing position in first forming process) where, in the same plane, the approximate center of the guide groove 212a intersects with the joint portion 35 projecting from the housing 20 held by the housing holder 240 which will be described later (see FIG. 19).

In cooperation with both forming guides 212 and a housing guide 243, the front plate 214 has a function of locking the housing 20 and constituting the housing holder 240 for placing the connector 10 in position.

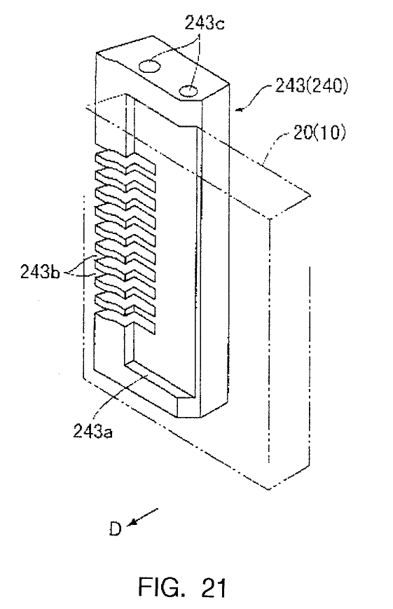

FIG. 21 is a perspective view showing the construction of the housing guide 243 of the pressing unit 200 according to the embodiment shown in FIG. 19.

With reference to FIG. 21, the housing guide 243 is made of a plate-shaped material, such as metal. The housing guide 243 has at a side thereof a surrounding portion 243a capable of surrounding both sides of the housing 20 in its transverse direction. The housing guide 243 receives the upper edge of the housing 20 at the downstream side in the insertion direction of the terminal of the housing 20 placed in position by the front plate 214, thus locking the housing 20 firmly. In the embodiment, at a predetermined position of the housing guide 243, a plurality of slits 243b which do not interfere with the joint portions 35 are formed in correspondence to the recesses 21 of the housing 20. To fix the housing guide 243 to the structure 210, screw holes 243c are formed on the upper and lower surfaces of the housing guide 243 and a bolt (not shown) is tightened into each screw hole 243c from both outer sides of the forming guide 212.

In the present embodiment, to lock the housing 20 introduced in the gap between the front plate 211 and the housing guide 243, a housing-locking unit 245 is provided. The housing-locking unit 245 has a stay 246, an air cylinder 247 provided above the stay 246 and extending along the feeding direction D, and a pressing member 248 which is reciprocated along the feeding direction D by a slide table 247a and a rod 247b of the air cylinder 247. The air cylinder 247 extends the rod 247b at predetermined intervals to reciprocate the pressing member 248 along the feeding direction D. Thereby the housing 20 can be locked to the housing holder 240. The pressed housing 20 can be removably released by reciprocating the pressing member 248 in a direction opposite to the feeding direction D.

The first forming portion 250 and the second forming portion 260 will be described below with reference to FIGS. 19 and 22 through 27.

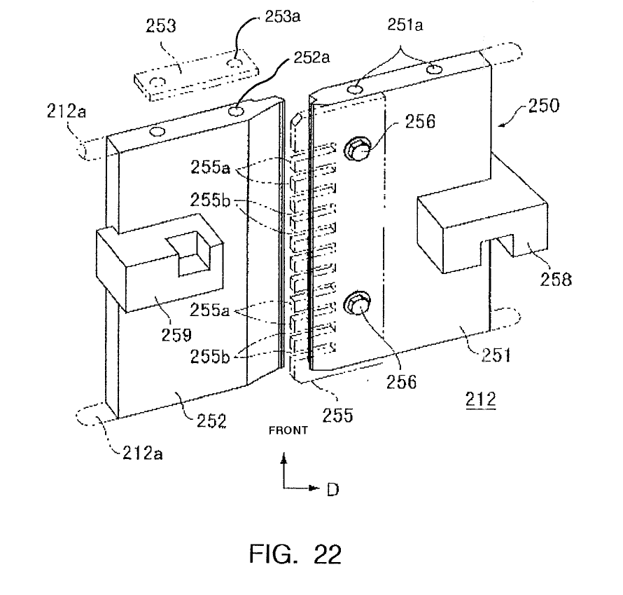

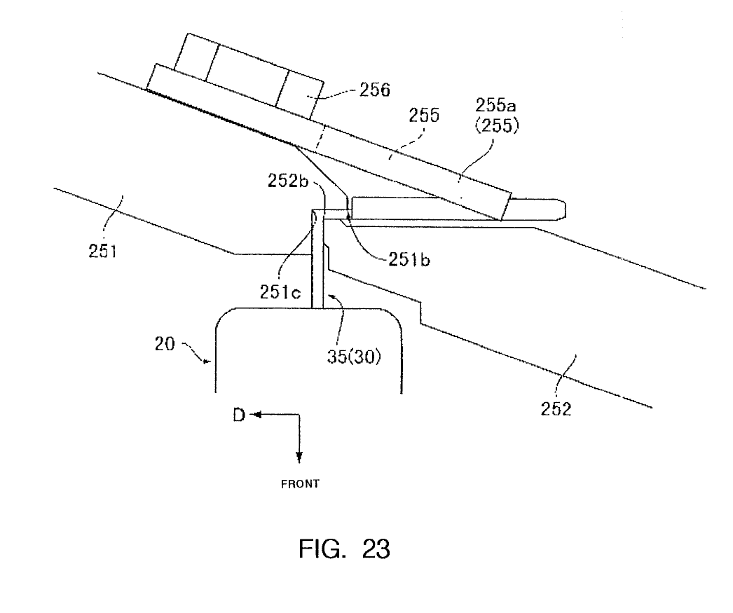

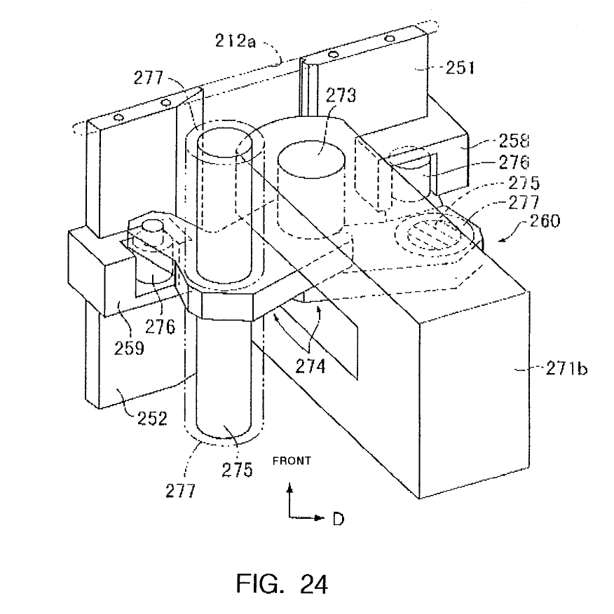

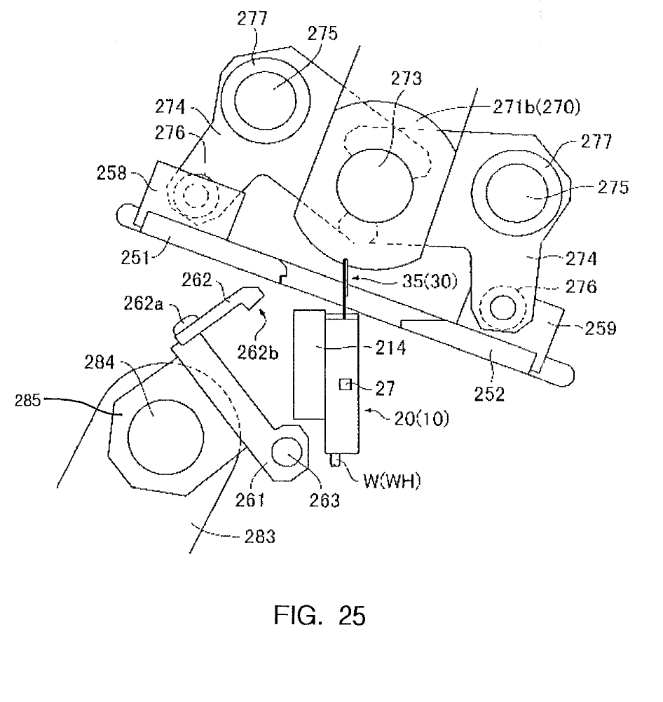

FIG. 22 is a perspective view showing the first forming portion 250 according to the embodiment shown in FIG. 10. FIG. 23 is an enlarged schematic view showing the forming stage of the first forming portion 250 according to the embodiment shown in FIG. 10. FIG. 24 is a perspective view showing a schematic construction of the first forming operation portion 270 according to the embodiment shown in FIG. 10. FIGS. 25 through 27 are enlarged schematic views showing the forming stage of the first forming portion 250 and the second forming portion 260 according to the embodiment shown in FIG. 10, respectively.

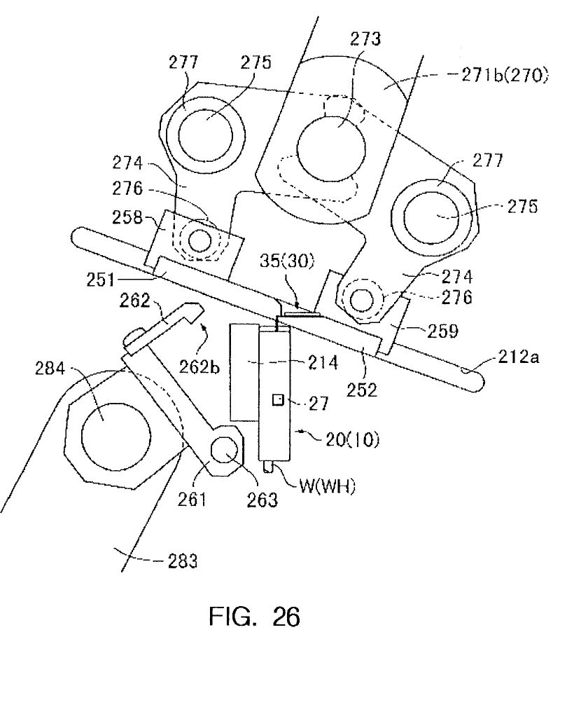

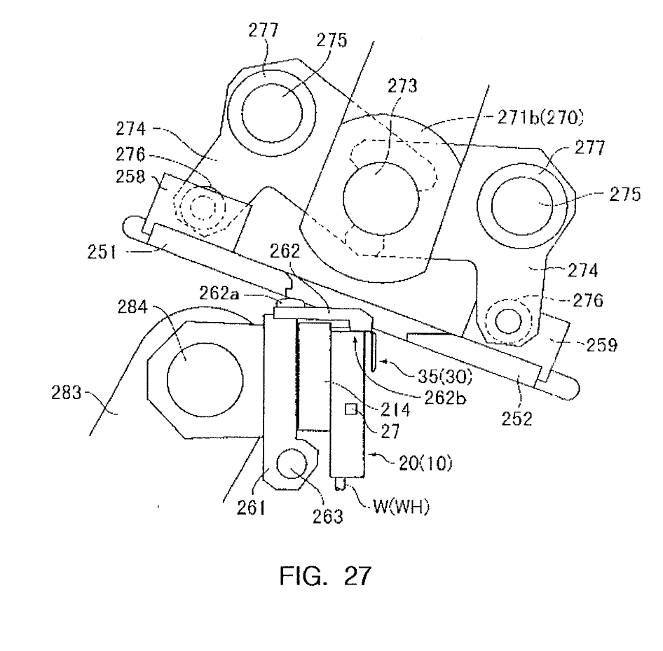

With reference to FIGS. 19 and 22, the first forming portion 250 and the second forming portion 260 are an example of a pressing portion for shaping the joint portions 35 formed on the terminals 30 of the housing 20 held by the housing holder 240. The first forming portion 250 shapes an intermediate portion of the joint portion 35 perpendicularly (see FIG. 26). The second forming portion 260 shapes the joint portion 35 at the base side thereof with respect to the portion formed by the first forming portion 250 (see FIG. 27).

As shown in FIG. 22, the first forming portion 250 has a pair of dies 251 and 252 which are guided by the forming guide 212. The plate-shaped dies 251 and 252 confront each other along the longitudinal direction of the guide groove 212a of the forming guide 212 and move along the longitudinal direction thereof. To install the dies 251 and 252 on the structure 210, a pair of end plates 253 corresponding to each die 251 and 252 (only one of which is shown in FIG. 22) is disposed on the outer wall of the forming guide 212 at opposite ends of each die. Bolts 254 are inserted through insertion holes 253a formed on the end plates 253 and through the guide groove 212a of the forming guide 212 and are tightened into screw holes 251a and 252a formed on opposite side walls of each of the dies 251 and 252. Thereby the dies 251 and 252 are removably connected and mounted for movement along the guide groove 212a and capable of pressing the joint portion 35 therebetween.

The die 251 is disposed at the downstream side of the feeding direction D. When the joint portion 35 is shaped, the die 251 moves along the guide groove 212a, thus pressuring the intermediate portion of the joint portion 35 in the direction from the downstream side of the feeding direction D to the upstream side thereof. A comb-shaped terminal guide 255 is placed on the upper surface of the die 251 and fixed to the die 251 with a pair of bolts 256. The terminal guide 255 has a comb tooth portion 255a projecting above the upper edge of the die 251. The comb tooth portion 255a partitions recesses 255b corresponding to the number of poles of the connector 10 from one another. The recesses 255b between the adjacent comb tooth portions 255a guides the joint portions 35 (see FIG. 16) of the terminals 30, thus preventing deformation of the joint portions 35 in the transverse direction thereof when the joint portions 35 are shaped. A cam holder 258 for connecting the first forming operation portion 270, which will be described later, and the die 251 to each other is fixed to the lower end of the die 251.

The other die 252 sandwiches the joint portion 35 between it and the die 151. A cam holder 259 for connecting the first forming operation portion 270 which will be described later and the die 251 to each other is fixed to the center of the outer portion of the die 252.

As shown in FIG. 23, the pressing portion of the die 251 is formed on one edge thereof and has a press-up edge portion 251b for pressing the joint portion 35 in a direction from the downstream side of the feeding direction D to the upstream side thereof and a stepped portion 251 c recessed perpendicularly to the press-up edge portion 251b. At an initial stage of pressing the joint portion 35, the press-up edge portion 251b presses the joint portion 35 upward.

The pressing portion of the die 252 has a pressing edge 252b which can bend the joint portion 35 perpendicularly between the pressing portion and the die 251. In cooperation with the stepped portion 251c, the pressing edge 252b can bend the joint portion 35 perpendicularly.

With reference to FIGS. 19 and 24, the first forming operation portion 270 for operating the first forming unit 250 has a suitable drive member, such as an air cylinder 271. The air cylinder 271 is mounted on an upper portion of a stay 272 disposed rearwardly from the stay 211. A rod 271a of the air cylinder 271 projects obliquely along a horizontal surface from the upstream side of the feeding direction D to the downstream side thereof. A bifurcated yoke 271b is fixed to the front end of the rod 271a. A vertically extending connection shaft 273 is mounted on the yoke 271b.

The connection shaft 273 is connected to a pair of linking arms 274 disposed in the yoke 271b. The linking arms 274 have generally L-shaped configuration in a plan view and are provided in correspondence to the dies 251 and 252 and are symmetrical with respect to the connection shaft 273.

The center of each linking arm 274 is rotatably supported by a shaft 275 parallel with the connection shaft 273. As described above, one end of the linking arm 274 is connected to the connection shaft 273, whereas the other end thereof is connected cam holders 258 and 259 of the dies 251 and 252 through a cam roller 276. Thereby the reciprocating motion of the rod 271a of the air cylinder 271 is converted into reciprocal movement of the dies in a direction in which the dies 251 and 252 are opened and closed.

A pair of rotary sleeves 277 sandwiching the linking arm 274 is provided vertically in such a way that the sleeves 277 are rotatable on each shaft 275. The cam roller 276 is guided by a sidewall 278 or a notch of the cam holder 258, 259 (see FIGS. 19 and 24) fixed to a respective die 251, 252. The reciprocating motion of the rod 271a is smoothly transmitted to the opening/closing operation of the dies 251 and 252 through the cam roller 276.

With reference to FIGS. 19, 20 and 25-27, the second forming portion 260 has a forming arm 261 mounted on the front plate and a die 262 held by the forming arm 261.

The forming arm 261 is configured to have a generally rectangular shape in a plan view. The forming arm 261 is made of a suitable material, such as metal. The forming arm 261 is supported by a shaft 263 parallel to the connection shaft 273 in such a way that one end thereof is rotatable on a vertical shaft. The shaft 263 is mounted to extend between the forming guides 212 supports the second forming portion 260 in such a way that the second forming portion 260 is pivotal between a retracted position shown in FIG. 25 and a forming position shown in FIG. 27.

One end of a die 262 made of a suitable material, such as metal, is fixed to a free end of the forming arm 261 with suitable fasteners, such as screws 262a. The die 262 has a punching portion 262b formed integrally therewith at the other end thereof for bending the joint portion 35 of the terminal 30. The punching portion 262b of the die 262 has a width corresponding to the width of the housing 20 (see FIG. 1).

With reference to FIGS. 19 and 20, the second forming operation portion 280 includes a suitable drive member, such as an air cylinder 281. The air cylinder 281 is disposed on the upper end of a stay 282 disposed at a front portion of the downstream side in the feeding direction D with respect to the stay 211. Similar to the air cylinder 271 of the first forming operation portion 270, a rod 281a is reciprocably held on a horizontal surface. The rod 281 a extends in such a way that the front end thereof inclines from the downstream side to the upstream side. A connection member 283 having a generally yoke-shape in a front view is fixed to the front end of the rod 281a. A vertically extending shaft 284 is rotatably connected to the connection member 283. A linking member 285 is fixed to the front end of the shaft 284 in such a way that the linking member 285 is rotatable on the shaft 284. The linking member 285 is fixed to a side wall of the forming arm 261. Thus, the reciprocating motion of the rod 281 a of the air cylinder 281 is smoothly transmitted to the forming arm 261 of the second forming portion 260, and through the forming arm 261, the die 262 can be rotated on the shaft 263 to bend the base portion of joint portion 35 against the rear wall of housing 10 to form the joint portion 35 into the generally U-shaped configuration, as shown in FIG. 27.

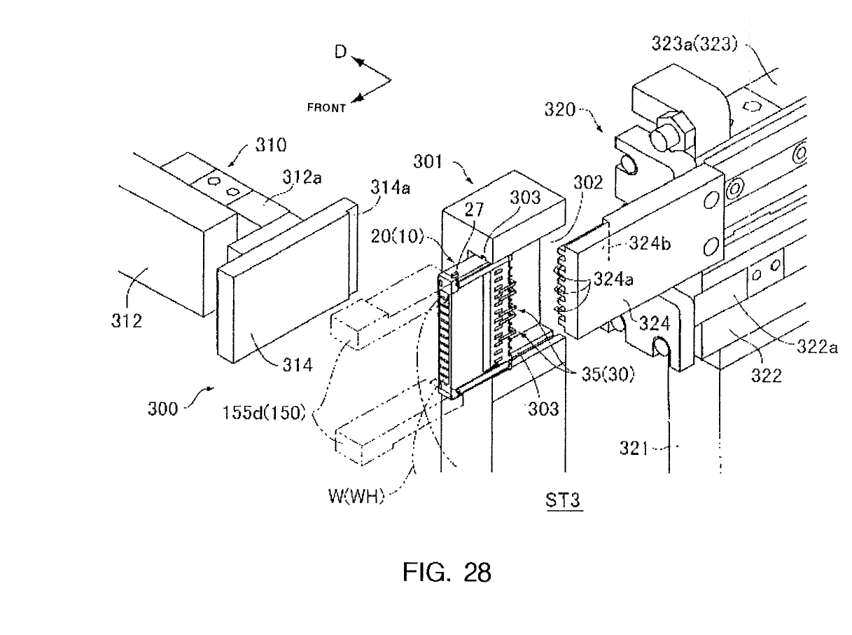

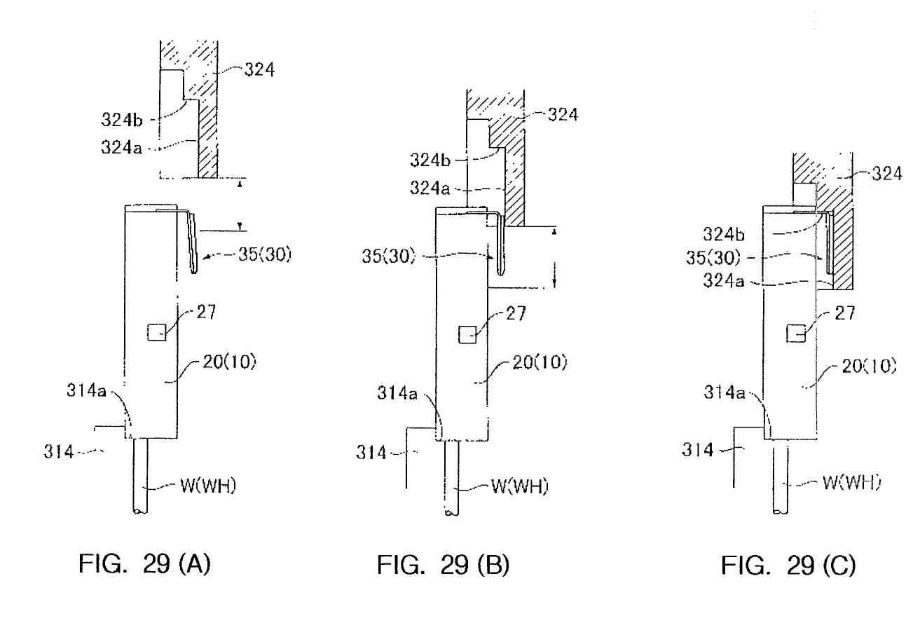

With reference to FIGS. 28 and 29, the correction/inspection station ST3 will be described below. FIG. 28 is a perspective view showing a schematic construction of the correction unit 300 installed on the correction/inspection station ST3 according to the embodiment shown in FIG. 10. FIGS. 29(A)-(C) are partly enlarged schematic plan views showing the operation of the correction unit 300 shown in FIG. 28.

With reference to FIGS. 10 and 28, the correction unit 300 has a housing holder 301 vertically holding the housing 20 of the connector 10 as shown in FIG. 28, a locking unit 310 capable of locking an end surface of the housing 20 held by the housing holder 301 in cooperation with the housing holder 301, and a die unit 320 correcting the configuration of the joint portion 35 of the housing 20 in cooperation with the locking unit 310.

The housing holder 301 is a pillar-shaped member mounted at a predetermined position of the correction/inspection station ST3 and has a recess 302 whose upper portion is generally U-shaped. A groove 303 corresponding to the projection 27 of the housing 20 is formed at upper and lower portions inside the recess 302. After the pressing process terminates, the air chuck 155d of the feeding unit 150 feeds the housing 20 and introduces it into the recess 302, with the projection 27 introduced into the groove 303 and with the housing 20 having the position shown in FIG. 28.

The locking unit 310 has a pillar 311 (see FIG. 10) and an air cylinder 312 fixed to an upper portion of the pillar 311. The air cylinder 312 has a slide table 312a and a pressure-receiving plate 314, receiving an edge of the housing 20, mounted on an end of an unshown rod. A stepped portion 314a is formed at an end of the pressure-receiving plate 314. The housing 20 can be locked to the recess 302 of the housing holder 301 by moving both edges of the housing 20 at the upstream and downstream sides in the housing insertion direction in the direction from the downstream side of the feeding direction D to the upstream side thereof.

The die unit 320 has a pillar 321 disposed rearward from the housing holder 301, a first air cylinder 322 mounted on the upper portion of the pillar 321, a second air cylinder 323 which is reciprocated forward and backward by a slide table 322a of the first air cylinder 322 and an unshown rod, a die 324 which is reciprocated forward and backward by a slide table 323a of the second air cylinder 323 and an unshown rod.

As shown in FIG. 29, the die 324 has a plurality of shaping grooves 324a for pressing the pressed joint portions 35 to form bent portions at the free end of the joint portions 35 and a shaping end wall 324b perpendicularly continuous with each shaping groove 324a to form an erect portion of the joint portion 35.

In an initial state, the first air cylinder 322 and the second air cylinder 323 are placed in a condition in which the slide tables 322a and 323a are located rearward. In this condition, the die 324 is positioned away from the joint portion 35 of the housing 20 locked by the housing holder 301 (see FIG. 29A).

When the first air cylinder 322 moves the second air cylinder 323 forward, the die 324 stops, with a small portion of a free end of a shaping groove 324a slightly in contact with the joint portion 35 (see FIG. 29B).

Thereafter the second air cylinder 323 reciprocates the die 324. As a result, the shaping grooves 324a and the shaping end walls 324b of the die 324 are capable of shaping the joint portions 35 of the locked housing 20 (see FIG. 29C).

With reference to FIG. 10, the correction/inspection station ST3 has the image pick-up/inspection unit 350. The image pick-up/inspection unit 350 includes an image pick-up camera 351 picking up the image of the connector 10 locked to the housing holder 301 and an unshown image evaluation system for determining whether the connector 10 is good, based on the image picked up by the image pick-up camera 351. The image pick-up camera 351 receives light rays emitted by an unshown light source through a mirror 352 and picks up the image of the connector 10. The data of the image picked up by the image pick-up camera 351 is converted into a binary image. Whether the connector 10 is good is determined by comparing the converted binary image with reference data. Because a known image pick-up/inspection unit can be used as the image pick-up/inspection unit 350, the detailed description thereof is omitted herein.

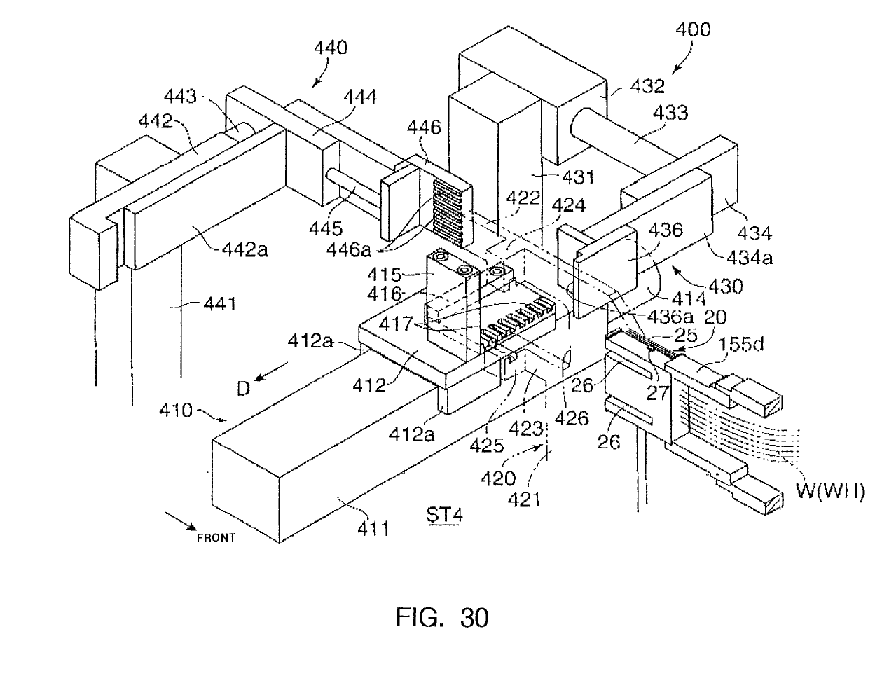

The stacking unit 400 mounted on the stacking station ST4 will be described below with reference to FIG. 30 and subsequent drawings.

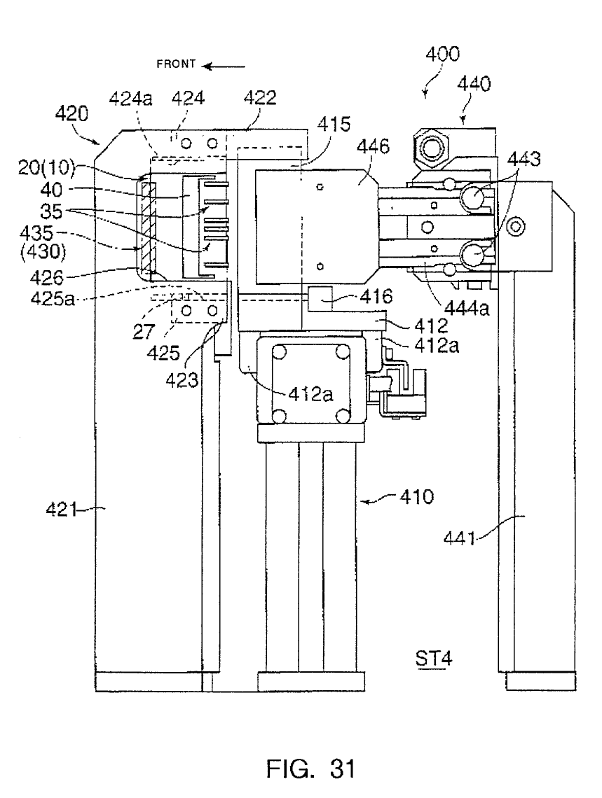

FIG. 30 is a perspective view showing a schematic construction of an automatic housing-stacking apparatus 400 according to another embodiment of the present invention. FIG. 31 is a side view showing the automatic housing-stacking apparatus 400 of the embodiment shown in FIG. 30.

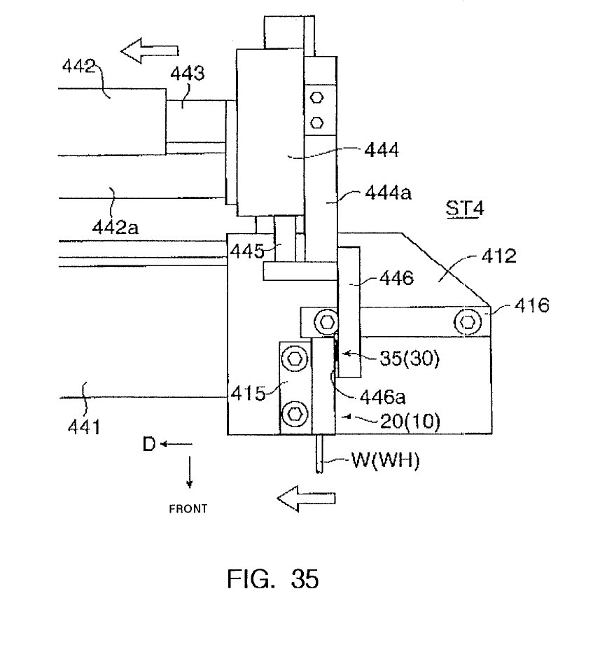

With reference to the drawings, the automatic housing-stacking apparatus 400 of the present embodiment is installed in a housing stacking station ST4 of an automatic assembling line for manufacturing a wire harness WH. The automatic housing-stacking apparatus 400 has a housing-holding unit 410 for holding the housing 20 fed automatically by an air chuck 155d provided on an unshown feeding unit, a transfer guide 420 disposed forwardly of the housing-holding unit 410 and receiving and transferring the housing 20 fed thereto from the air chuck 155d to the housing-holding unit 410, a pressing unit 430 for pressing the housing 20 delivered to the transfer guide 420 into the housing-holding unit 410, and a correction unit 440 (see FIG. 35) for correcting the configuration of the joint portion 35 of the housing 20 pressed by the pressing unit 430. In the description which will be made below, a direction in which the feeding unit feeds the housing 20 in a process order set for each unshown station is hereinafter referred to as D. A direction in which each unit confronts the feeding unit is “forward” in the horizontal direction perpendicular to the feeding direction D.

The housing-holding unit 410 has a ball thread mechanism 411 extending along the feeding direction D, a slide table 412 reciprocably mounted on the ball thread mechanism 411, and a motor 414 installed at one end of the ball thread mechanism 411 to cause the slide table 412 to reciprocate. By driving the motor 414 in opposite directions, an unshown ball thread contained in the ball thread mechanism 411 is driven to reciprocably move the slide table 412 in the longitudinal direction of the ball thread mechanism 411.

The plate-shaped slide table 412 having guide portions 412a fixed on opposite sides thereof is mounted on the ball thread mechanism 411 and connected to the unshown ball thread. Thus, the slide table 412 is driven by the motor 414 and can reciprocate for each stacking interval of the housing 20.

With reference to FIG. 30, a positioning plate 415 receiving the bottom surface (surface on which slide groove 26 is formed) of the lowermost housing 20 and a positioning rib 416 for positioning the front end surface of the housing 20 are fixed to the slide table 412 with suitable fasteners, such as screws, with the positioning plate 415 and the positioning rib 416 disposed perpendicularly to each other.

As shown in FIG. 30, the positioning plate 415 is configured to cover the entire bottom surface of the housing 20 longitudinally placed and has a housing-positioning-allowing height. The height of the positioning rib 416 is so set that it is open for the entire joint portion 35 projecting from the housing 20 (see FIG. 31).

In the example shown in the drawings, a plurality of grooves 417 which do not interfere with the housings 20 placed in position by the positioning plate 415 and the positioning rib 416 are formed in the slide table 412.

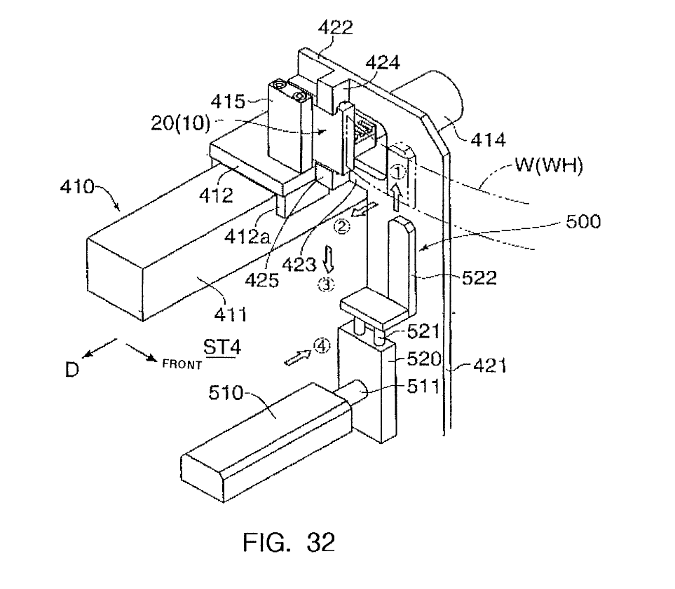

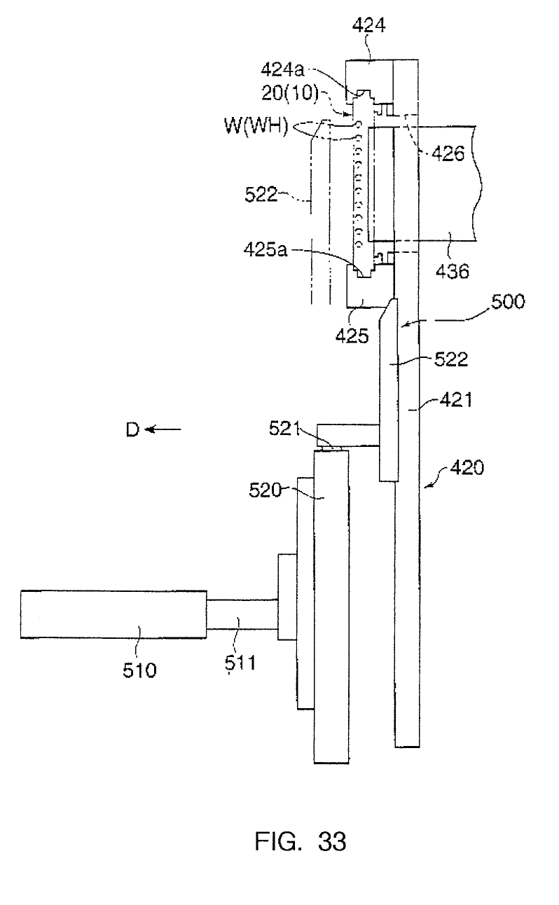

FIG. 32 is a schematic perspective view showing a schematic construction of component parts in the periphery of the transfer guide 420 according to the embodiment shown in FIG. 30. FIG. 33 is a schematic front view showing the automatic housing-stacking apparatus 400 of the embodiment shown in FIG. 30.

With reference to FIGS. 30 through 33, the transfer guide 420 has a plate-shaped erect member 421, a pair of arms 422, 423 extending from the erect member 421, guide ribs 424, 425 integral with one side of the arms 422, 423 respectively.

The erect member 421 is located at a predetermined position of the stacking station ST4. The arms 422, 423 are located at the front side of a housing stacking unit.

The arms 422 and 423 confront each other vertically. A recess 426 whose front side is open is formed between the arms 422 and 423. The upper-side arm 422 extends immediately over the slide table 412 of the housing-holding unit 410. The upper surface of the lower-side arm 423 is flush with the upper surface of the slide table 412.

The guide ribs 424 and 425 have guide grooves 424a and 425a on the lower surface and the upper surface thereof respectively in such a way that the guide ribs 424 and 425 are longitudinally guidably in correspondence to the configuration of the side wall of the housing 20. The housing 20 fed from the air chuck 155d can be received in the gap between the guide grooves 424a and 425a. The received housing 20 can be guided to the upper surface of the slide table 412.

With reference to FIG. 30, the pressing unit 430 has a pillar 431, a first air cylinder 432 supported by the pillar 431 and extending horizontally, a second air cylinder 434 mounted on a free end of a rod 433 of the first air cylinder 432, a pressing plate 436 mounted on a slide guide table 434a of the second air cylinder 434 and a free end of the rod 435.

As will be described later, the first air cylinder 432 drives the pressing plate 436 forward and backward through the second air cylinder 434 to feed the housing 20 to the guide rib 424 of the transfer guide 420 and the slide table 412 of the housing-holding unit 410. The pressing force of the first air cylinder 432 is set higher than that of a second air cylinder 444 provided on the correction unit 440 which will be described later.

The second air cylinder 434 is removably locked to the edge of the housing 20 supplied to the transfer guide 420, by removably inserting the pressing plate 436 into the recess 426.

The pressing plate 436 is made, for example, of metal with an approximately rectangular configuration and has a stepped portion 436a receiving the edge of the housing 20 at its free end. The housing 20 can be pressed forward by locking the housing 20 to the stepped portion 436a (see FIGS. 31 and 33).

The correction unit 440 has a pillar 441, a first air cylinder 442 supported by the pillar 441 and extending horizontally, a second air cylinder 444 mounted on a slide guide table 442a of the first air cylinder 442 and a free end of a rod 443, a correction plate 446 mounted on a slide guide table 444a of the second air cylinder 444 and a free end of a rod 445.

As will be described later, the first air cylinder 442 corrects the configuration of the joint portions 35 of the housing 20 positioned on the slide table 412 by moving the correction plate 446 forward and backward in association with the housing-holding unit 410.

The second air cylinder 444 corrects the configuration of the joint portions 35 of the housing 20 positioned on the housing-holding unit 410, by moving the correction plate 446 forward and backward.

The correction plate 446 is made, for example, of metal to have an approximately rectangular configuration. The correction plate 446 has at its free end a plurality of grooves 446a into which the joint portions 35 of the housing 20 is introduced. The configurations of the joint portions 35 are corrected and can be reliably pressed forward by fitting the joint portions 35 into the grooves 446a and in cooperation of the positioning plate 415 of the slide table 412 and the positioning rib 416 thereof (see FIGS. 31 and 33).

With reference to FIGS. 32 and 33, in the embodiment, the stacking station ST4 is provided with a electric wire guide unit 500. The electric wire guide unit 500 has a first air cylinder 510 extending horizontally along the ball thread mechanism 411 of the housing-holding unit 410, a second air cylinder 520 provided on a free end of the rod 511 of the first air cylinder 510, and a electric wire guide member 522 provided on a rod 521 of the second air cylinder 520.

The first air cylinder 510 is disposed on the side where the guide ribs 424 and 425 of the transfer guide 420 are provided. The rod 511 is directed toward the transfer guide 420. The first air cylinder 510 drives an electric wire W extending from the housing 20 supplied to the transfer guide 420 in a direction away from the transfer guide 420, by moving the electric wire guide member 522 up and down through the second air cylinder 520.

The second air cylinder 520 drives the electric wire W before the pressing plate 436 of the pressing unit 430 is locked to the housing 20, by moving the transfer guide 420 between a retracted position shown with the solid line of FIG. 33 and a driving position shown with the imaginary line of FIG. 33. After the pressing plate 436 is locked to the housing 20, the second air cylinder 520 moves downward and allows the pressing operation of the pressing plate 436.

The operation of the embodiment shown in FIG. 10 and the subsequent drawings will be described below.

With reference to FIG. 10, the manufactured wire harness WH is placed on the base AS1 of the processing apparatus AS. The housing holder 110 is placed on the slide table 111 of the housing supply station ST1. The wire harness WH is placed on the base AS1 and locked to a hook AS2 erect on the base AS1.

In the initial condition, the slide table 111 of the housing supply unit 100 moves to the original position. Then the housing 20 to be supplied initially is disposed at the housing removal position (see FIG. 18).

As shown in FIG. 13, each hand unit 155 of the feeding unit 150 is located at the upstream side of the feeding direction D. Regarding the hand unit 155 disposed at the most upstream side, the air cylinder 155c moves the air chuck 155d downward.

When the processing apparatus AS is operated in this condition, the feeding unit 150 disposed at the most upstream side drives the air cylinders 155a and 155c to move the air chuck 155d to the housing removal position so that the air chuck 155d grips the housing disposed at the housing removal position. When the gripping operation of the air chuck 155d terminates, the rod-less cylinder 155a of the feeding unit 150 moves the vertical member 155b forward. Consequently, the housing gripped by the air chuck 155d is removed from the housing holder 110 with the housing 20 pulled out from the protection cap 101, as described previously with reference to FIG. 14.

With reference to FIG. 13, when the removal operation of the housing 20 terminates, the air cylinder 154a of the feeding unit 150 extends the rod 154b. As a result, all the hand units 155 move to the stations ST2-ST4 disposed at the downstream side. At stations ST2-ST4, the rod-less cylinder 155a moves rearwardly to move the air chuck 155d forward.

With reference to FIG. 25, at the press station ST2, the dies 251 and 252 of the first forming portion 250 and the die 262 of the second forming portion 260 are at the home position, respectively. In this condition, in the feeding unit 150, the housing 20 formed as shown in FIG. 5 is inserted into the housing holder 240 from the housing supply station ST1 and locked to the housing holder 240 by the housing-locking unit 245. Upon completion of the locking of the housing 20, the hand unit 155 of the feeding unit 150 transfers the housing 20 to the pressing unit 200 and is displaced in a condition in which the hand unit 155 can return to the upstream side. Upon completion of the displacement, the air cylinder 154a retracts the rod 154b and returns to the original position.

In the pressing unit 200, the air cylinder 271 extends the rod 271a. As a result, as shown in FIG. 26, the dies 251 and 252 of the first forming portion 250 sandwich a first bending position of the joint portion 35 under pressure to bend the joint portion 35 perpendicularly at the first bending position. Thus, the connector 10 is shaped as shown in FIG. 6.

Thereafter the rod 271a of the air cylinder 271 is stretched, and the first forming portion 250 and the first forming operation portion 270 return to the condition shown in FIGS. 19 and 25.

Thereafter the air cylinder 281 of the second forming operation portion 280 operates to extend the rod 281a. Thus, as shown in FIG. 27, the die 262 fixed to the free end of the forming arm 261 sandwiches the joint portions 35 under pressure between the die 262 and the end surface of the housing 20 to bend the joint portion 35 into a generally U-shaped configuration, as shown in FIG. 7.

Thereafter, the air cylinder 271 retracts the rod 271 a to return the second forming portion 260 to the condition of FIG. 19. The air chuck 155d of the feeding unit 150 then pulls out the housing 20 to remove the connector 10 in which the joint portion 35 has been bent.

Upon termination of this process, synchronously with the housing removal operation of the most upstream air chuck 155a, the air chuck 155a of the hand unit 155 positioned at the press station ST2 removes the processed housing 20.

Upon termination of the removal operation at the housing supply station ST1 and the press station ST2, the air cylinder 154a of the feeding unit 150 extends the rod 154b of the air cylinder 154a again to feed each hand unit 155 to the downstream side. The most upstream hand unit 155 supplies the housing 20 to the pressing unit 200 of the press station ST2. Synchronously with the supply operation, the other hand unit 155 which has moved to the correction/inspection station ST3 feed the pressed housing 20 to the housing holder 301 as shown in FIG. 28. In cooperation with the housing holder 301, the hand unit 155 transfers the housing 20 to the locking unit 310.

Upon termination of the transfer operation, synchronously with the operation of the hand unit 155 at the upstream side, the other hand unit 155 is placed in a condition in which it can return to the upstream side. After each hand unit 155 returns to the stations ST2 and ST3, the air cylinder 154a of the feeding unit 150 retracts the rod 154b again to return each hand unit 155 to the upstream side.

The joint portion 35 of the housing 20 locked to the correction/inspection station ST3 is corrected by the correction unit 320 in the procedure described with reference to FIGS. 29A-29C. After the correction process terminates, the image pick-up/inspection unit 350 inspects each portion of the connector 10. If it is determined that the connector 10 is good, each unit proceeds to a subsequent process. On the other hand, if it is determined that the connector 10 is defective, all units suspend operation, and the unshown image evaluation system connected to the image pick-up/inspection unit 350 provides information regarding the error.

If it is determined that the housing 20 is good after the correction process terminates, the most downstream hand unit 155 which has retreated to the correction/inspection station ST3 performs a removal operation synchronously with the operation of the upstream side hand unit 155 and supplies the housing 20 to the downstream stacking station ST4 in the above-described procedure.

In the present embodiment, three hand units 155 perform the housing removal operation/transfer operation synchronously to reduce time lag.

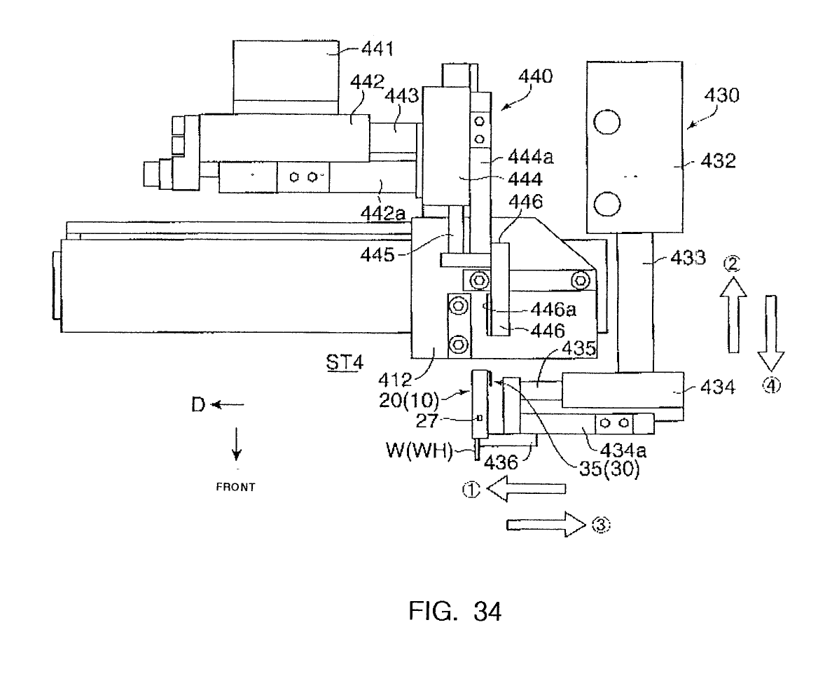

The operation of the embodiment shown in FIG. 30 will be described below with reference to FIGS. 30 through 36. FIGS. 34 through 36 are a partly enlarged schematic plan view showing the operation procedure of the stacking unit 400 of the embodiment shown in FIG. 30.

With reference to FIG. 30, at the stacking station ST4, the motor 414 of the housing-holding unit 410 drives the slide table 412. With the position of the housing 20 placed on the slide table 412 in confrontation with a guide position specified by the guide ribs 424 and 425 of the transfer guide 420, the supply of the housing 20 to the housing-holding unit 410 by the air chuck 155d of the feeding unit is idled.

In the idle condition (or initial state) of the stacking unit 400, the first air cylinder 432 of the pressing unit 430 is in an extended condition, and the second air cylinder 434 extends the rod 435 (see FIG. 34).

The correction plate 446 of the correction unit 440 projects rearwardly to allow correction of the configuration of the joint portion 35 of the housing 20 on the slide table 412.

With reference to FIG. 32, the first air cylinder 510 and the second air cylinder 520 of the electric wire guide unit 500 are in respective extended and retracted conditions.

In this condition, when the housing 20 is fed by the most downstream air chuck 155d of the feeding unit 150 and supplied to the space between guide ribs 424 and 425 of the transfer guide 420, as shown with the arrow \mathring{1} of FIG. 32, the rod 521 of the second air cylinder 520 of the electric wire guide unit 500 is extended to face the electric wire guide member 522 toward the upstream side of the feeding direction D of the electric wire W. Then, as shown with the arrow \mathring{2} of FIG. 32, the rod 511 of the first air cylinder 510 is retracted to drive the electric wire guide member 522 along the feeding direction D. Thus, the electric wire guide member 522 guides the electric wire W to the downstream side of the feeding direction D. Therefore, the pressing plate 436 of the pressing unit 430 can reliably lock the stepped portion 436a to the edge of the housing 20.

With reference to FIGS. 30, 33, and 34, when the electric wire W is guided to the downstream side of the feeding direction D, the second air cylinder 434 of the pressing unit 430 extends, as shown with the arrow \mathring{1} of FIG. 34, from the initial condition shown in FIG. 30 to introduce the pressing plate 436 into the recess 426 of the transfer guide 420 and lock the stepped portion 436a to the housing 20. In this condition, the first air cylinder 432 retracts the rod 433 to drive the pressing plate 436 forward. As a result, the pressing plate 436 presses the housing 20 held by the transfer guide 420 forward to feed the housing 20 to the placing position specified by the positioning plate 415 of the slide table 412 and by the positioning rib 416 thereof. Thus, the housing 20 is fed to the space between the positioning plate 415 and the correction plate 446 and then fed from the transfer guide 420 to the slide table 412.

As shown with the arrow \mathring{3} of FIG. 32, the second air cylinder 520 of the electric wire guide unit 500 retracts again to retract the electric wire guide member 522, and the retracted first air cylinder 510 is extended again, as shown with the arrow \mathring{4} of FIG. 32.

With reference to FIG. 35, the housing 20 fed to the slide table 412 is placed in position by the positioning plate 415 and the positioning rib 416, and the groove-shaped stepped portions 446a formed on the correction plate 446 correct the configuration of the joint portion 35. When the housing 20 is fed from the transfer guide 420 to the slide table 412, the pressing unit 430 returns to the idle condition. Simultaneously with the return operation of the pressing unit 430, the slide table 412 moves in the feeding direction D by a distance equal to the length of the housing 20 to align the housing-stacking position to the guide position of the transfer guide 420. Further, synchronously with the movement of the slide table 412, the first air cylinder 442 of the correction unit 440 is retracted to allow the correction plate 446 to follow the slide table 412.

When an upper housing 20 to be stacked on the housing placed in position is supplied to the slide table 412 by the air chuck 155d (see FIG. 30), the electric wire guide unit 500 and the pressing unit 430 operate in the above-described order. The pressing unit 430 serves as a fit-in mechanism that presses the upper housing 20 to be stacked on the lower housing 20 placed in position into the slide table 412.

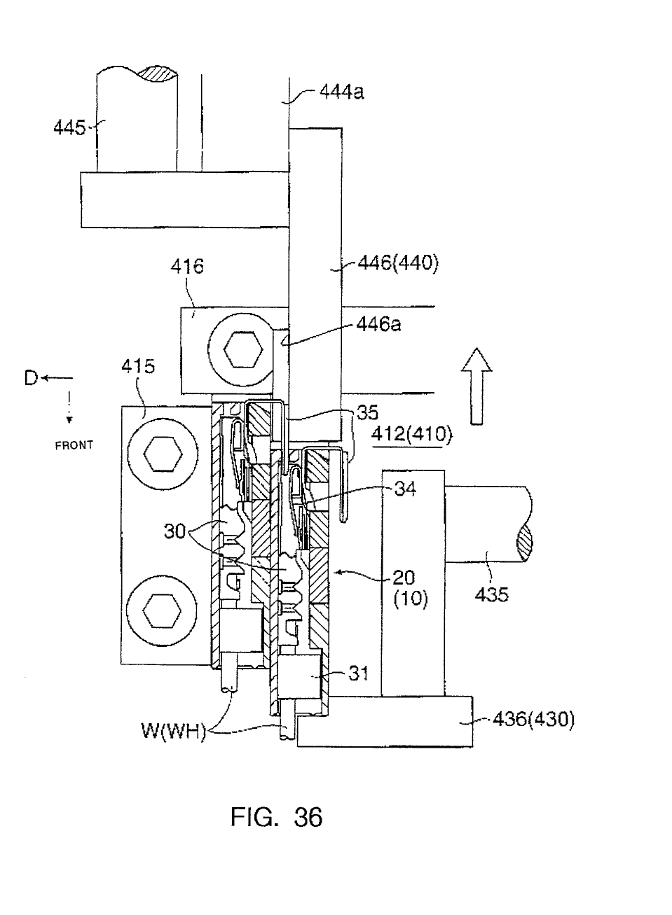

With reference to FIG. 36, when the pressing unit 430 starts the operation of pressing the upper housing 20 into the slide table 412, the guide rib 25 of the lower housing 20 placed in position is introduced into the slide groove 26 (see FIG. 1) formed on the upper housing 20, and the operation of fitting both housings 20 in each other begins.

In the present embodiment, the correction plate 446 of the correction unit 440 corrects the configuration of the joint portion 35 of the housing 20. Thus, by the fit-in operation, the upper housing 20 temporarily fits in the lower housing 20 placed in position, with the upper housing 20 and the correction plate 446 in contact with each other. As described above, the first air cylinder 432 of the pressing unit 430 has a higher pressing force than the second air cylinder 444 of the correction unit 440. Thus after the upper housing 20 contacts the correction plate 446, the upper housing 20 is fitted in the lower housing 20 placed in position, while the upper housing 20 presses the second air cylinder 444 rearward. In this manner, both housings 20 are fitted together at the normal fit-in position.

After all the housings 20 are stacked one upon another by repeating each of the above-described processes, the stacked-type connector 10 is manually removed from the slide table 412.

As described above, in constructing a part of the wire harness WH of the stacked-type connector 10, the joint portions 35 projecting from the housing 20 are pressed into a generally U-shaped configuration by the pressing unit 200, and the pressed housings can be successively stacked by the stacking unit 400. Therefore, it is possible to automatically produce a large-scale circuit very close to a complete circuit. Therefore, the present invention has an outstanding effect of embodying an electrical connection technique contributing to the formation of the complete circuit.

In the present embodiment, because the housing supply unit 100 stocks the housings 20 supplied to the pressing unit 200, it is easy to protect and supply the housings 20 while sequentially processing the housings 20.

The housing supply unit 100 stocks the housings 20 in such a way that the housings 20 can be supplied to the pressing unit 200 by removably holding the housing holder 110 accommodating the housing 20 of the wire harness WH in a housing-stacking order. Thus, it is possible to perform the preceding processes, with the housing holder 110 maintaining the housing-stacking order, and then to supply the housings 20 to the pressing unit 200 in the housing-stacking order. Accordingly it is possible to smoothly accomplish automatic processing and improve workability.

In the housing holder unit (housing holder 110 and protection cap 101) utilized in the present embodiment, the protection cap 101 can protect the joint portions 35 of the stacked-type connector 10 in the process of manufacturing the wire harness WH and the housing 20 can be smoothly supplied to the processing apparatus when the processing apparatus stacks the housings 20 one upon another.

In the present embodiment, the correction/inspection station ST3 is disposed between the pressing station ST2 on which the pressing unit 200 is installed and the stacking station ST4 on which the stacking unit 400 is installed, and the correction/inspection station ST3 is provided with the correction unit 300 for correcting the configuration of the joint portions 35 shaped by the pressing unit 200. In the embodiment, as described previously with reference to FIG. 29, the joint portions 35 shaped by the pressing unit 200 are shaped again into a predetermined configuration. That is, it is possible to accurately shape the joint portions 35 into the predetermined configuration and thus prevent disadvantages (for example, defective connection between the terminal 30 and the female connection portion when housings 20 are stacked one upon another) which may occur in subsequent stages.

As described above, in the stacking unit 400 of the embodiment, the lowermost housing 20 is supplied to the positioning unit 150 serving as the housing-holding portion and supported thereby. Then, the configuration of the joint portions 35 projecting the housing 20 held by the positioning unit 150 are corrected by displacing the correction unit 440 serving as the joint correction mechanism to the correction position shown in FIG. 34. Therefore, it is possible to effectively prevent a fit-in error because the joint portion 35 is not deformed or defectively shaped.

The upper housing 20 to be stacked on the lower housing 20 placed in position is supplied to the housing-holding unit 410 serving as the housing-holding portion. Then, with the upper housing 20 placed in position by the positioning plate 415 and the positioning rib 416 both serving as the positioning mechanism, both housings 20 are fitted together smoothly. Thus, the configuration-corrected joint portions 35 and the terminal 30 fit into each other smoothly. In the fit-in operation, the upper housing 20 to be stacked on the lower housing 20, which has had the configuration of its joint portions 35 corrected, presses the correction plate 446 serving as the correction member rearwardly. Therefore, in the entire process of fitting both housings together, it is possible to maintain the condition in which the joint portions 35 of the lower housing 20 can be securely connected to the female connection portion of the upper housing 20. Accordingly, even though the fit-in operation is performed automatically, it is possible to smoothly fit both housings 20 together.

In the present embodiment, the stacking unit 400 is provided with the electric wire guide unit 500 for guiding electric wires W of the housing 20 supplied to the stacking unit 400. Therefore, it is possible to prevent the electric wires W extending from the housing 20 from interfering with the housings-stacking operation when the stacking unit 400 stacks the housings 20 one upon another.

In the present embodiment, the protection cap 101 covering the joint portion 35 is mounted on the housing 20 before the joint portion 35 is shaped, and the protection cap-installed housings 20 are held by the housing holder 110 capable of holding them in a stacked order. The housings 20 are removed therefrom in the stacked order, and the protection cap 101 is removed from the housing 20 in the removal operation to supply the housing 20 to the pressing unit 200 of the processing apparatus AS. Therefore, in the process of manufacturing the wire harness WH, the housing 20 is covered with the protection cap 101 to protect the joint portions 35 of the terminals accommodated in the housing 20. Thus in the entire process of manufacturing the wire harness WH, it is possible to protect the joint portions 35 and prevent failures from occurring in the stages of the processing which is performed by the processing apparatus.

The protection cap 101 is removed from the housing 20 when the processing apparatus supplies the housing 20 to the pressing unit 200 and is left in the housing holder 110. Therefore the supply of the housing 20 to the processing apparatus AS can be accomplished smoothly, and the protection cap 101 which has been removed from the housing 20 can be handled easily.

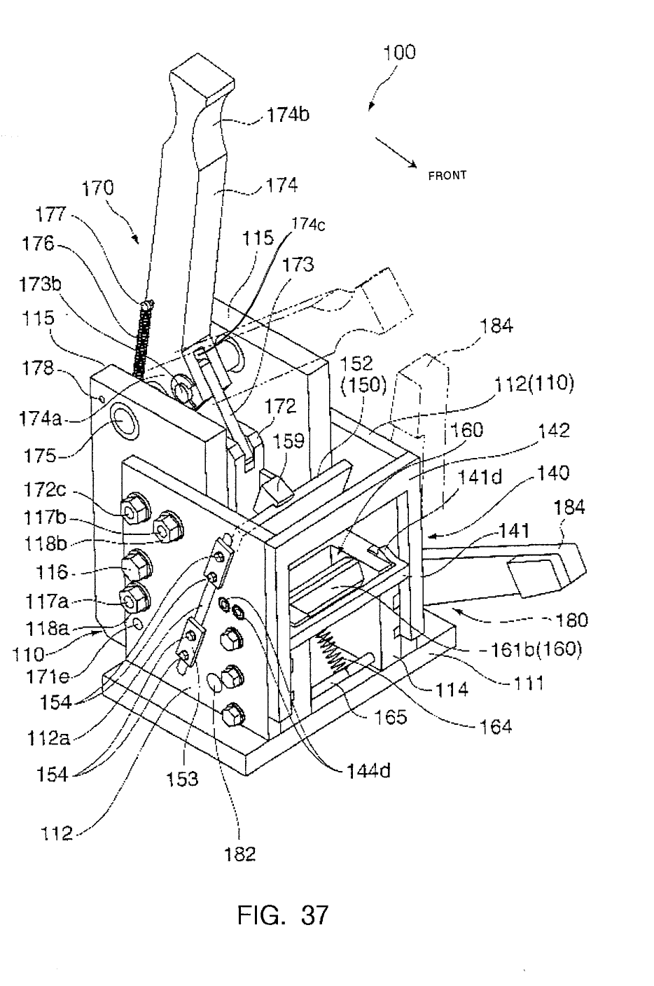

In the process of manufacturing the stacked-type connector 10, it is necessary to easily and precisely bend the joint portion 35 of the terminal 30 inserted into the housing 20. To do so, in the present embodiment, the pressing apparatus 100, shown in FIG. 37 and other figures, which is manually operated is adopted.

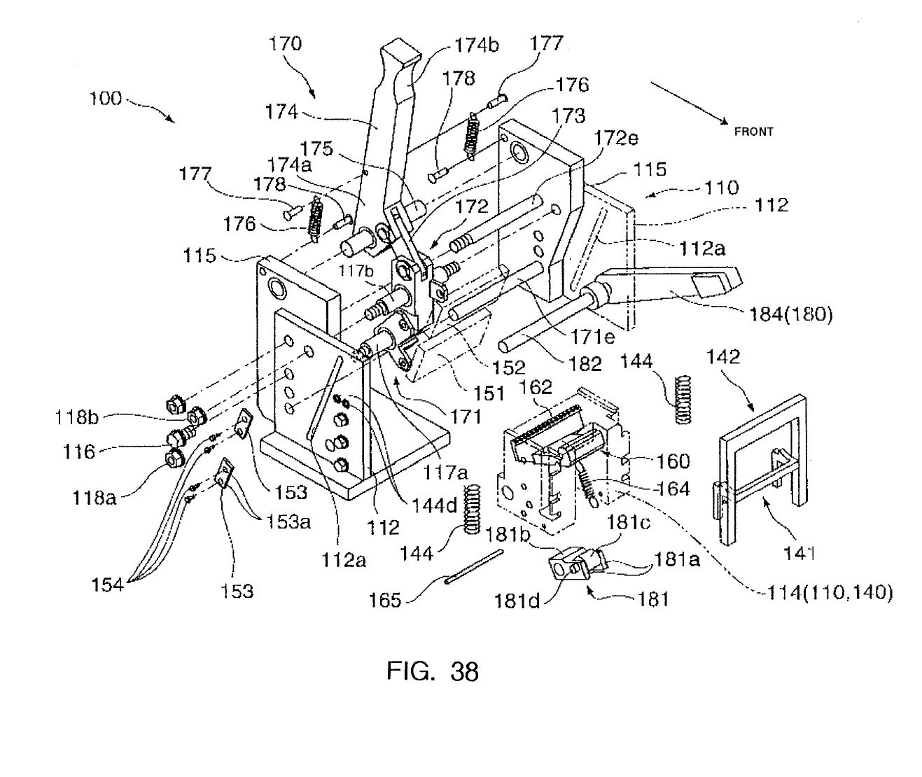

FIG. 37 is a perspective view showing a schematic construction of a joint portion pressing apparatus 100 according to an embodiment of the present invention. FIG. 38 is an exploded perspective view showing the joint portion pressing apparatus 100 shown in FIG. 37. In the description which will be made below, the side at which an operator is positioned is set as the forward direction.

With reference to FIGS. 37 and 38, the pressing apparatus 100 includes a frame member 110, a housing holder 140 formed as the frame member 110, a first forming unit 150 held by the housing holder 140, a second forming unit 160 held by the housing holder 140, a first forming unit operation portion 170 for driving the first forming unit 150, and second forming unit operation portion 180 for driving the second forming unit 160.

The frame member 110 includes a rectangular base 111, a pair of forming guides 112 (example of guide member) erected on the base 111, a front block 114 disposed between the forming guides 112, and a pair of side plates 115 fixed to the forming guides 112 at the rear sides thereof respectively. The forming guides 112 are erected at predetermined positions spaced at a predetermined interval and fixed to the base 111 with suitable fasteners, such as bolts (not shown). The first forming unit 150 which will be described later is disposed between the two forming guides 112. A guide groove 112a for guiding the first forming unit 150 is formed in each of the forming guides 112. In the example shown in FIGS. 37 and 38, the front end of the guide groove 112a inclines forwardly. The dimensions of the guide groove 112a are set in such a way that the approximate center thereof corresponds to the position where the side surface of the center of the guide groove 112a intersects the joint portion 35 projecting from the housing 20 held by the housing holder 40.

In cooperation with the two forming guides 112, the front block 114 has the function of locking the housing 20 thereto and positioning the connector 10. The front block 114 also has the function of supporting the second forming unit 160 and the second forming unit operation portion 180.

The side plates 115 are erected on the upper surface of the base 111 with suitable fasteners, such as bolts (not shown) and are fixed to the inner wall surface of the corresponding forming guide 112 with suitable fasteners, such as a pair of bolts 116. The side plates 115 and the forming guide 112 are tightened with a plurality of supporting shafts 117a and 117b and nuts 118a and 118b engaging screw threads formed on the end of the supporting shafts 117a and 117b respectively. Thereby the side plates 115 support the first forming unit operation portion 170 at a position rearward from the forming guide 112.

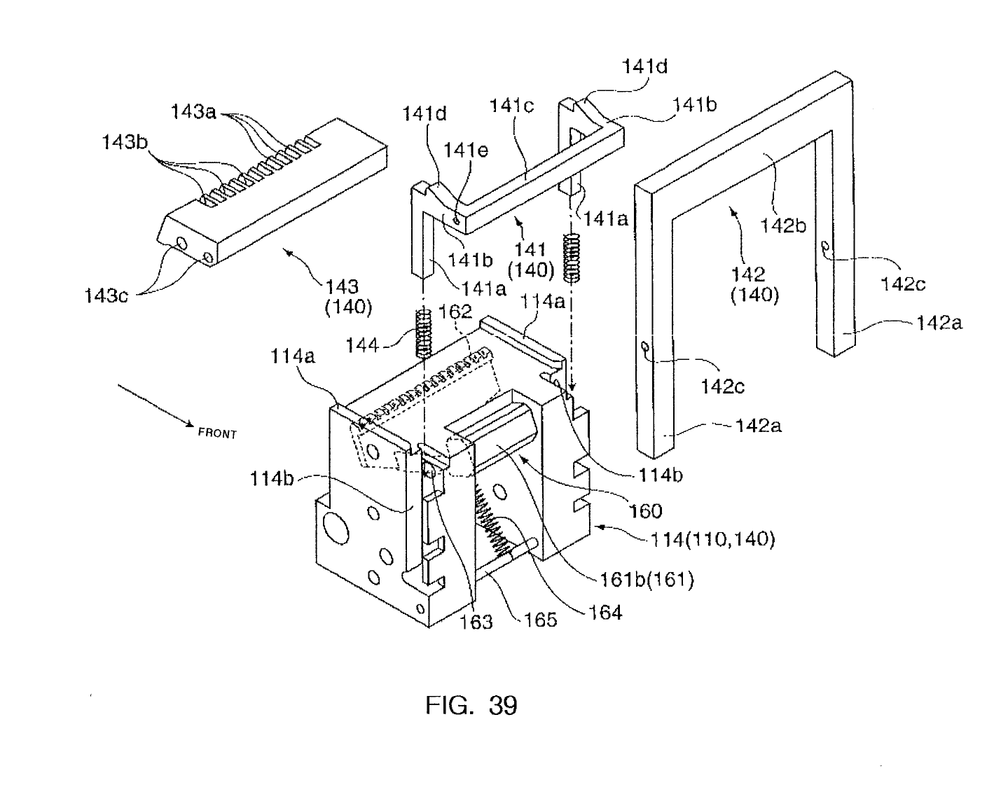

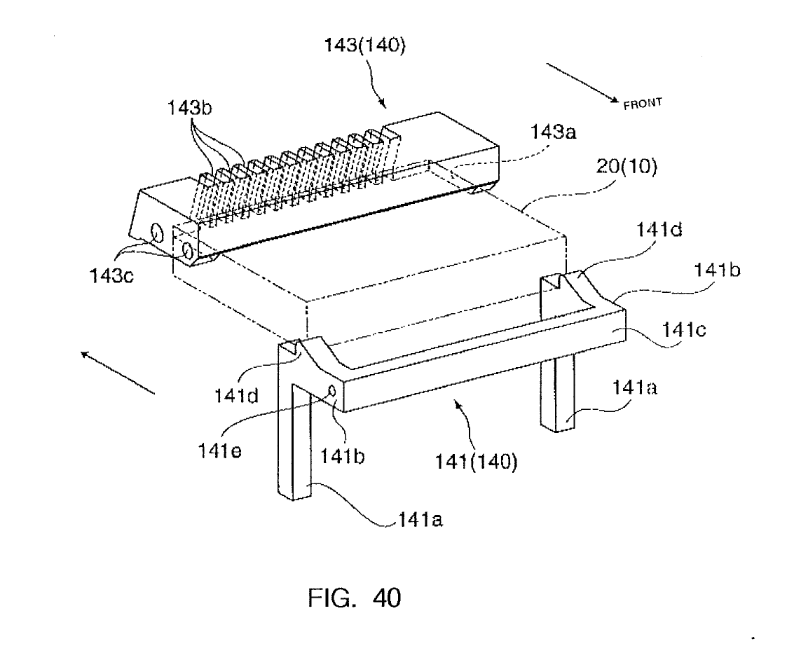

FIG. 39 is a perspective view showing a schematic construction of the housing holder 140 of the embodiment shown in FIG. 37. FIG. 40 is a perspective view showing the housing 20 held by the housing holder 140 of the embodiment shown in FIG. 37.

With reference to FIGS. 37 through 40, the housing holder 140 has a hook frame 141 mounted on the front block 114, an operation arm 142 connected to the hook frame 141, a housing guide 143 fixed to the forming guide 112 and capable of locking the housing 20 (see FIG. 1) of the connector 10 in cooperation with the hook frame 141.

With reference to FIG. 39, the front block 114 serving as a constituent element of the housing holder 140 is a gate-shaped block member whose central portion is open forwardly and rearwardly. The front block 114 receives the housing 20 (see FIG. 1) of the connector 10 at its upper wall. A pair of guide ribs 114a for guiding the housing 20 is formed on the upper wall at opposite sides of the front block 114. A pair of vertically extending bottomed guide grooves 114b is formed in the vicinity of the front end of both side walls of the front block 114. The guide grooves 114b vertically guide the hook frame 141 which will be described later. A coil spring 144 is disposed inside each guide groove 114b to urge the hook frame 141 upward.

The hook frame 141 receives and hooks the rear surface of the housing 20 placed on the upper wall of the front block 114. The hook frame 141 is made, for example, of metal and has a pair of legs 141a which are guided only vertically along the guide grooves 114b, a horizontal portion 141b extending from the upper end of both legs 141a, and a connection portion 141c connecting the front ends of the horizontal portions 141b to each other. A locking projection 141d for receiving the rear surface of the housing 20 inserted into the front portion of the housing holder 140 is formed on the upper surface of the horizontal portions 141b. The locking projection 141d inclines downward from its downstream side to its upstream side in the housing insertion direction, with its downstream end erect perpendicularly. Therefore, when the housing 20 is inserted into the housing holder 140, the locking projection 141d is pressed by the front end of the housing 20 and displaced downwardly. Thus, when the housing 20 is mounted at a predetermined position, the rear surface of the housing 20 is received by the locking projection 141d. Thus, the housing 20 is prevented from being removed from the housing holder 140.

The operation arm 142 presses the hook frame 141 downward to unlock the processed housing 20 so that the housing 20 can be removed from the housing holder 140. The operation arm 142 has a pair of legs 142a for sandwiching the connection portion 141c of the hook frame 141 therebetween and a handle portion 142b connecting the legs 142a to each other. A screw hole 141e (only one is shown in FIGS. 12 and 13) is formed on each side of the hook frame 141 to connect the hook frame 141 and the operation arm 142 to each other. An insertion hole 142c corresponding to the screw hole 141e is formed on each side of the operation arm 142. An unshown screw is inserted into the insertion hole 142c to fasten the screw into the screw hole 141e. Thereby it is possible to displace the combined hook frame 141 and operation arm 142 as a unit. In combining the hook frame 141 and the operation arm 142 with each other, an end surface of the operation arm 142 slides in contact with an end surface of the forming guides 112. Thus, the operation arm does not pivot on the screw but is displaced only vertically.

The housing guide 143 is plate-shaped and made, for example, of metal. The housing guide 143 has a surrounding portion 143a disposed on the bottom thereof and capable of surrounding opposite sides of the housing 20 in its widthwise direction. The housing guide 143 receives the upper edge (in the embodiment, end surface of both guide ribs 25 shown in FIG. 1) of the housing 20 at an end thereof downstream in its insertion direction when the housing 20 is placed on the upper wall of the front block 114, thus firmly locking the housing 20 in cooperation with the hook frame 141 (see FIG. 40). In the example shown in the drawings, at the rear end of the housing guide 143, to prevent the housing guide 143 from interfering with the joint portions 35 at the time of bending the joint portions, a plurality of slits 143b are formed in correspondence with the cavities 21 of the housing 20 to be processed. To fix the housing guide 143 to the frame member 110, in the example shown in the drawings, a screw hole 143c is formed at both sides of the housing guide 143 to screw a bolt 144d into the screw hole 143c from both outer side surface of the forming guide 112.

The first forming unit 150 and the second forming unit 160 will be described in detail below with reference to FIGS. 37, 38, and 41.

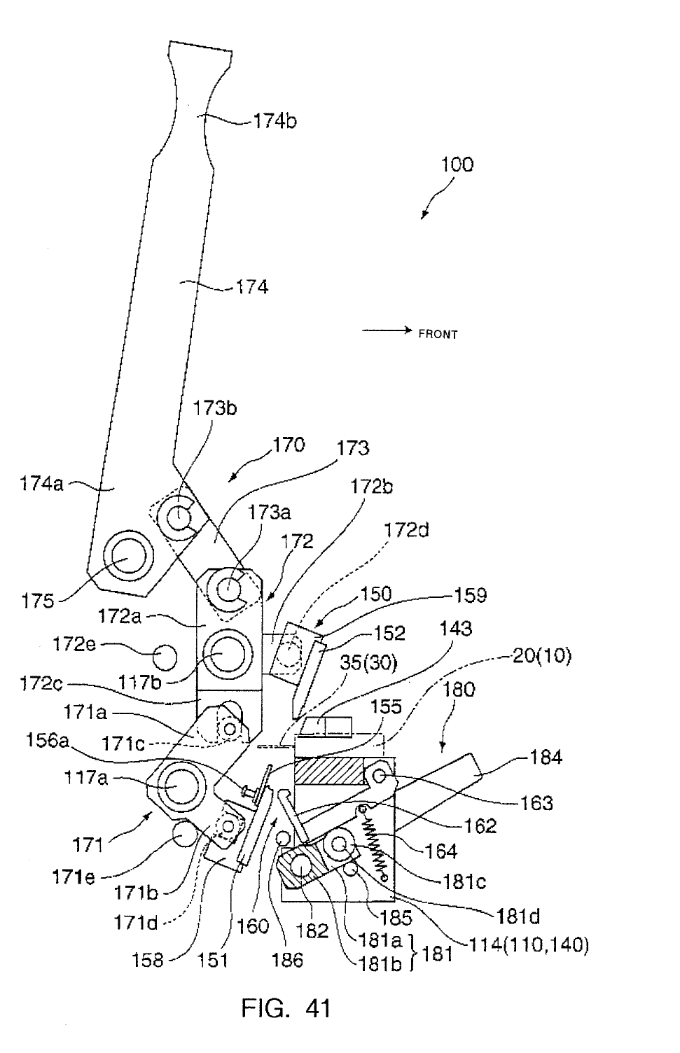

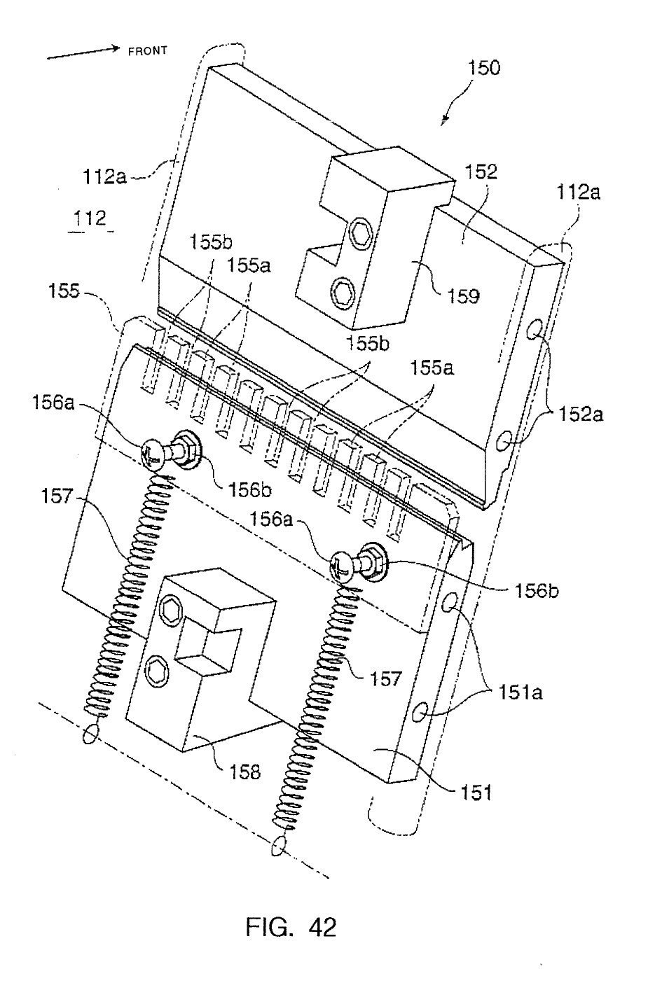

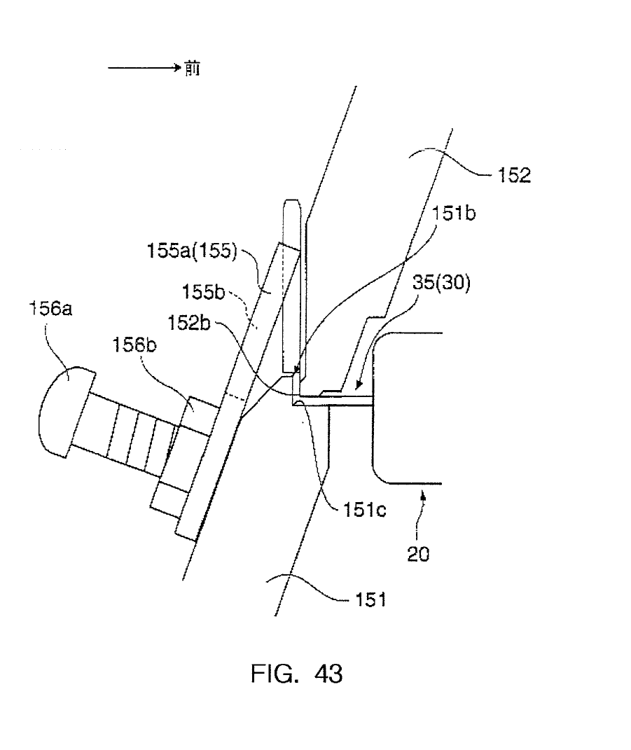

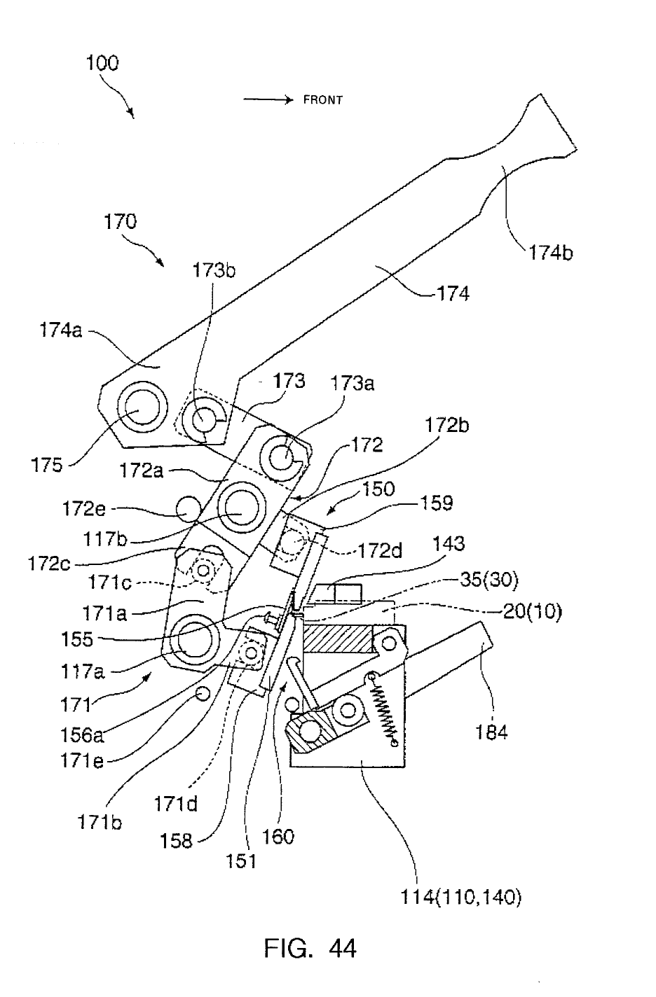

FIG. 41 is a side view showing a schematic construction of the joint portion pressing apparatus 100 according to the embodiment shown in FIG. 37. FIG. 42 is a perspective view showing a first forming unit 150 according to the embodiment shown in FIG. 37. FIG. 43 is a main portion-enlarged schematic view showing a forming process which is performed by the first forming unit 150 according to the embodiment shown in FIG. 37. FIG. 44 is a side schematic view showing the forming process which is performed by the first forming unit 150 according to the embodiment shown in FIG. 37.

With reference to FIGS. 37 and 41, the first forming unit 150 and the second forming unit 160 are an example of the press portion for shaping the joint portion 35 formed on the terminal 30 of the housing 20 held by the housing holder 140. The first forming unit 150 is so constructed that it bends (see FIG. 6) a portion of the joint portion 35 perpendicularly at the side of the rear side of the joint portion 35 with respect to a stepped portion 35a formed at an intermediate portion of the joint portion 35. The second forming unit 160 is so constructed that it bends (see FIG. 7) a portion of the joint portion 35 at the rear side thereof with respect to the portion thereof bent by the first forming unit 150.

As shown in FIGS. 37 and 38, the first forming unit 150 has a pair of dies 151 and 152 which are guided by the forming guide 112. The dies 151 and 152 are plate-shaped and confront each other and shift along the longitudinal direction of the guide groove 112a of the forming guide 112. To install the dies 151 and 152 on the frame member 110, a pair of plate-shaped end plates 153 corresponding to the dies 151 and 152 respectively is disposed on the outer side wall of each of the forming guides 112. Bolts 154 inserted through an insertion hole 153a formed in the end plates 153 and the guide groove 112a of the forming guide 112 are tightened into screw holes 151a and 152a (see FIG. 42) formed on both side walls of the dies 151 and 152 respectively. Thereby the dies 151 and 152 are removably connected to each other along the guide groove 112a and sandwich the joint portion 35 under pressure.

With reference to FIG. 42, the die 151 is disposed in the lower portion of the guide groove 112a. At the time of forming the joint portion 35, with the die 151 inclining forward along the guide groove 112a, the die 151 rises and pressures the intermediate portion of the joint portion 35 from the lower side thereof. A comb-shaped terminal guide 155 is placed on the upper surface of the die 151 and fixed to the die 151 with two pairs of bolts 156a and nuts 156b. The terminal guide 155 has a comb tooth portion 155a projecting above the upper edge of the die 151. The comb tooth portion 155a partitions recesses 155b, corresponding to the number of poles of the connector 10 to be processed, from one another. The recesses 155b between adjacent comb tooth portions 155a guide the joint portions 35 (see FIG. 43) of the terminal 30, thus preventing deformation of the joint portions 35 in the transverse direction thereof when the joint portions 35 are shaped. One end of a tension coil spring 157 is installed on each bolt 156a. The other end of each tension coil spring 157 is fixed to the inner wall of one of the forming guides 112 closest thereto with a suitable connector (for example, rod or bolt not shown). Thus, the die 151 is always urged downwardly. A cam holder 158 for connecting the first forming unit operation portion 170, which will be described later, and the die 151 to each other is fixed to the lower end of the die 151.

The other die 152 sandwiches the joint portions 35 between the lower edge thereof and the die 151 disposed below the die 152. A cam holder 159 for connecting the first forming unit operation portion 170, which will be described later, and the die 151 to each other is fixed to the center of the upper edge portion of the die 152.

As shown in FIG. 43, the pressing portion of the die 151 is formed on the upper end thereof and has a press-up edge portion 151b for pressing the joint portion 35 upwardly and a stepped portion 151c recessed perpendicularly to the press-up edge portion 151b. At an initial stage of pressing the joint portions 35, the press-up edge portion 151b presses the lower surface of the joint portions 35 upward.

The pressing portion of the die 152 has a pressing edge 152b which can bend the joint portion 35 perpendicularly between the pressurizing portion and the die 151. In cooperation with the stepped portion 151c, the pressing edge 152b can bend the joint portions 35 perpendicularly.

With reference to FIGS. 38 and 41, the first forming unit operation portion 170 for operating the first forming unit 150 has a first link arm 171 connected to the die 151, and a second link arm 172 connected to the die 152, and a handle 174 connected to the second link arm 172 through a connection piece 173.

With reference to FIG. 38, the first link arm 171 and the second link arm 172 are rotatably connected to first and second supporting shafts 117a and 117b respectively supported by the frame member 110.

With reference to FIG. 41, the first link arm 171 has a body 171a rotating on the first supporting shaft 117a and a branch portion 171b, integral with the body 171a, extending from the side of the body 171a.

The base side of the body 171a is rotatably supported by the first supporting shaft 117a, whereas the free end of the body 117a is connected to the second link arm 172 through a cam roller 171c.

The branch portion 171b is connected to the cam holder 158 of the die 151 through a cam roller 171d. Thus, when the first link arm 171 rotates counterclockwise on the first supporting shaft 117a in the condition shown in FIG. 41, a driving force is transmitted to the die 151 from the branch portion 171b through the cam roller 171d. Consequently the die 151 is driven upwardly against the pulling force of the tension coil springs 157 (see FIG. 42). In the initial condition shown in FIG. 41, the die 151 is moved downwardly by the urging force of the tension coil spring 157, and the first link arm 171 is disposed immediately below the first supporting shaft 117a and in contact with a stopper 171e fixed to the frame member 110.

The second link arm 172 has a body 172a whose center is supported by the second supporting shaft 117b and a branch portion 172b integrally projecting from the front end surface of the body 172a.

The body 172a has a cam holder 172c having one end connected to the cam roller 171c of the first link arm 171 and having the other end connected to a connection piece 173 through the pin 173a. The body 172a is connected to the handle 174 through the connection piece 173 and the pin 173b.

The branch portion 172b is connected to the cam holder 159 of the die 152 through a cam roller 172d. Thus when the second link arm 172 rotates clockwise on the first supporting shaft 117a in the condition shown in FIG. 41, a driving force is transmitted to the die 152 from the branch portion 172b through the cam roller 172c. Consequently the die 152 is driven downwardly. In the frame member 110, a stopper pin 172e for limiting the drive stroke of the die 152 is fixed to the rear side of the body 172a

The handle 174 is made of a suitable material, such as metal, and has a base portion 174a rotatably supported by a supporting shaft 175 supported by the side plates 115 of the frame member 110 and an operation portion 174b integral with the base portion 174a and extending from the base portion 174a. The base portion 174a of the handle 174 is formed by notching the material of the handle in the shape of a yoke in a front view (note FIG. 37). The other end of the connection piece 173 is inserted into a recess 174c of the base portion 174a to rotatably support the base portion 174a by a pin 173b.

As shown in FIGS. 37 and 38, a tension coil spring 176 is disposed at each side of the handle 174. One end of each of the tension coil springs 176 is mounted to an intermediate portion of the handle 174 by suitable fasteners, such as screws 177. The other end of each tension coil spring 176 is mounted to the inner wall of one of the side plates 115 closer to the tension coil spring 176 with suitable fasteners, such as screws 178. Thus, the tension coil springs 176 urge the handle 174 counterclockwise in FIG. 41 on the supporting shaft 175. The urging force of the tension coil springs 176 is transmitted to the second link arm 172 from the handle 174 through the connection piece 173, thus urging upwardly the die 152 connected to the second link arm 172.

With reference to FIGS. 38 and 45 through 47, the second forming unit 160 and the second forming operation portion 180 will be described below.

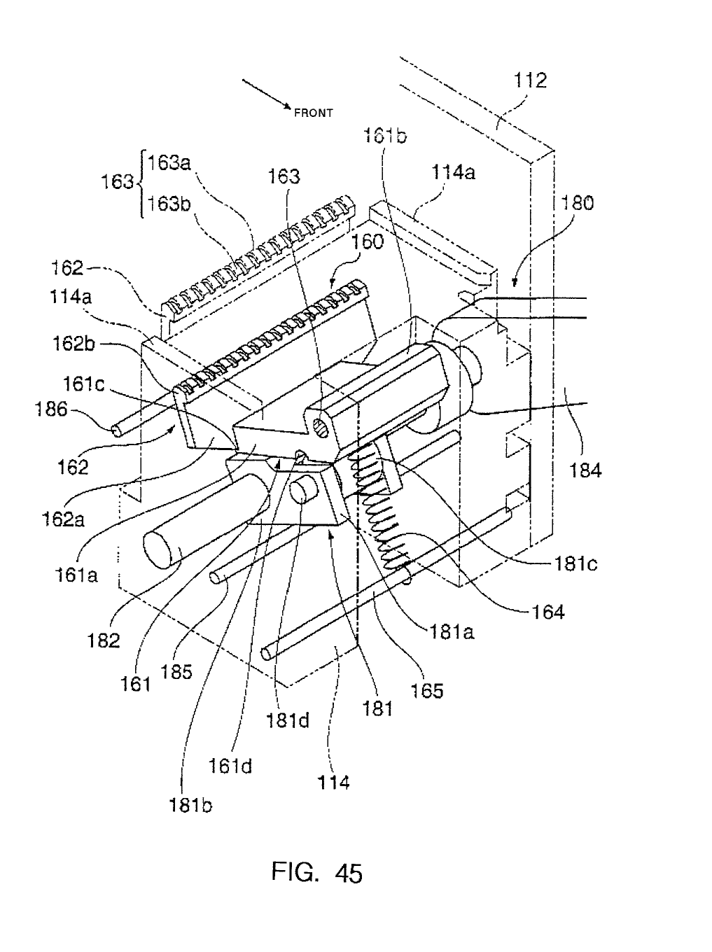

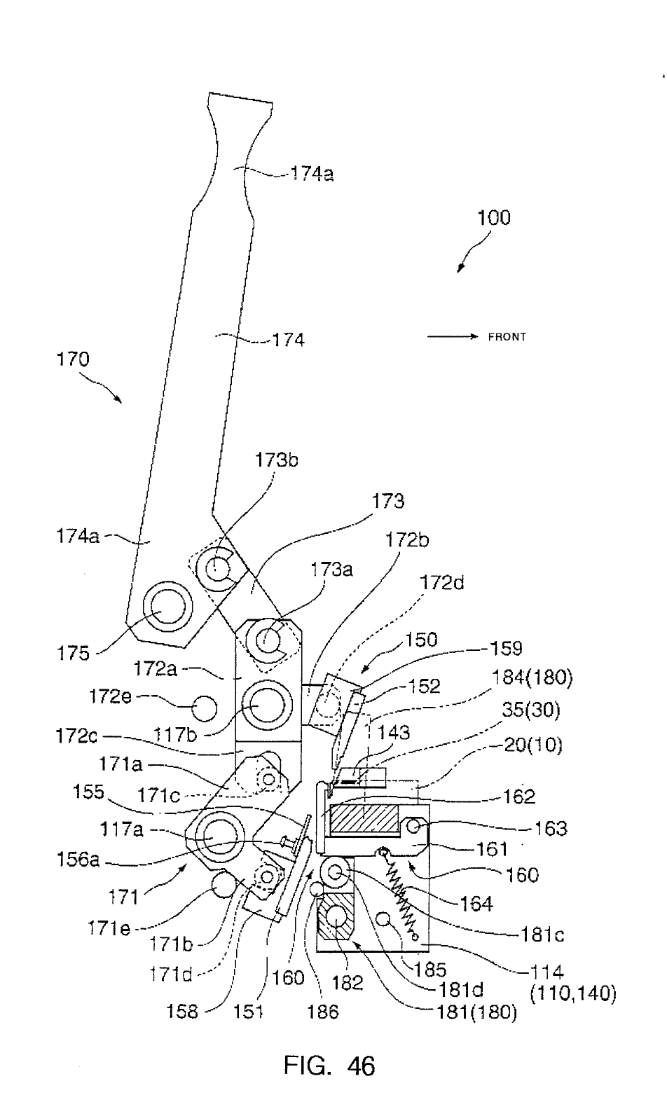

FIG. 45 is an enlarged perspective view showing a schematic construction of the second forming unit 160 and the second forming operation portion 180 according to the embodiment shown in FIG. 37. FIG. 46 is a side schematic view showing a forming process which is performed by the second forming unit 160 according to the embodiment shown in FIG. 37.

With reference to FIGS. 38 and 45 through 47, the second forming unit 160 has a forming arm 161 installed on the front block 114 of the frame member 110 and a die 162 held by the forming arm 161.

With reference to FIG. 45, the forming arm 161 is formed rectangularly in a plan view. The transverse dimension of the forming arm 161 is set so that the forming arm 161 is accommodated between the inner walls of the front block 114. The forming arm 161 is made of a suitable material, such as metal. The forming arm 161 has a plate-shaped body 161a, a mounting portion 161b projecting, in the shape of a rib, from the upper end of the body 161a, and a stepped portion 161c formed on the lower end thereof and receiving the die 162. The body 161a, the mounting portion 161b, and the stepped portion 161c are unitarily and in one-piece with one another.

The body 161a is a carrier for carrying the die 162, which will be described later, and is driven by the operation arm 181 of the second forming unit operation portion 180.

With reference to FIG. 45, a supporting shaft 163 penetrates through the mounting portion 161b. The forming arm 161 is rotatably supported by the supporting shaft 163 so that the forming arm 161 is rotatable thereon. Thus, the second forming unit 160 is capable of pivoting between a retracted position shown in solid lines in FIG. 45 and a forming position shown in imaginary lines in FIG. 45.

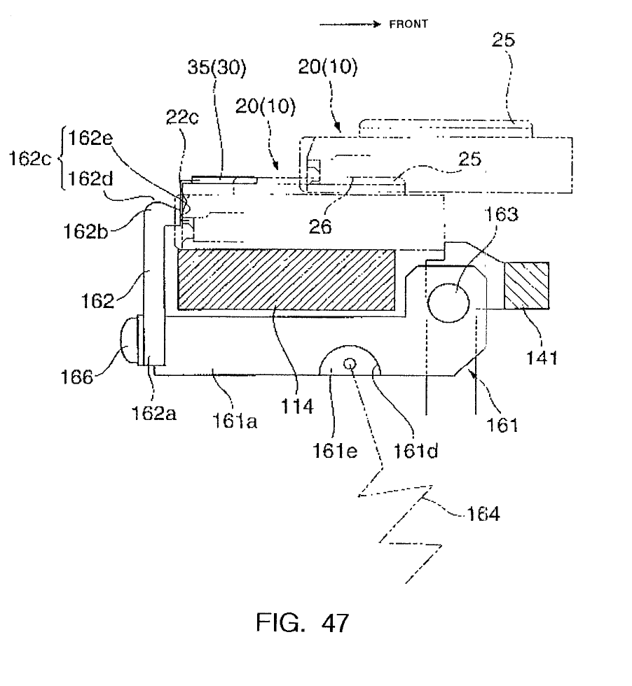

With reference to FIG. 47, to urge the second forming unit 160 to the retracted position shown by the solid lines of FIG. 45, a pair of confronting grooves 161d (only one is shown in FIGS. 45 and 47) is formed in the bottom surface of the body 161 at the outer sides thereof in a direction perpendicular to the housing insertion direction. One end of tension coil spring 164 is mounted on a hooking portion 161e formed between both grooves 161d. The hooking portion 161e has an opening receiving the one end of the tension coil spring 164. The other end of the tension coil spring 164 is mounted on an installing pin 165 fixed to the front block 114.

The upper surface of the stepped portion 161c is rectangular and stepped from the body 161a. The die 162 is seated on the stepped portion 161c and fixed thereto with suitable fasteners, such as a bolt 166 (shown only in FIG. 47) to integrate the forming arm 161 and the die 162 with each other.

The die 162 is made of a suitable material, such as metal, and has a plate-shaped seating portion 162a, which is seated on the mounting portion 161b, and a punching portion 162b, integral with the seating portion 162a, and formed on the upper end of the seating portion 162a.

The seating portion 162a has a width corresponding to the width of the housing 20 to be processed (see FIG. 1). The lower portion of the seating portion 162a is chamfered obliquely (note FIG. 45) so that the width of the lower portion thereof is equal to the width of the mounting portion 161b to prevent the seating portion 162a from interfering with the front block 114.

The punching portion 162b has a pressing projection 162c corresponding to the recesses 21 of the housing 20 to be processed (see FIG. 1). The pressing projection 162c has a press-up surface 162d for pressing the joint portions 35 of the housing 20 upwardly and a flat bending surface 162e (see FIG. 47) formed as a continuation of the press-up surface 162d. The bending surface 162e perpendicularly bends the joint portions 35, pushed upward by the press-up surface 162d, between the bending surface 162e and the end surface of the locked housing 20, when the bending surface 162e is at the forming position shown by the imaginary line of FIG. 47.

The second forming unit operation portion 180 has an operation arm 181, a supporting shaft 182 supporting the operation arm 181, and a handle 184 fixed to one end of the supporting shaft 182 and driving the operation arm 181 through the supporting shaft 182.

The operation arm 181 has a pair of plates 181a, a block portion 181b integral with the lower portion of the plates 181a, and a cam roller 181c which is disposed between both plates 181a and can be rotatably supported by a rod 181d. As shown in FIG. 45, the operation arm 181 is disposed immediately below the forming arm 161 in the front block 114 and is fixed firmly to the supporting shaft 182 penetrating through the front block 114 with a suitable fastener, such as a screw (not shown). To restrict the pivotal range of the operation arm 181 on the supporting shaft 182 to a predetermined range, a pin 185 for determining the retracted position and a pin 186 for determining the forming position are fixed to the front block 114.

The cam roller 181c of the operation arm 181 rolls on the lower surface of the body of the forming arm 161. This condition is always maintained by the urging force of the tension coil spring 164 urging the forming arm 161 downwardly against the cam roller 181c. The urging force urges the operation arm 181 to the position where the operation arm 181 contacts the pin 185 in a free condition.

The handle 184 is disposed on the outside of the frame member 110. The base 183a of the handle 184 is fixed to the end of the corresponding end of the supporting shaft 182. The free end of the handle 184 is approximately parallel to the operation arm 181. The operation arm 181 can be pivoted by pivoting the handle 184 from the position shown in the solid lines of FIG. 37 to the position shown in the imaginary lines of FIG. 37, by an operator gripping the handle 184. In the example shown in FIG. 46, the operation arm 181 has been pivoted to the position where the operation arm 181 is erect to displace the second forming unit 160 to the forming position. Thereby the operation arm 181 locks the second forming unit 160 in the shape of a wedge.

The operation of the embodiment will be described below.

With reference to FIGS. 37 and 41, in the pressing apparatus 100 according to the embodiment shown therein, due to the urging force of the coil springs 157, 164, and 174, the dies 151 and 152 of the forming units 150 and 160 and the die 162 are placed at the respective home positions (see FIG. 41). In correspondence to this condition, the handles 174 and 184 of the operation portions 170 and 180 are placed at the initial positions, as shown in FIGS. 10 and 14. In this condition, the connector 10 formed as shown in FIG. 5 is inserted into the housing holder 140, and the housing 20 is locked to place the connector 10 in position (see FIGS. 40 and 41).

Thereafter, the operator grips the handle 174 and pivots the handle 174 of the first forming unit operation portion 170 toward the operator. As a result, as shown in FIGS. 16 and 17, by the operation of the link mechanism (first link arm 171, second link arm 172, and connection piece 173), the dies 151 and 152 of the first forming unit 150 sandwich the first to-be-bent portion 35a (portion shown with the lead line 35a of FIG. 5) of the joint portion 35 therebetween under pressure, thus bending the joint portion 35 perpendicularly at the first to-be-bent portion. Thereby the connector 10 is processed into the condition shown in FIG. 6.

When the operator releases the handle 174, the urging force of the coil spring returns the first forming unit 150 and the first forming unit operation portion 170 to the condition shown in FIG. 41.

Thereafter, the operator pivots the handle 184 of the second forming unit operation portion 180 from the position shown in solid lines of FIG. 37 to the position shown by the imaginary lines, and the operation arm 181 pivots on the supporting shaft 182. As a result, as shown in FIG. 46, the forming arm 161 pivots counter-clockwise on the supporting shaft 163. Thereby, the press-up surface 162d of the punching portion 162c of the die 162 fixed to the free end of the forming arm 161 presses the joint portion 35 upward. Then the joint portion 35 is sandwiched between the bending surface 162e and the end surface of the housing 20 to bend the joint portion 35 in the shape of “U”, as shown in FIG. 7.

Thereafter the handle 184 is returned to its original state to restore the second forming unit 160 to the condition shown in FIG. 41, and the operation arm 142 is pressed to unlock the connector 10 from the housing holder 140. Then the connector 10 is pulled out from the housing holder 140. Thereby the connector 10 accommodating the joint portion-bent connector 10 can be removed from the housing holder 140.

As described above, in the embodiment, it is possible to easily and accurately shape the terminal 30 having the joint portions 35 projecting from each of the housings 20 stacked one upon another by bending the terminals 30. Thus it is easy to construct a wiring system of the terminals 30 and the stacked housings 20. Thereby, the present invention has an outstanding effect of embodying an electrical connection technique contributing to the formation of a complete circuit.

The above-described embodiment of the present invention is merely a preferred example of the present invention. The present invention is not limited to the above-described embodiment.

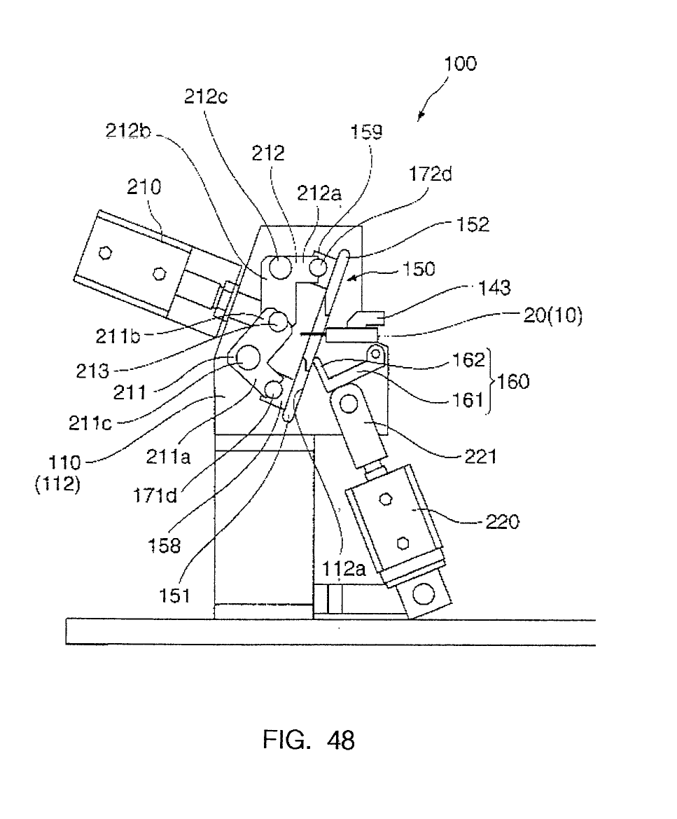

FIG. 48 is a schematic front view showing another embodiment of the present invention.

As shown in FIG. 48, the driving mechanism of the present invention is not limited to the first forming operation portion 170 and the second forming operation portion 180 of the handle type, but suitable fluid cylinders, such as air cylinders 210 and 220, may be utilized as the driving mechanism of the present invention.

In this construction, one end 21 la of an L-shaped link arm 211 and one end 212a of an L-shaped link arm 212 are mounted on the dies 151 and 152 of the first forming unit 150 respectively. The L-shaped link arms 211 and 212 are symmetrically disposed. The other end 211b of the link arm 211 and the other end 212b of the link arm 212 are connected to each other with a common shaft 213. An intermediate portion of each of the link arms 211 and 212 is pivotally supported by the frame member 110 by shafts 211c and 212c, respectively. The air cylinder 210 moves the shaft 213 in a predetermined direction to perform opening and closing operation of each of the dies 151 and 152.

In the second forming unit 160, the air cylinder 220 moves an operation arm 221 equivalent to the operation arm 181 of the second forming operation portion 180 upwardly and downwardly. The second forming unit 160 is driven by the upward and downward movement of the operation arm 221 by the air cylinder 220.

In the above-described embodiment, the frame member 110 carrying the first forming unit 150 and the second forming unit 160 has the forming guides 112 serving as the guide member for guiding a pair of dies 151 and 152 along the same line. Further the forming guides 112 includes the guide groove 112a intersecting obliquely with the joint portion 35 of the connector 10 positioned horizontally. Therefore, it is possible to allow intersection of the displacement direction of the dies 151 and 152 and that of the second forming unit 160. Thus, it is comparatively easy to compactly lay out the first forming unit 150 and the second forming unit 160.

The dies 151, 152, and 162 utilized in the first forming unit 150 and the second forming unit 160 are so constructed to press all the joint portions 35 projecting the connectors 10. Thus all the joint portions 35 can be processed in single sandwiching operation, and processing efficiency can be improved.

As described above, according to the present invention, it is possible to easily and accurately shape the terminals having the joint portions projecting from each of the housings stacked one upon another by bending the terminals. Thus it is easy to construct a wiring system of the terminals and the stacked housings. The present invention thus has an outstanding effect of embodying the electrical connection technique contributing to the formation of a complete circuit.

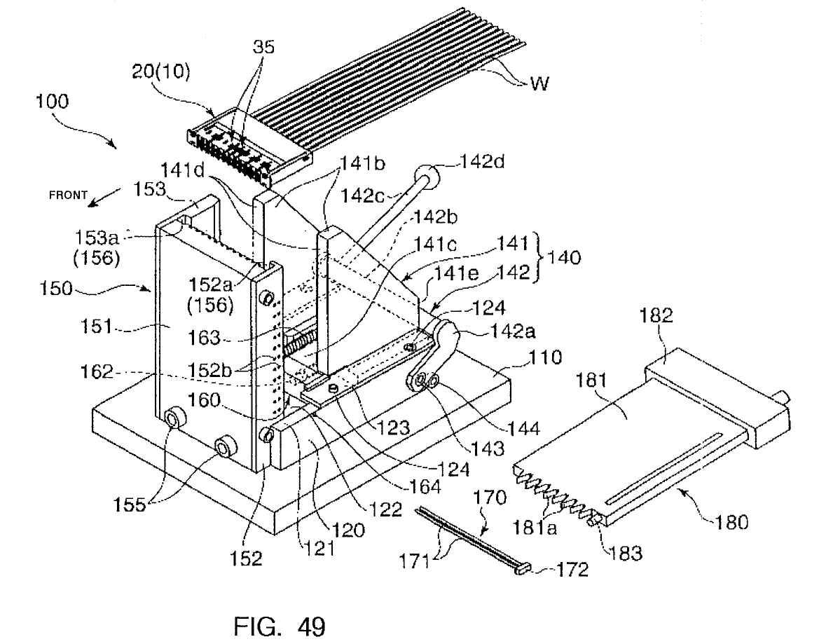

Additionally, in the process of manufacturing the stacked-type connectors 10, it is necessary to easily and precisely stack the housings after the joint portion 35 is bent. To do so, in the embodiment, a manually operated housing-stacking apparatus 100 shown in FIG. 49 and subsequent drawings is adopted.

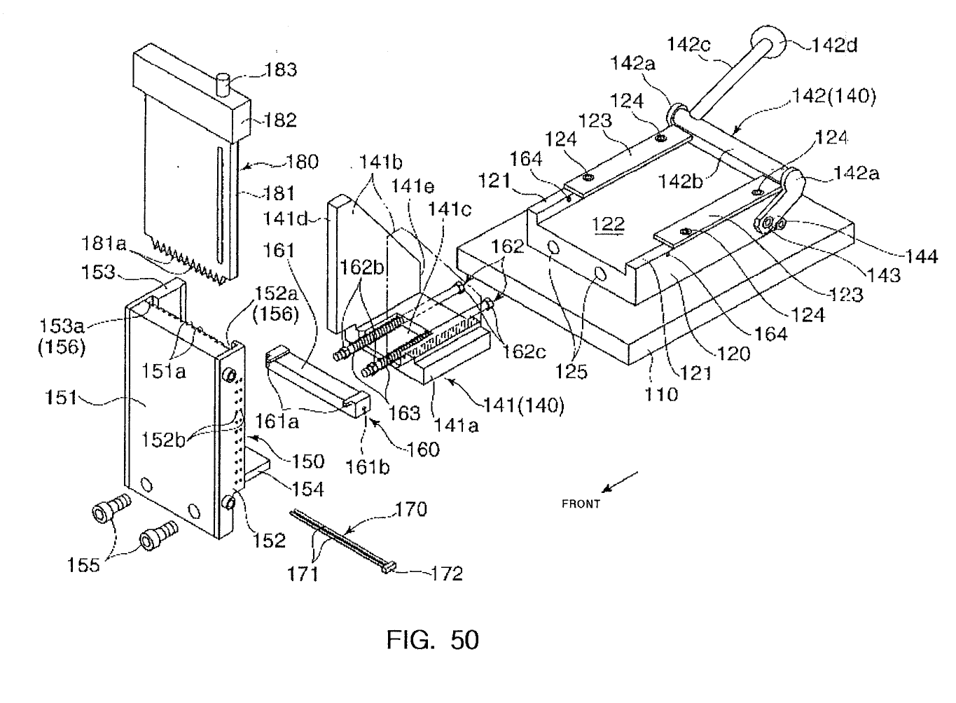

FIG. 49 is a perspective view showing a schematic construction of a housing-stacking apparatus 100 according to an embodiment of the present invention. FIG. 50 is an exploded perspective view showing the housing-stacking apparatus 100 according to the embodiment shown in FIG. 49.

With reference to FIGS. 49 and 50, the housing-stacking apparatus 100 includes a plate-shaped base 110, a guide base 120 placed on the base 110, a pressing unit 140 held reciprocatively on the guide base 120 and serving as a fit-in device, a positioning unit 150 fixed to an end of the guide base 120 and holding and positioning the housing 20 pressed by the pressing unit 140, a locking mechanism 160 locking the lowermost housing 20 to the positioning unit 150, a position regulation member 170 regulating the configuration of the joint portion 35 of the locked housing 20, and a correction member 180 serving as a correction device for correcting the configuration of the joint portion 35 whose position is regulated.

The guide base 120 is a plate-shaped member fixed to the upper surface of the base 110 by suitable fasteners, such as bolts (not shown). The guide base 120 has a pair of guide ribs 121 formed unitarily therewith at both sides thereof. A guide groove 122 guiding the pressing unit 140 is formed between an inner wall of the guide rib 121 and the upper surface thereof. Each of the guide ribs 121 serves to slidably guide the pressing unit 140 forward and backward. A plate 123 for preventing inadvertent removal of the pressing unit 140 is fixed to the upper surface of each guide rib 121 by suitable fasteners, such as bolts 124.

The pressing unit 140 has a slider 141 which slidably fits in the guide base 120 and an operation portion 142 for driving the slider 141. The slider 141 has a rectangular base 141 a and a pair of pressing plates 141b integral with the base 141 a and projecting from the upper surface of the base 141a.

The base 141a fits in the guide groove 122 for slidable movement only forward and backward. A recess 141c is formed on the upper surface of the front end of the base 141a. A part of the locking mechanism 160 which will be described later is mounted inside the recess 141c.

The pressing plate 141b is a metal plate having a pressing end surface 141d for pressing the housing 20 at the front portion thereof, as will be described later and a pressure-receiving surface 141 e which contacts the operation portion 142 at the rear portion thereof. In stacking the housings 20 one upon another, because an electric wire W connected to the terminal 30 extends from the housing 20, in the embodiment shown in FIGS. 49 and 50, the housings are stacked one upon another, with the electric wire W disposed between the pressing plates 141b and 141b.

The operation portion 142 has a pair of arms 142a each pivotally mounted on the guide base 120 at its rear end by a supporting shaft 143, a driving rod 142b connecting free ends of both arms 142a and 142a to each other and pressing the pressure-receiving surface 141e of the pressing plate 141b, and a handle 142c projecting from the end of the driving rod 142b.

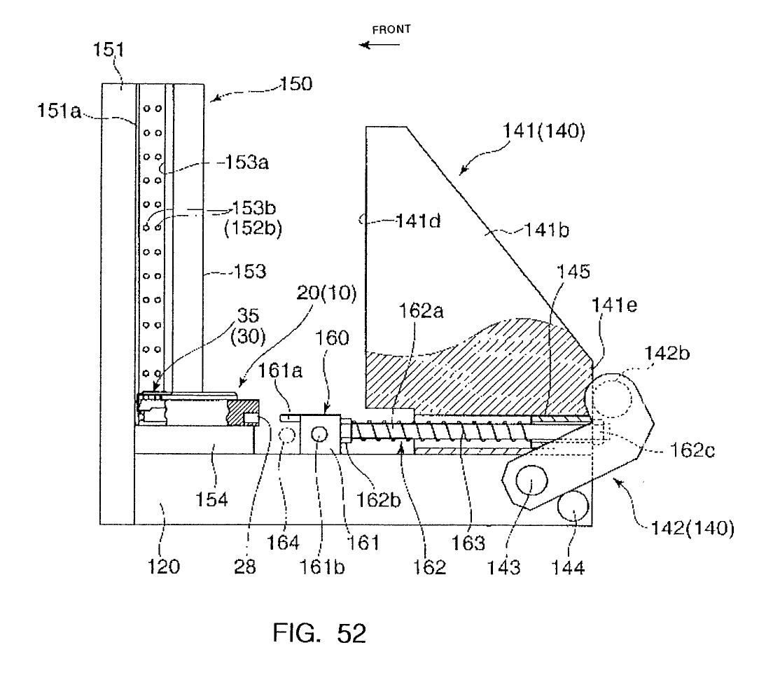

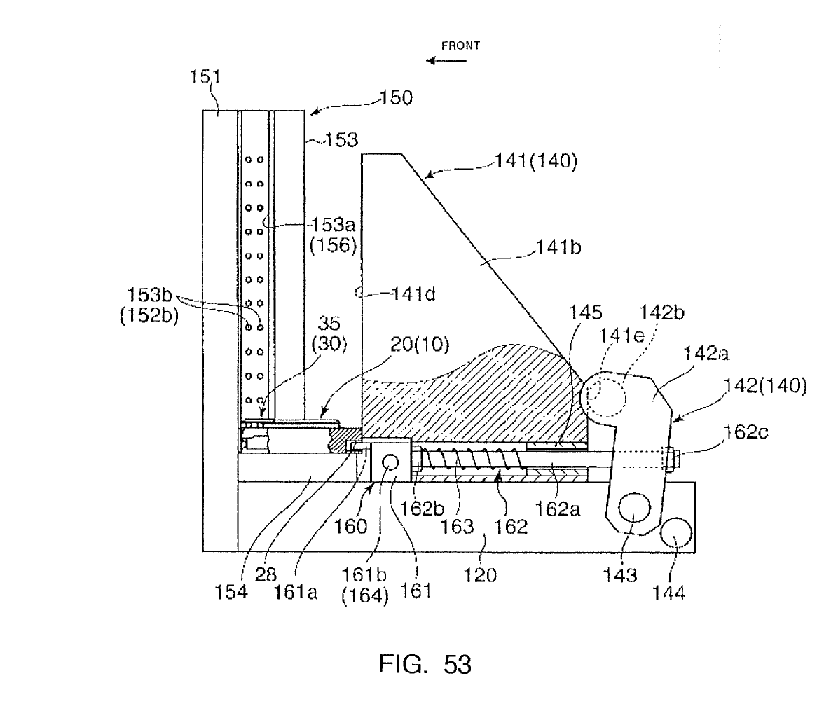

A stop bolt 144 mounted rearward of the supporting shaft 143 regulates the pivotal motion of the arm 142a at a position where the free end thereof inclines rearwardly. Thereby the driving rod 142b integral with the arm 142a can be driven between a retracted position (position shown in FIG. 52), where the pressing plate 141b of the slider 141 moves rearwardly and a pressing position (see FIG. 53) where the pressing plate 141b moves forwardly and presses the housing 20.

The handle 142c is cylindrical and has a gripping portion 142d at its top. The handle 142c projects at a position where it does not interfere with the electric wires W disposed between both pressing plates 141b of the slider 141.

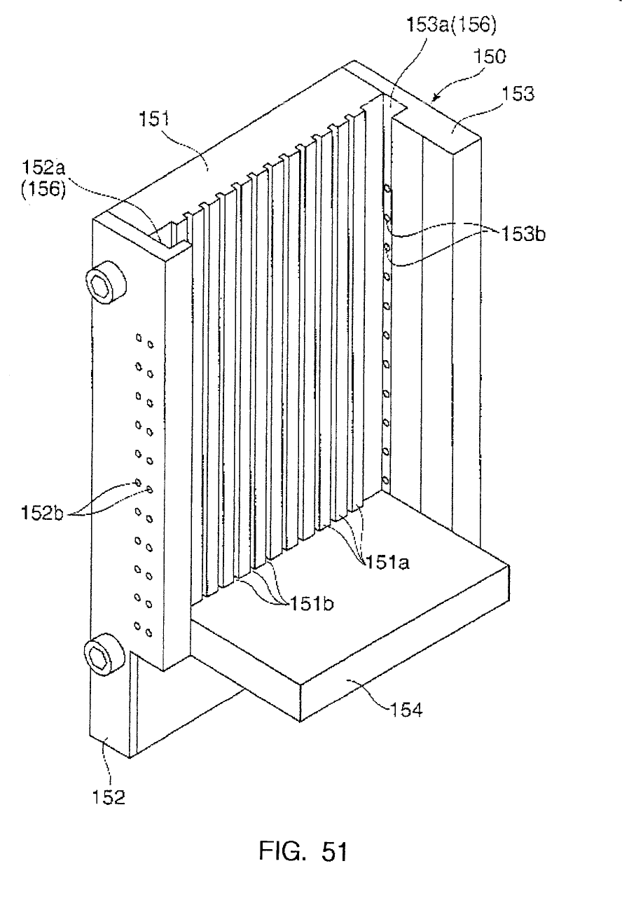

FIG. 51 is a perspective view showing the positioning unit 150 according to the embodiment shown in FIG. 49.

With reference to FIGS. 49 through 51, the positioning unit 150 has an end plate 151 mounted on the front end of the guide base 120, side plates 152, 153 fixed to both sides of the end plate 151, and a bottom plate 154 formed at the bottom of the end plate 151 and that of both side plates 152, 153.

The end plate 151 is fixed to the guide base 120, for example, by inserting a pair of bolts 155 into the bottom of the end plate 151 and tightening them into screw holes 125 formed on the front end surface of the guide base 120. The end plate 151 has a plurality of ribs 151a on its rear surface (surface receiving the stacked housing 20). The joint portions 35 projecting from the stacked housings 20 are accommodated in gaps 151b formed between the ribs 151a and 151a.

The pair of the side plates 152, 153 has respective inner side walls 152a, 153a that are irregular in correspondence to the configuration of the housing 20 which is guided by the end plate 151. Each of the side plates 152, 153 has a U-shaped insertion/removal opening 156 formed between the side plates 152, 153 and the end plate 151. The correction member 180 which will be described later is inserted into the insertion/removal opening 156 and removed therefrom. A plurality of pairs of through-holes 152b and 153b are formed in the side of each of the side plates 152, 153 in correspondence to the interval between the housings 20 to be stacked one upon another. The position regulation member 170 which will be described later is removably inserted into the through-holes 152b and 153b.

The bottom plate 154 receives the bottom surface of the housing 20 and is irregular in correspondence to the configuration of the bottom surface of the housing 20, although not shown in the drawings. The bottom plate 154 is in connection with the upper surface of the guide base 120 when the housings 20 are stacked one upon another (see FIG. 52).

FIGS. 52 through 55 are a partly broken-away schematic side view showing the housing-stacking apparatus of the embodiment shown in FIG. 49.

With reference to FIGS. 50 through 52, the locking mechanism 160 has a sliding member 161 disposed forward from the pressing unit 140, a pair of connection bars 162 having the front end thereof fixed to the sliding member 161 and penetrating through the slider 141 in a front-to-back direction, and a coil spring 163 disposed in the periphery of the connection bar 162 and provided between the slider 141 and the sliding member 161 for compression.

The sliding member 161 is made, for example, of rectangular solid-shaped metal extending in the transverse direction of the guide base 120. A pair of positioning projections 161a that can fit in a positioning hole 28 (see FIG. 3) formed in the housing 20 is formed integrally with the upper surface of the sliding member 161. A free end of the sliding member 161 projects forward. The connection bars 162 connect the sliding member 161 and the slider 141 to each other. In unison with the slider 141, the sliding member 161 is capable of moving between a retracted position (position shown in FIG. 52) apart from the housing 20, and a locking position (position shown in FIG. 53) proximate to the housing 20, where each positioning projection 161a fits in a positioning hole 28.

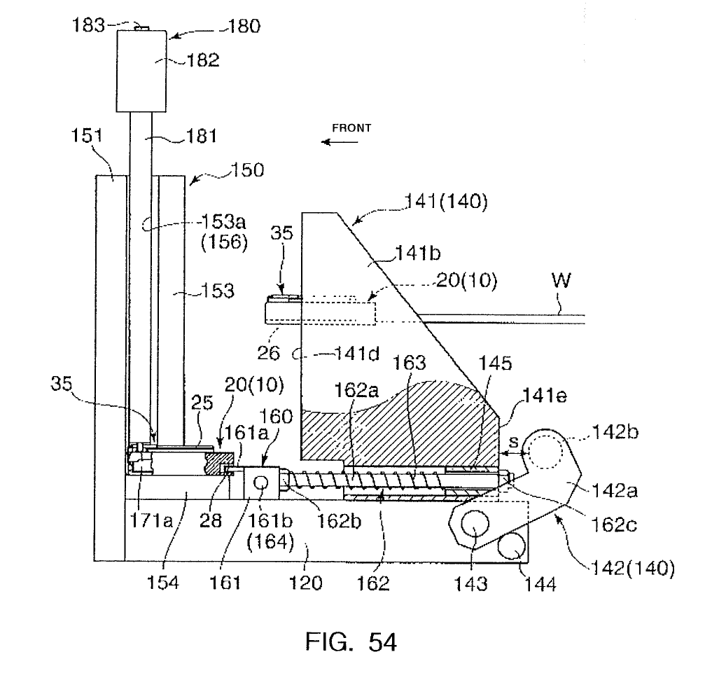

In the above-described embodiment, each of the guide ribs 121 of the guide base 120 has a ball plunger 164, formed by a spring biased ball, for locking the sliding member 161, when the sliding member 161 is located at the locking position. A recess 161b for locking the ball plunger 164 is formed at both sides of the sliding member 161. Thereby once the sliding member 161 moves to the locking position, the ball plungers 164 hold the sliding member 161 (see FIG. 54).

The pair of connection bars 162 is formed of a bolt 162a and a pair nuts 162b and 162c. The nut 162b is fixed to the sliding member 161, with the front end of the bolt 162a engaging the sliding member 161. The rear end of the bolt 162a penetrates through the base 141a of the slider 141. The removal of the rear end of the bolt 162a is prevented by the nut 162c engaging the rear end of the bolt 162a. The sliding member 161 and the slider 141 are displaceably connected to each other in such a way that the positioning unit 140 moves relative to the sliding member 161 located at the locking position to thereby allow a fit-in operation of the housings 20.

The front end of the coil spring 163 is in contact with the nut 162b. The rear end of the coil spring 163 penetrates into the base 141a of the slider 141 and contacts the front end surface of a sleeve 145 (see FIGS. 52 through 54). Thus, the coil spring 163 is compressed between the sliding member 161 and the slider 141, thus always pressing the slider 141 against the driving rod 142b of the operation portion 142.

As described above, after the sliding member 161 moves to the locking position, the ball plungers 164 hold the sliding member 161 at the locking position. Thus the rear-end nut 162c of each connection bar 162 is held at the locking position together with the sliding member 161. Accordingly when the sliding member is held at the locking position, the slider 141 is held at the predetermined position. Consequently, after an operator returns the operation portion 142 to the retracted position, the slider 141 does not return beyond the position regulated by the nut 162c. Thus a gap S of the stroke is formed between the slider 141 and the driving rod 142b (see FIG. 54). The sliding member 161 is unlocked from the ball plunger 164 by forcibly displacing the slider 141 by the stroke S.

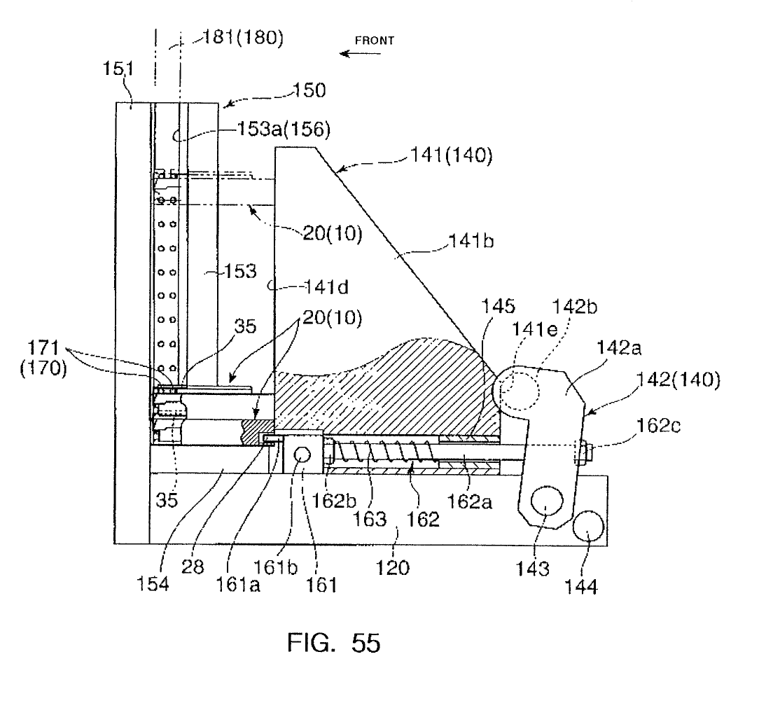

On the other hand, when the slider 141 moves to the pressing position, it is displaced relative to the sliding member 161 held at the locking position, thus pressing the housing 20 to a normal stacking position (see FIG. 55).

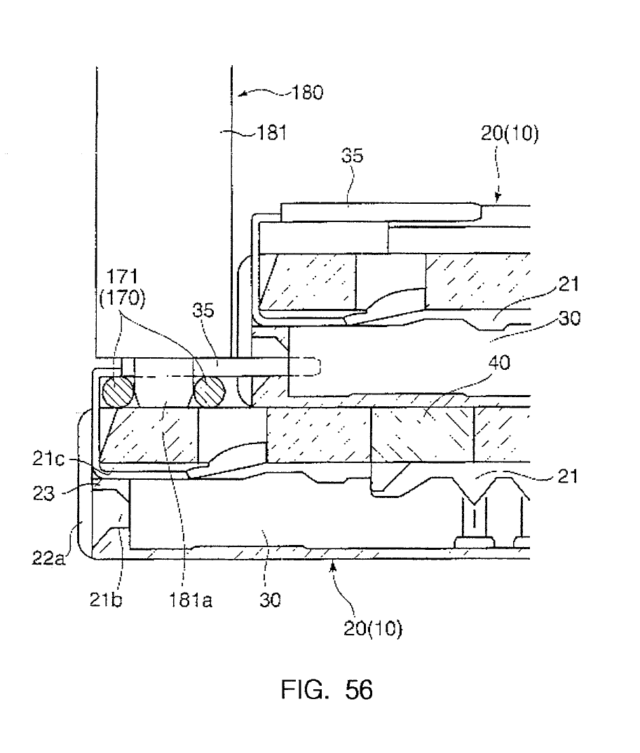

FIG. 56 is a partly enlarged schematic sectional view showing the process of stacking the housings one upon another in the embodiment shown in FIG. 49.

With reference to FIGS. 49, 50, and 56, the position regulation member 170 includes a pair of pins 171 parallel with each other and a connection head 172 integral with the pins 171 and connecting one end of the pins 171 to each other.

The pins 171 are spaced at an interval corresponding to the interval between the through-holes 152b of the side plate 152 and between the through-holes 153b of the side plate 153. At a position where the pins 171 do not interfere with the correction member 180 which will be described later, the pins 171 inserted into the through-holes 152b and 153b penetrate into the joint portion 35 bent in the shape of U, thus receiving the lower surface of the free end of the joint portion 35 to prevent the correction member 180 from bending the joint portion 35 excessively. The provision of the position regulation member 170 can be omitted depending on the degree of rigidity of the joint portion 35.

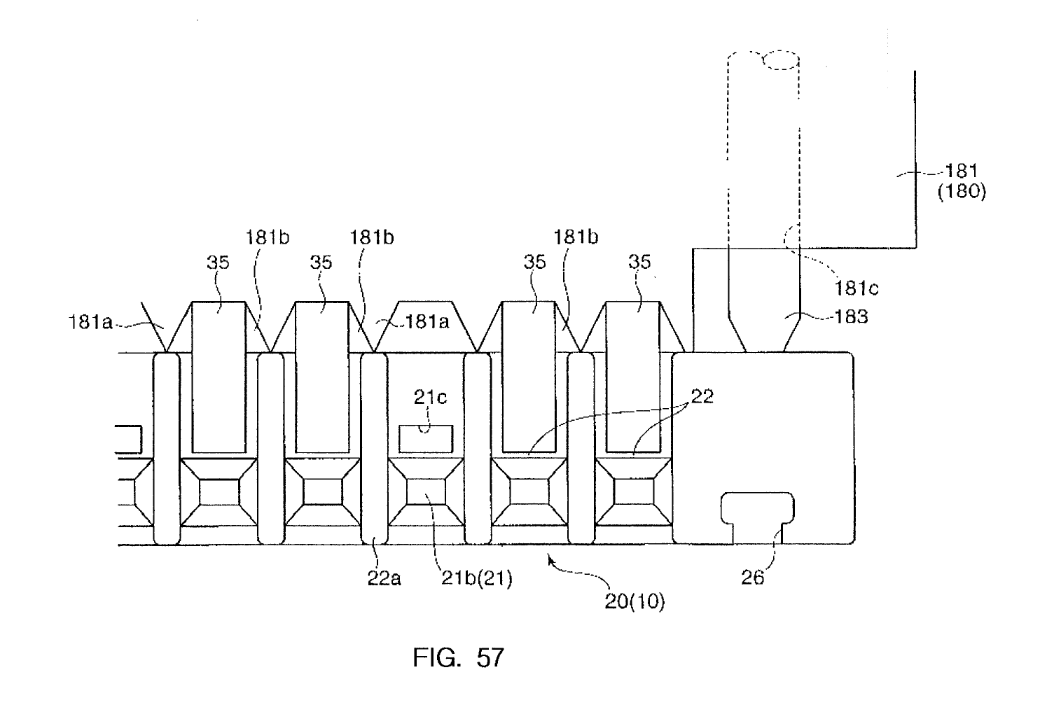

FIG. 57 is a partly enlarged front view showing the process of stacking the housings one upon another in the embodiment shown in FIG. 49.

With reference to FIGS. 49, 50, 56, and 57, the correction member 180 has a plate-shaped body 181, a head portion 182 integral with the body 181 and projecting from the body 181, and a detection bar 183 which penetrates through the correction member 180 in the longitudinal direction thereof in such way that the detection bar 183 can be removed from the head portion 182 in the longitudinal direction of the correction member 180.

The body 181 is introduced into the positioning unit 150 from the insertion/removal opening 156 thereof and faces the upper portion of the housing 20 positioned by the positioning unit 150, thus engaging the joint portion 35 of the housing 20 to thereby correct the configuration of the joint portion 35.

A wavy guide portion 181 a is formed at the lower end of the body 181. A trapezoidal gap 181b (note FIG. 57) is formed between the adjacent guide portions 181a in correspondence to the number of poles of the housing 20. The joint portion 35 is introduced into the gap 181b so that the joint portion 35 is pressed by the bottom portion of the gap 181b, with the free end of the joint portion 35 sandwiched between the correction member 180 and the pair of pins 171 of the position regulation member 170. Thus, the height of the joint portion 35 is corrected without bending it excessively to position the free end of the joint portion 35 in such a way that the free end of the joint portion 35 can be securely connected to the female connection portion 34 of the corresponding terminal 30 (see FIG. 56).

The head portion 182 serves as the gripping portion when the operator inserts the body 181 into the insertion/removal opening 156 removably. A throughhole 181c (see FIG. 57) vertically penetrating through the body 181 is formed at one end of the head portion 182 in its longitudinal direction to slidably insert the detection bar 183 into the through-hole 181c.

When the body 181 contacts the upper surface of the housing 20 whose joint portion 35 is being corrected, the detection bar 183 is disposed upwardly from the head portion 182 and detects whether the guide portion 181a of the body 181 corrects the configuration of the joint portion 35 normally.

With reference to FIG. 57, when the guide portion 181a has corrected the position of each joint portion 35 normally, the lower end of each guide portion 181a is seated on the upper surface of the housing 20. When the detection bar 183 contacts the upper surface of the housing 20 in this state, the detection bar 183 is disposed upwardly from the head portion 182 by a predetermined amount. The operator can detect whether each joint portion 35 has the normal configuration, based on the amount the detection bar 183 is disposed upward with respect to the head portion 182. On the other hand, if the body 181 is disposed upward from the head portion 182 for some reason, the amount the detection bar 183 is disposed upward from the head portion 182 is smaller than the predetermined amount. Thereby the operator can detect that each joint portion 35 has not been normally positioned.

The operation of the above embodiment will be described below.

FIG. 49 shows that the housing-stacking apparatus 100 is in an initial state. The correction member 180 and the position regulation member 170 are removed from the positioning unit 150 and disposed alongside the positioning unit 150.

In this condition, the lowermost housing 20 having the joint portions 35 bent in the shape of U is initially placed on the bottom plate 154 of the positioning unit 150 of the housing-stacking apparatus 100 (see FIG. 52). Then the upper housings 20 are stacked one upon another one at a time, as described below.

Next, the operation portion 142 of the pressing unit 140 is operated to move the slider 141 forward. As a result, as shown in FIG. 53, the sliding member 161 of the locking mechanism 160 moves forward, and the positioning projection 161a of the sliding member 161 fits into the positioning hole 28 of the housing 20, thus locking the housing 20 in position. In this locking condition, the ball plunger 164 fits into the recess 161b formed on the side of the sliding member 161 and locking the sliding member 161 thereto. As a result, the housing 20 is locked to the positioning unit 150 by the sliding member 161 of the locking mechanism 160. After the operator returns the handle 142c (see FIG. 49) of the operation portion 142 to its original position, the locking condition is maintained (see FIG. 54). As shown in FIG. 54, when the operator returns the handle 142c (see FIG. 49) of the operation portion 142 to its original position, the slider 141 moves rearward due to the action of the coil spring 163, thus providing the space where the housings 20 are stacked one upon another.

With reference to FIG. 54, when the housing 20 placed in position is locked, the pin 171 of the position regulation member 170 is inserted into respective ones of the plurality of through-holes 152b, 153b corresponding to the housing 20 to regulate the position of the lower surface of the joint portion 35 projecting from the housing 20 (see FIG. 56).

Thereafter the correction member 180 is introduced into the insertion/removal opening 156 of the positioning unit 150 to position the joint portion 35 in cooperation with the position regulation member 170, with the guide portion 181a being pressed against the upper portion of the joint portion 35.

An upper housing 20 is manually stacked on the lower housing 20 placed in position, and the guide rib 25 formed on the lower housing 20 and the slide groove 26 formed on the upper housing are slidably interfitted.

In this condition, the operator operates the handle 142c of the operation portion 142 again to temporarily fit the upper housing 20 in the lower housing 20. As shown in FIG. 56, in this condition, the joint portion 35 projecting from the lower housing 20 is introduced into the tab-projecting opening 21c of the upper housing 20. As a result, the joint portion 35 enters slightly into the female connection portion 34.

The correction member 180 and the position regulation member 170 are withdrawn from the positioning unit 150 to release the joint portion 35. Then, the operation portion is operated to move the slider 141 forwardly to thereby fit the upper housing 20 to the lower housing 20 (see FIG. 55).

Thereafter by repeating the work described with reference to FIG. 54 and subsequent drawings, the housings 20 are stacked one upon another up to the stack shown by the imaginary line of FIG. 55 to manufacture the stacked-type connectors shown in FIG. 9.

After the stacked-type connectors are manufactured, the sliding member 161 is unlocked from the ball plunger 164 of the locking mechanism 160 by forcibly displacing the slider 141 rearward. Thus, the stacked housings 20 can be taken out from the positioning unit 150.

In the embodiment as described above, the lowermost housing 20 is supplied to the positioning unit 150 serving as the housing-holding portion and is held thereby. Then the position regulation member 170 and the correction member 180 serving as the joint portion correction mechanism are displaced to the correction position to thereby correct the configuration of the joint portion 35 held by the positioning unit 150. Therefore, it is possible to effectively prevent an insertion error because the joint portion 35 is not deformed or defectively shaped.

Thereafter the upper housing 20 to be stacked on the housing 20 placed in position is supplied to the positioning unit 150 to temporarily fit both housings to each other. Thus the position-corrected joint portion 35 and the terminal 30 fit in each other smoothly. After both housings temporarily fit in each other, they are fitted to each other completely or normally. Thus a smooth housing connection operation can be performed without making an erroneous fit-in operation.

In the above embodiment, the housing-stacking apparatus 100 has the locking mechanism 160 capable of moving between the locking condition in which the lowermost housing 20 to be placed initially on the positioning unit 150 is locked to the positioning unit 150 and the housing unlocking state. Thus, when a subsequent housing 20 is temporarily fitted in the lower housing 20 placed in position previously, the lower housing 20 placed in position previously is locked. Therefore, the position of the housing 20 is stable, which allows the operator to temporarily manually fit both housings in each other easily.

Further the locking operation of the locking mechanism 160 can be interlocked to the operation of the pressing unit 140. Thus the locking mechanism 160 can automatically lock the housing 20 thereto by merely operating the pressing unit 140.

The unlocking operation can be performed by merely forcibly driving the slider 141 rearward. Thus it is unnecessary to provide the housing-stacking apparatus 100 with a particular unlocking mechanism.

In the above embodiment, the locking mechanism 160 has the ball plungers 164 for holding the sliding member 161 at the locking position. The connection bar 162 connects the sliding member 161 and the pressing unit 140 to each other in such a way that the pressing unit 140 is displaced relatively to the sliding member 161 located at the locking position to thereby allow the fit-in operation of the housings 20. Therefore, with the lowermost housing 20 locked to the locking mechanism 160, the remaining housings 20 can be stacked one upon another by repeating the fit-in operation. Thus the fit-in operation can be accomplished easily.

As described above, according to the present invention, in constructing a part of the wire harness of the stacked-type connector proposed by the present applicant, each joint portions projecting from the housing is pressed to have a generally U-shaped configuration, and the pressed housings can be successively stacked one upon another. Thus it is possible to automatically produce a large-scale circuit very close to a complete circuit. Therefore, the present invention has an outstanding effect of automatically utilizing an electrical connection technique contributing to the formation of a complete circuit.

Also as described above, according to the present invention, it is possible to securely fit the stacked housings 20 having a particular construction in each other manually or automatically. Therefore, the present invention has an outstanding effect of providing the electrical connection technique contributing to the formation of a complete circuit.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present disclosure relates to subject matter contained in priority Japanese Application No. 2000-393564, Japanese Application No. 2000-393565, and Japanese Application No. 2000-393566, all filed on Dec. 25, 2000, the disclosures of which is herein expressly incorporated by reference in their entirities.

What is claimed is:

1. An apparatus for processing a stacked-type connector having terminals connectable to electric wires and arranged parallel with one another in a predetermined direction, and housings each accommodating the arranged terminals and stackable one upon another and connected to each other, each of the terminals having a female connection portion formed at one end thereof in the longitudinal direction thereof and accommodated in the housing, and a joint portion extending from the female connection portion, said apparatus for processing the stacked-type connector comprising:
a pressing unit configured to press the joint portion of the housing into a generally U-shaped configuration; and
a stacking unit configured to sequentially stack the joint portion-pressed housings one upon another in a predetermined order.

2. The apparatus for processing a stacked-type connector according to claim 1, further comprising a correction unit disposed between said pressing unit and said stacking unit, said correction unit configured to correct a configuration of the joint portion shaped by said pressing unit.

3. The apparatus for processing a stacked-type connector according to claim 1, further comprising an electric wire guide unit provided on said stacking unit, said electric wire guide unit configured to guide electric wires of the housings supplied to said stacking unit.

4. The apparatus for processing a stacked-type connector according to claim 1, further comprising a housing supply unit configured to stock the housings in such a way that the housings are suppliable to said pressing unit in a housing-stacking order.

5. The apparatus for processing a stacked-type connector according to claim 4, wherein said housing supply unit is configured to stock the housings in such a way that the housings are suppliable to said pressing unit by removably holding a housing holder unit accommodating the housings of said wire harness in a housing-stacking order.

6. A housing holder unit usable in the apparatus for processing a stacked-type connector according to claim 5, said housing holder unit comprising:
a holder body configured to stock the housings of the stacked-type connectors in a housing-stacking order; and
a protection cap provided for each of the housings held by said holder body and covering joint portions of each of the housings,
wherein said protection cap is connected to said holder body in such a way that said protection cap is removed from the housing by a removal operation of the housings from said holder body.

7. A wire harness supply method for supplying a stacked-type connector and a wire harness to an apparatus, and for processing the stacked-type connector, according to claim 1, said method comprising:
mounting a protection cap configured to cover an unprocessed joint portion on each of the housings at a time of manufacturing the wire harness;
stocking the protection cap-mounted housings in a holder body forming a housing holder unit together with the protection cap in such a way that the housings are suppliable in a housing-stacking order;
mounting the housing holder unit and the stacked-type connector on the wire harness; and
supplying the wire harness and the housing holder unit mounted on the wire harness to said processing apparatus.

8. The apparatus for processing a stacked-type connector according to claim 1, further comprising:
a frame member configured to hold the housing, with the joint portion placed in a predetermined pressing position;
a first pressing portion configured to sandwich a linear joint portion placed in said predetermined pressing position under pressure and to bend a front end of the joint portion;
a second pressing portion configured to bend the joint portion to have a generally U-shaped configuration by folding back a base end of the terminal with respect to the bent joint portion after said first pressing portion bends said front end of said joint potion; and
a driving mechanism configured to sequentially drive said first pressing portion and then said second pressing portion.

9. The apparatus for processing a stacked-type connector according to claim 8, wherein said first pressing portion includes a pair of dies configured to sandwich therebetween all of the joint portions projecting from the connectors placed at said predetermined pressing position of said frame member.

10. The apparatus for processing a stacked-type connector according to claim 9, wherein said frame member includes a guide member configured to guide said pair of dies along a same line.

11. The apparatus for processing a stacked-type connector according to claim 8, wherein said second pressing portion includes a die configured to bend all of said joint portions of the terminals in a space between said die and the housings of the connectors placed at said predetermined pressing position of said frame member.

12. The apparatus for processing a stacked-type connector according to claim 11, wherein said die of said second pressing portion includes a punching portion configured to press all of the joint portions projecting from the connectors.

13. The apparatus for processing a stacked-type connector according to claim 1, further comprising:
a housing-holding portion configured to hold the housings of stacked-type connectors in a stacking order;
a correction mechanism that corrects a configuration of the joint portion projecting from one of the housings held by the housing-holding portion and connectable to the female connection portion of another of the housings to be stacked on the one housing held by said housing-holding portion, said correction mechanism being movable between a correction position where the joint portion is corrected and a position away from the joint portion that allows the joint portion to be connected to the female connection corresponding thereto; and
a fit-in mechanism that temporarily fits the another of the housings to the one housing after the configuration of the joint portion of the one housing after the configuration of the joint portion of the one housing is corrected by said joint portion correction mechanism and normally fitting both housings to each other after said correction mechanism moves away from said joint portion correction position.

14. The apparatus for processing a stacked-type connector according to claim 13, wherein said correction mechanism includes a position regulation member configured to receive a lower surface of a free end of the joint portion of the one housing positioned in said housing-holding portion; and
a correction member configured to an upper surface of the free end of the joint portion downward, with the joint portion sandwiched between said correction member and said position regulation member.

15. The apparatus for processing a stacked-type connector according to claim 13, further comprising a locking mechanism configured to move between a locking condition in which one of the housings initially placed in the housing-holding portion is locked to the housing-holding portion and an unlocking condition.

16. The apparatus for processing a stacked-type connector according to claim 15, wherein said locking mechanism comprises:
a sliding member configured to move between a housing-locking position and a housing-unlocking position; and
a connection member connected to said sliding member so that said sliding member is movable from said housing-unlocking position to said housing-locking position in unison with a fit-in operation of said fit-in mechanism.

17. The apparatus for processing a stacked-type connector according to claim 16, further comprising a holding mechanism configured to hold said sliding member at said locking position, and wherein said connection member connects said sliding member and said fit-in mechanism to each other so that said fit-in mechanism moves relative to said sliding member located at said locking position to perform an operation of fitting the housings together.

18. A wire harness having a stacked-type connector having at least one terminal with a male portion extending therefrom and shaped to have a generally U-shaped configuration connectable to a female connection portion of another terminal of an adjacent connector, said stacked-type connector being formed by the apparatus of claim 1.

19. A method for stacking housings of stacked-type connectors each having terminals arranged parallel with one another in a predetermined direction, and housings accommodating the arranged terminals and stacked one upon another in a direction perpendicular to the direction in which the terminals are arranged and connected to each other,
each of the terminals having an electric wire connection portion formed at one end thereof in a longitudinal direction thereof and connected to an end of a coated electric wire, a female connection portion formed at the other end thereof in the longitudinal direction thereof and accommodated in the housing, and a joint portion extending from the female connection portion, with a front end of the joint portion formed to have a generally U-shaped configuration and connectable to the female connection portion of another of the terminals adjacent to the one of the terminals in a direction in which the housings are stacked one upon another;
said method comprising:
holding the housings of stacked-type connectors in a stacking order;
correcting, with a correction mechanism, a configuration of the joint portion projecting from one of the housings held by the housing-holding portion and connectable to the female connection portion of another of the housings to be stacked on the one housing held by the housing-holding portion; and
fitting the another housing to the one housing after the configuration of the joint portion of the one housing is corrected by the correction mechanism.

20. The method according to claim 19, wherein said correcting is performed with a correction mechanism comprising a plate-shaped member.
